(19) United States
(12) Patent Application Publication
(10) Pub. No.: US 2008/0307987 A1
(43) Pub. Date: Dec. 18, 2008

(54) Liquid transfer member position adjusting method and apparatus of rotary stencil printing plate liquid coating machine

(75) Inventors: Isao Umetsu, Tsukuba-shi (JP); Hiromitsu Numauchi, Tsukuba-shi (JP); Isao Komuro, Noda-shi (JP); Akehiro Kusaka, Noda-shi (JP)

Correspondence Address: BIRCH STEWART KOLASCH & BIRCH, PO BOX 747, FALLS CHURCH, VA, 22040-0747, US

(73) Assignee: KOMORI CORPORATION, Tokyo (JP)

(21) Appl. No.: 12/155,761

(22) Filed: Jun. 9, 2008

(30) Foreign Application Priority Data
Jun. 14, 2007 (JP) 2007-157300
Mar. 12, 2008 (JP) 2008-062377

(51) Int. Cl. B41L 13/00

(52) U.S. Cl. 101/120

(57) ABSTRACT

A rotary screen printing press includes, a rotary screen cylinder which supports a screen printing forme and is supported rotatably; an impression cylinder which is provided to oppose the rotary screen cylinder, and is supported rotatably; and a squeegee which is located within the rotary screen cylinder and, during printing, contacts an inner peripheral surface of the screen printing forme, while being pressed against it, to transfer ink stored within the rotary screen cylinder to a material to be printed, which is held on the impression cylinder, via holes of the screen printing forme. The printing press has a setting instrument for setting the length in the transport direction of the material to be printed, and a squeegee throw-on and throw-off control device for controlling the squeegee to be moved to a retreat position in accordance with the length in the transport direction of the material to be printed which has been set by the setting instrument.

### BACKGROUND OF THE INVENTION

1. Field of the Invention

This invention relates to a liquid transfer member position adjusting method and apparatus of a rotary stencil printing plate liquid coating machine such as a rotary screen printing press. In the descriptions to follow, examples, in which a rotary screen printing press is used as a rotary stencil printing plate liquid coating machine, and ink is used as a liquid which is coated on a material to be liquid coated, will be explained to facilitate understanding. It goes without saying, however, that the present invention maybe similarly applied to a liquid coating machine using a stencil printing plate put to other uses instead of the rotary screen printing press, the liquid coating machine using a rotary screen coater for coating varnish in place of ink.

2. Description of the Related Art

A conventional rotary screen printing press, for example, as shown in FIGS. 23(a) and 23(b), is well known.

This rotary screen printing press is furnished with a plate cylinder 101 bearing a rotary screen printing forme 100, and an impression cylinder 104 having two cylinder pits 103 in each of which a sheet gripper 102 is installed. The sheet gripper 102, when located at a closed position, is arranged not to protrude above the printing surface of the impression cylinder 104.

A squeegee 105 whose position can be adjusted is disposed within the plate cylinder 101 and, during printing work, is pressed against the inner surface of the rotary screen printing forme 100 by an operating mechanism including a bell crank 106, a control cam 107, and an operating cylinder 108 (see the state of FIG. 23(a)). When the squeegee 105 passes through the open area of the cylinder pit 103 of the impression cylinder 104, the squeegee 105 is lifted away from the rotary screen printing forme 100 (see the state of FIG. 23(b)).

During passage through the cylinder pit 103 of the impression cylinder 104, therefore, the rotary screen printing forme 100 is released from the pressure of the squeegee 105 located inside the rotary screen printing forme 100. This avoids a situation in which the rotary screen printing forme 100 is pushed into the cylinder pit 103 of the impression cylinder 104 under the pressure of the squeegee 105, and damaged thereby.

JP-A-08-230149 is an example of a document on the above-mentioned related art.

With the conventional rotary screen printing press described above, the squeegee 105 is designed to be retreated to a position, where the squeegee 105 has been lifted away from the rotary screen printing forme 100, when the squeegee 105 comes to a position where it opposes the cylinder pit 103 of the impression cylinder 104.

At other portions of the impression cylinder 104, therefore, the squeegee 105 is held at the position during printing. At the rear end of the printed material, the squeegee 105 abruptly moves toward the impression cylinder by an amount corresponding to the thickness of the printed material. If the thickness of the printed material (paper or the like) is large, in particular, repetition of this abrupt movement has posed the problem that the rotary screen printing forme 100 interposed between the impression cylinder 104 and the squeegee 105 is damaged or worn.

Moreover, the squeegee 105 is designed to be retreated to a position where the squeegee 105 has been lifted away from the rotary screen printing forme 100. Thus, a gap is formed between the rotary screen printing forme 100 and the squeegee 105, and ink leaks out through this gap toward a downstream side in the rotating direction of the rotary screen printing forme. As a result, the amount of ink remaining in front of the squeegee 105 becomes small, thus decreasing ink density at the start of printing. If the amount of ink supplied is increased in order to prevent the decrease in the ink density at the start of printing, the amount of ink leaking out toward the downstream side increases. The increased leaking ink leaks out through the holes of a picture pattern portion of the rotary screen printing forme 100 under a centrifugal force during high speed rotation, adheres to outside portions of the holes, and sticks to the outside of the picture pattern portion during printing, thereby deteriorating printing quality.

The present invention has been accomplished in light of the above-described problems. It is an object of the invention to prevent the damage or wear of the stencil printing plate due to the abrupt movement of the liquid transfer member during liquid coating, prevent the stencil printing plate from being pushed into the notch of the impression cylinder and damaged thereby, and also eliminate ink leaking out toward the downstream side in the rotating direction of the stencil printing plate, thereby preventing deterioration of liquid coating quality.

### SUMMARY OF THE INVENTION

A first aspect of the present invention is a liquid transfer member position adjusting method of a rotary stencil printing plate liquid coating machine including,

a stencil printing plate cylinder which supports a stencil printing plate and is supported rotatably,

an impression cylinder which is provided to oppose the stencil printing plate cylinder, and is supported rotatably, and

a liquid transfer member which is located within the stencil printing plate cylinder and, during liquid coating, contacts an inner peripheral surface of the stencil printing plate, while being pressed against the inner peripheral surface of the stencil printing plate, to transfer a liquid stored within the stencil printing plate cylinder to a material to be liquid coated, which is supplied between the stencil printing plate cylinder and the impression cylinder, via holes of the stencil printing plate,

wherein a length in a transport direction of the material to be liquid coated, or a length of a liquid coating region in the transport direction of the material to be liquid coated is set, and

the liquid transfer member is moved to a retreat position in accordance with the set length in the transport direction of the material to be liquid coated, or the set length of the liquid coating region in the transport direction of the material to be liquid coated.

The retreat position of the liquid transfer member may be a position where the liquid transfer member makes contact with, the inner peripheral surface of the stencil printing plate, and a pressing force of the liquid transfer member acting on the inner peripheral surface of the stencil printing plate becomes lower than a pressing force of the liquid transfer member exerted during the liquid coating.

Adjustment of a position of the liquid transfer member may be made by a motor.

The retreat position of the liquid transfer member may be obtained from a type of the stencil printing plate.

The retreat position of the liquid transfer member may be obtained from a picture pattern area rate of a picture pattern which is applied by the liquid coating to the material to be liquid coated.

The retreat position of the liquid transfer member may be obtained from a type of the liquid used in the liquid coating.

The retreat position of the liquid transfer member may be obtained from a type of the liquid transfer member.

A second aspect of the present invention is a liquid transfer member position adjusting apparatus of a rotary stencil printing plate liquid coating machine including,

a stencil printing plate cylinder which supports a stencil printing plate and is supported rotatably,

an impression cylinder which is provided to oppose the stencil printing plate cylinder, and is supported rotatably, and

a liquid transfer member which is located within the stencil printing plate cylinder and, during liquid coating, contacts an inner peripheral surface of the stencil printing plate, while being pressed against the inner peripheral surface of the stencil printing plate, to transfer a liquid stored within the stencil printing plate cylinder to a material to be liquid coated, which is supplied between the stencil printing plate cylinder and the impression cylinder, via holes of the stencil printing plate,

the liquid transfer member position adjusting apparatus comprising:

setting means for setting a length in a transport direction of the material to be liquid coated, or a length of a liquid coating region in the transport direction of the material to be liquid coated, and

control means for controlling the liquid transfer member to be moved to a retreat position in accordance with the length in the transport direction of the material to be liquid coated, or the length of the liquid coating region in the transport direction of the material to be liquid coated, which has been set by the setting means.

The control means may control the retreat position of the liquid transfer member to a position where the liquid transfer member makes contact with the inner peripheral surface of the stencil printing plate, and a pressing force of the liquid transfer member acting on the inner peripheral surface of the stencil printing plate becomes lower than a pressing force of the liquid transfer member exerted during the liquid coating.

The control means may make adjustment of a position of the liquid transfer member by drivingly controlling a motor.

The control means may control the retreat position of the liquid transfer member in accordance with a type of the stencil printing plate.

The control means may control the retreat position of the liquid transfer member in accordance with a picture pattern area rate of a picture pattern which is applied by the liquid coating to the material to be liquid coated.

The control means may control the retreat position of the liquid transfer member in accordance with a type of the liquid used in the liquid coating.

The control means may control the retreat position of the liquid transfer member in accordance with a type of the liquid transfer member.

According to the foregoing features of the present invention, the timing with which to move the liquid transfer member to the retreat position is effectively set, thereby making it possible to prevent the damage or wear of the stencil printing plate due to the abrupt movement of the liquid transfer member during liquid coating. Even when the liquid transfer member is located at a position where it opposes the notch of the impression cylinder, the liquid transfer member does not leave the stencil printing plate, and only its pressure exerted on the stencil printing plate is rendered lower than its pressure exerted during liquid coating. Thus, the stencil printing plate can be prevented from being pushed into the notch of the impression cylinder and damaged thereby, and there is no liquid leaking out toward the downstream side in the rotating direction of the stencil printing plate, so that deterioration of liquid coating quality can be prevented.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic configurational sectional view of a rotary screen printing unit in a rotary screen printing press showing Embodiment 1 of the present invention;

FIG. 2 is a right side view of the rotary screen printing unit in FIG. 1;

FIG. 3 is a left side view of the rotary screen printing unit in FIG. 1;

FIG. 4(a) is an operating state view;

FIG. 4(b) is an operating state view;

FIG. 5(a) is a control block diagram of a squeegee throw-on and throw-off control device;

FIG. 5(b) is a control block diagram of the squeegee throw-on and throw-off control device;

FIG. 5(c) is a control block diagram of the squeegee throw-on and throw-off control device;

FIG. 6(a) is a motion flow chart of the squeegee throw-on and throw-off control device;

FIG. 6(b) is a motion flow chart of the squeegee throw-on and throw-off control device;

FIG. 6(c) is a motion flow chart of the squeegee throw-on and throw-off control device;

FIG. 6(d) is a motion flow chart of the squeegee throw-on and throw-off control device;

FIG. 6(e) is a motion flow chart of the squeegee throw-on and throw-off control device;

FIG. 7(a) is a motion flow chart of the squeegee throw-on and throw-off control device;

FIG. 7(b) is a motion flow chart of the squeegee throw-on and throw-off control device;

FIG. 7(c) is a motion flow chart of the squeegee throw-on and throw-off control device;

FIG. 7(d) is a motion flow chart of the squeegee throw-on and throw-off control device;

FIG. 8(a) is a motion flow chart of the squeegee throw-on and throw-off control device;

FIG. 8(b) is a motion flow chart of the squeegee throw-on and throw-off control device;

FIG. 8(c) is a motion flow chart of the squeegee throw-on and throw-off control device;

FIG. 8(d) is a motion flow chart of the squeegee throw-on and throw-off control device;

FIG. 9(a) is a motion flow chart of the squeegee throw-on and throw-off control device;

FIG. 9(b) is a motion flow chart of the squeegee throw-on and throw-off control device;

FIG. 9(c) is a motion flow chart of the squeegee throw-on and throw-off control device;

FIG. 9(d) is a motion flow chart of the squeegee throw-on and throw-off control device;

FIG. 10(a) is a motion flow chart of the squeegee throw-on and throw-off control device;

FIG. 10(b) is a motion flow chart of the squeegee throw-on and throw-off control device;

FIG. 10(c) is a motion flow chart of the squeegee throw-on and throw-off control device;

FIG. 10(d) is a motion flow chart of the squeegee throw-on and throw-off control device;

FIG. 11(a) is a motion flow chart of the squeegee throw-on and throw-off control device;

FIG. 11(b) is a motion flow chart of the squeegee throw-on and throw-off control device;

FIG. 11(c) is a motion flow chart of the squeegee throw-on and throw-off control device;

FIG. 11(d) is a motion flow chart of the squeegee throw-on and throw-off control device;

FIG. 12(a) is a motion flow chart of the squeegee throw-on and throw-off control device;

FIG. 12(b) is a motion flow chart of the squeegee throw-on and throw-off control device;

FIG. 12(c) is a motion flow chart of the squeegee throw-on and throw-off control device;

FIG. 12(d) is a motion flow chart of the squeegee throw-on and throw-off control device;

FIG. 13 is a schematic configurational sectional view of a rotary screen printing unit in a rotary screen printing press showing Embodiment 2 of the present invention;

FIG. 14(a) is an explanation drawing of an ink supply system;

FIG. 14(b) is an explanation drawing of an ink supply pipe;

FIG. 15(a) is a control block diagram of a doctor roller throw-on and throw-off control device;

FIG. 15(b) is a control block diagram of the doctor roller throw-on and throw-off control device;

FIG. 15(c) is a control block diagram of the doctor roller throw-on and throw-off control device;

FIG. 16(a) is a motion flow chart of the doctor roller throw-on and throw-off control device;

FIG. 16(b) is a motion flow chart of the doctor roller throw-on and throw-off control device;

FIG. 16(c) is a motion flow chart of the doctor roller throw-on and throw-off control device;

FIG. 16(d) is a motion flow chart of the doctor roller throw-on and throw-off control device;

FIG. 16(e) is a motion flow chart of the doctor roller throw-on and throw-off control device;

FIG. 17(a) is a motion flow chart of the doctor roller throw-on and throw-off control device;

FIG. 17(b) is a motion flow chart of the doctor roller throw-on and throw-off control device;

FIG. 17(c) is a motion flow chart of the doctor roller throw-on and throw-off control device;

FIG. 17(d) is a motion flow chart of the doctor roller throw-on and throw-off control device;

FIG. 18(a) is a motion flow chart of the doctor roller throw-on and throw-off control device;

FIG. 18(b) is a motion flow chart of the doctor roller throw-on and throw-off control device;

FIG. 18(c) is a motion flow chart of the doctor roller throw-on and throw-off control device;

FIG. 19(a) is a motion flow chart of the doctor roller throw-on and throw-off control device;

FIG. 19(b) is a motion flow chart of the doctor roller throw-on and throw-off control device;

FIG. 19(c) is a motion flow chart of the doctor roller throw-on and throw-off control device;

FIG. 20(a) is a motion flow chart of the doctor roller throw-on and throw-off control device;

FIG. 20(b) is a motion flow chart of the doctor roller throw-on and throw-off control device;

FIG. 20(c) is a motion flow chart of the doctor roller throw-on and throw-off control device;

FIG. 21(a) is a motion flow chart of the doctor roller throw-on and throw-off control device;

FIG. 21(b) is a motion flow chart of the doctor roller throw-on and throw-off control device;

FIG. 21(c) is a motion flow chart of the doctor roller throw-on and throw-off control device;

FIG. 22(a) is a motion flow chart of the doctor roller throw-on and throw-off control device;

FIG. 22(b) is a motion flow chart of the doctor roller throw-on and throw-off control device;

FIG. 22(c) is a motion flow chart of the doctor roller throw-on and throw-off control device;

FIG. 23(a) is a schematic view of a conventional rotary screen printing press; and

FIG. 23(b) is a schematic view of the rotary screen printing press showing a different operating state.

### DETAILED DESCRIPTION OF THE INVENTION

The liquid transfer member position adjusting method and apparatus of a rotary stencil printing plate liquid coating machine according to the present invention will be described in detail by embodiments of the invention by reference to the accompanying drawings.

### Embodiment 1

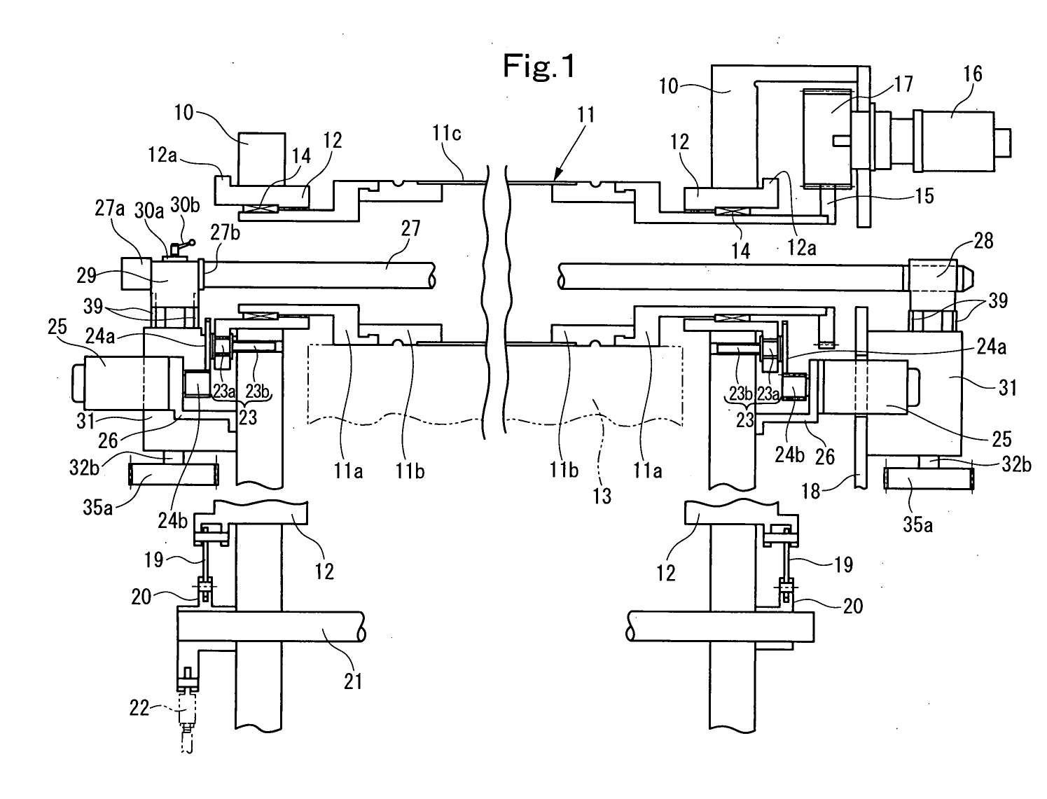

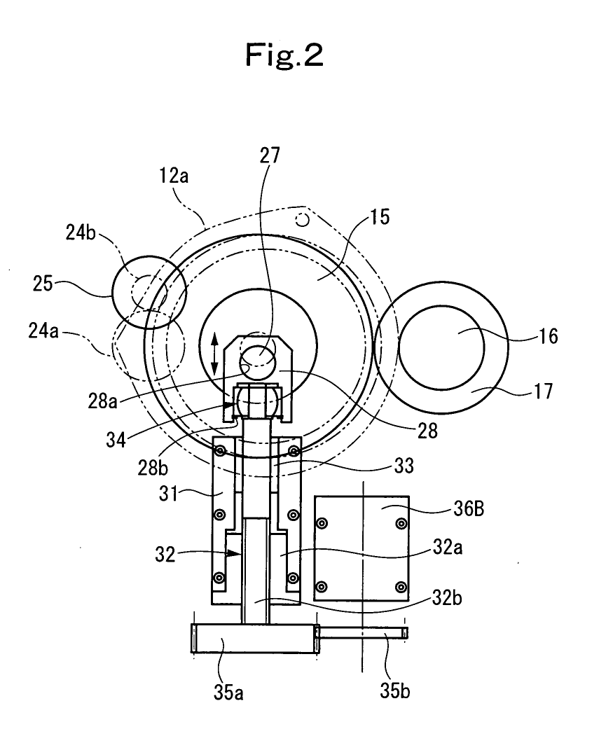

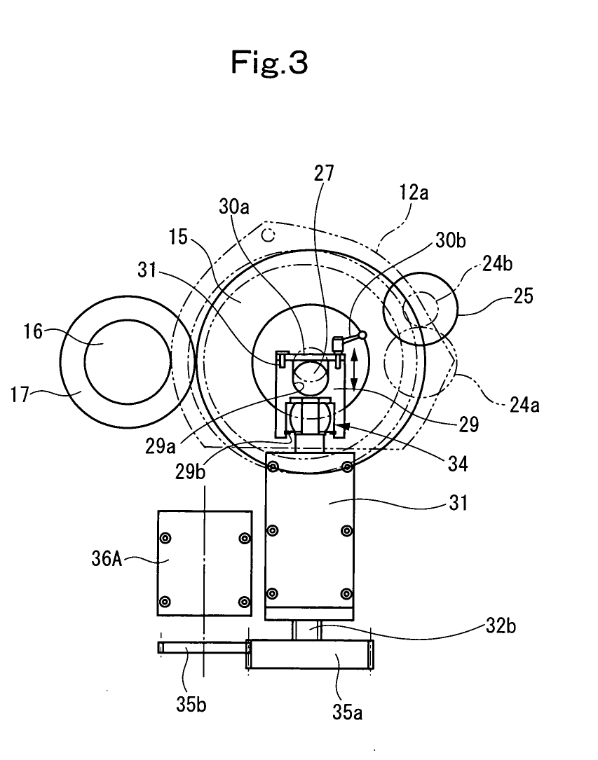

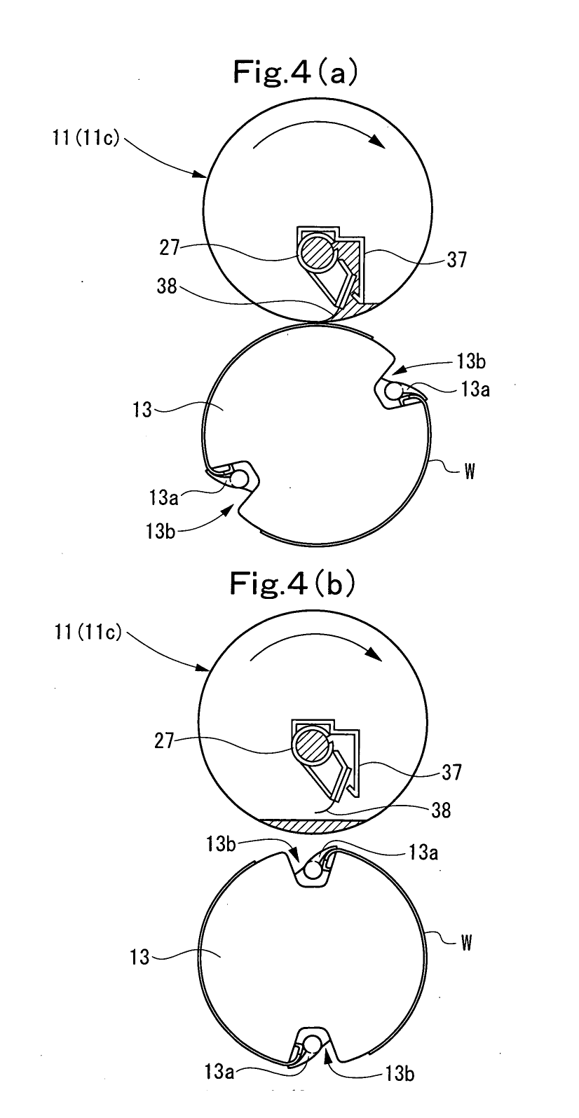

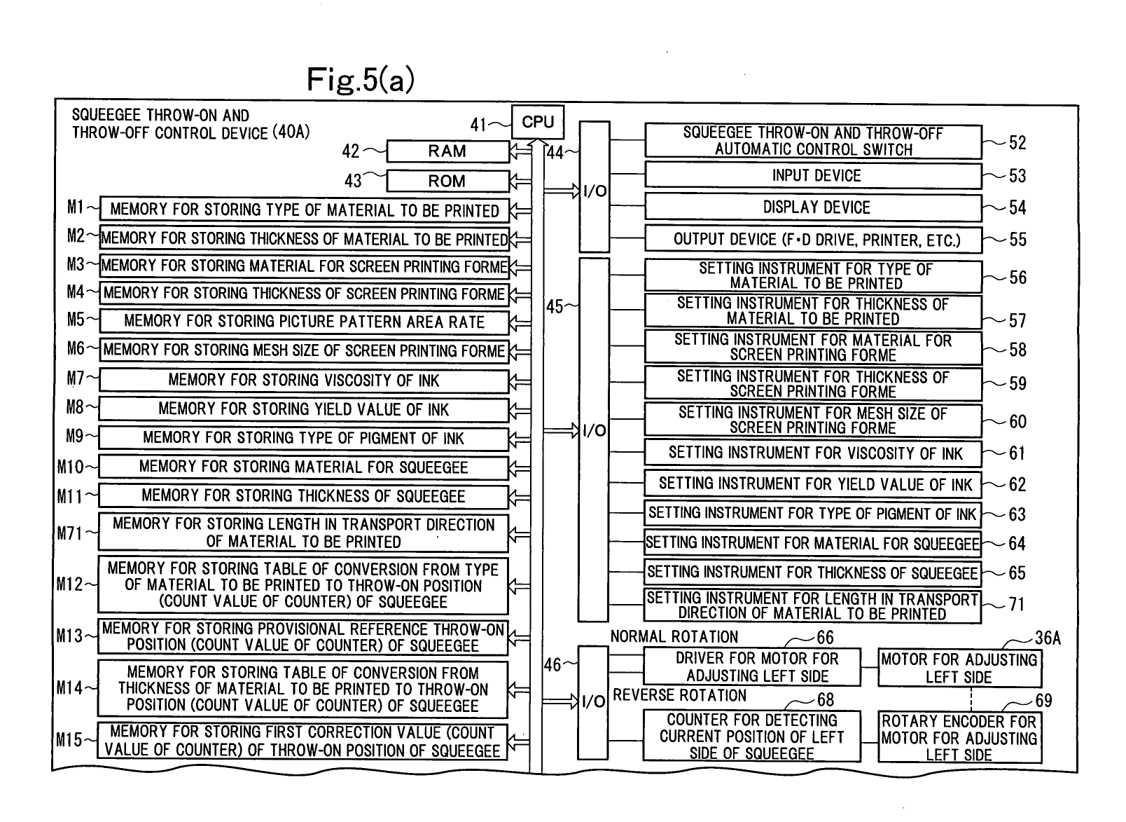

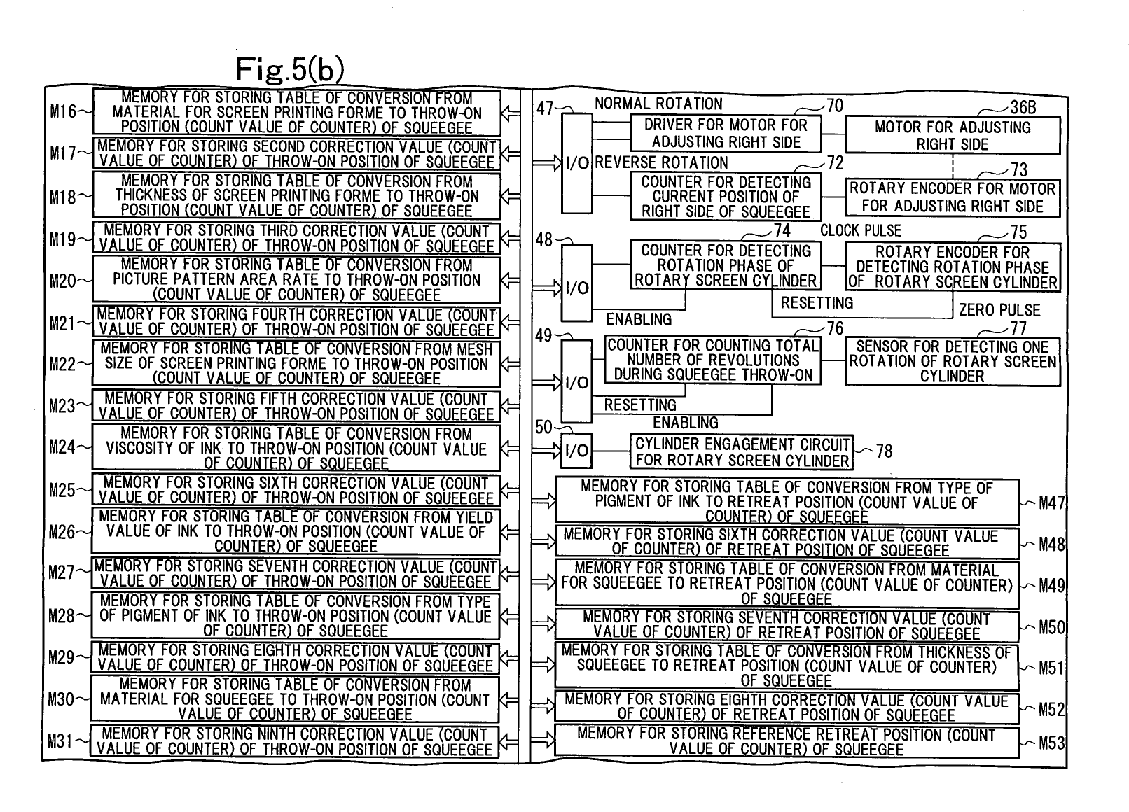

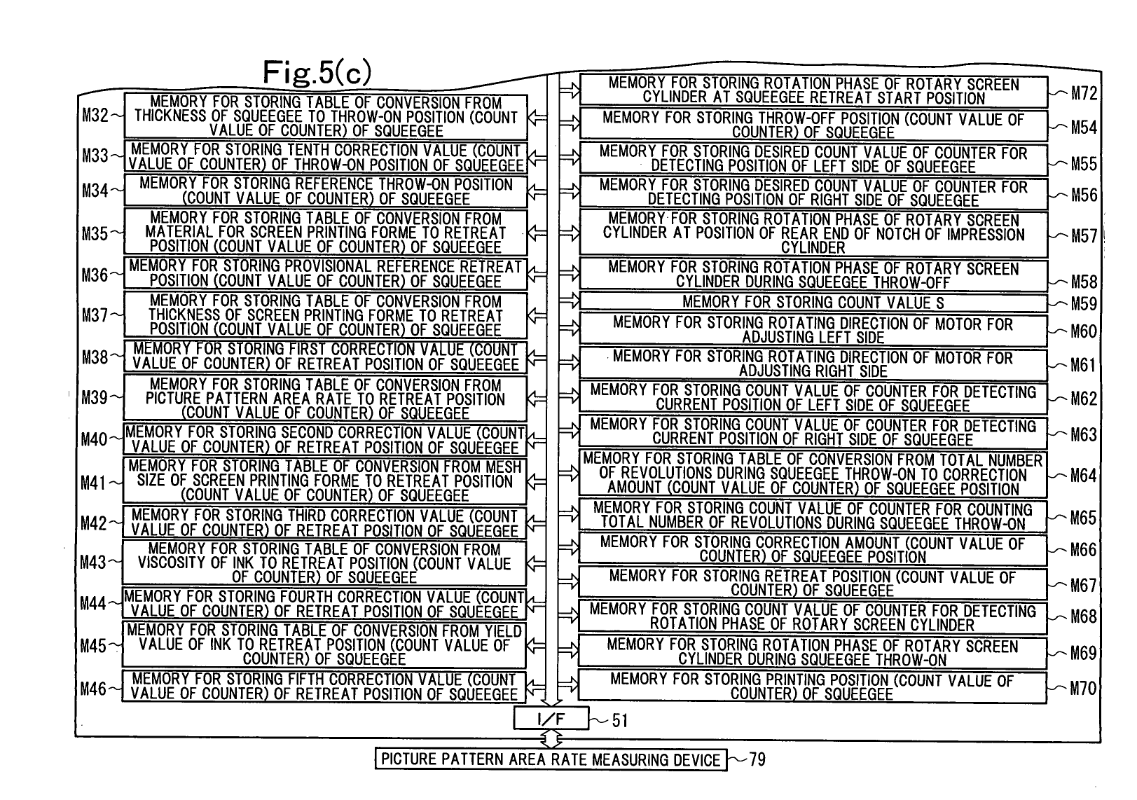

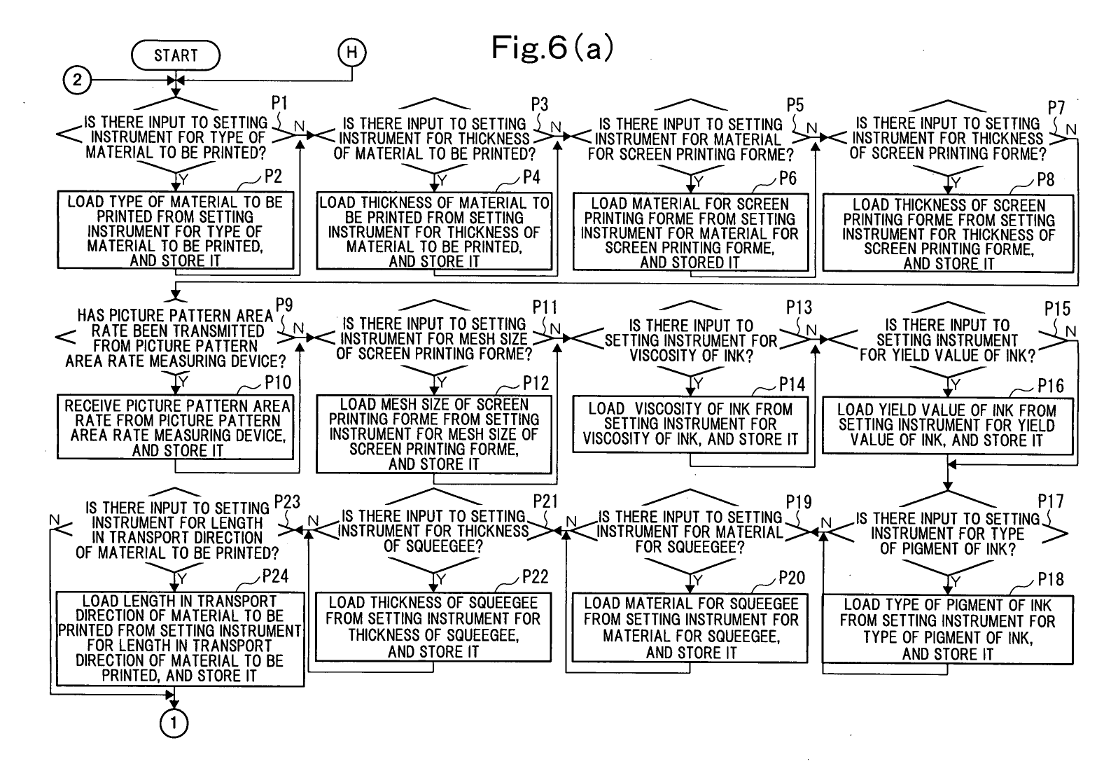

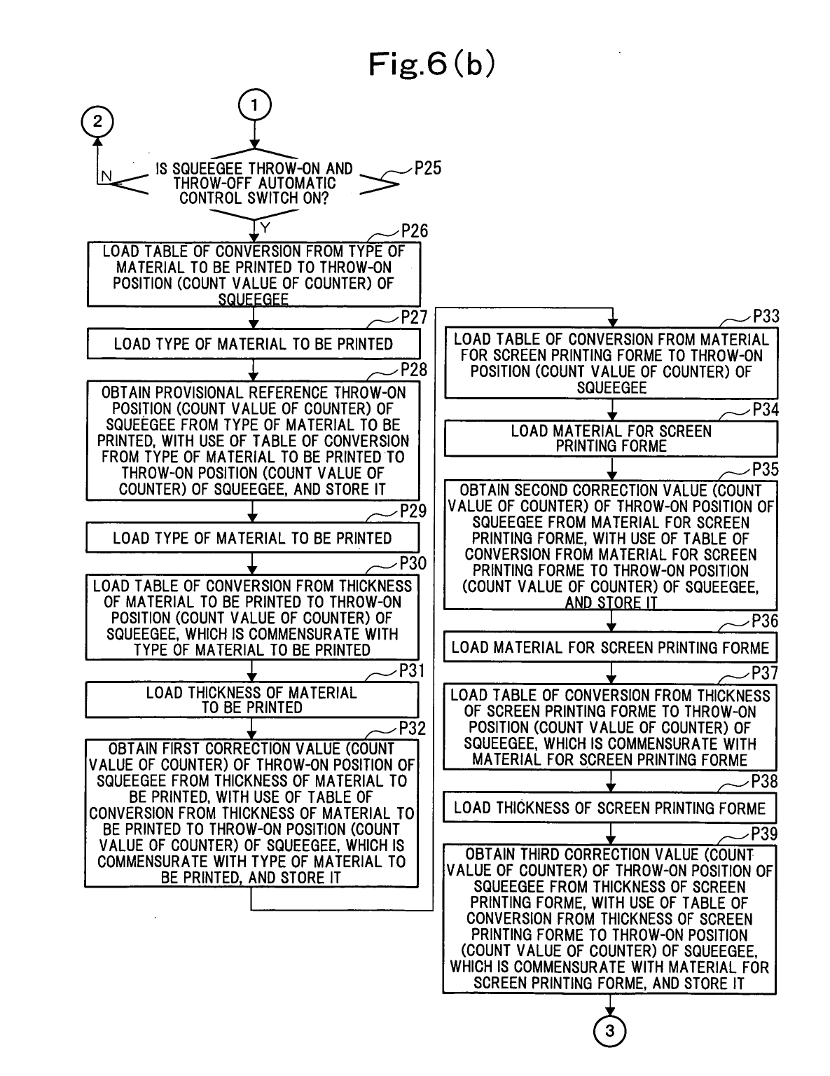

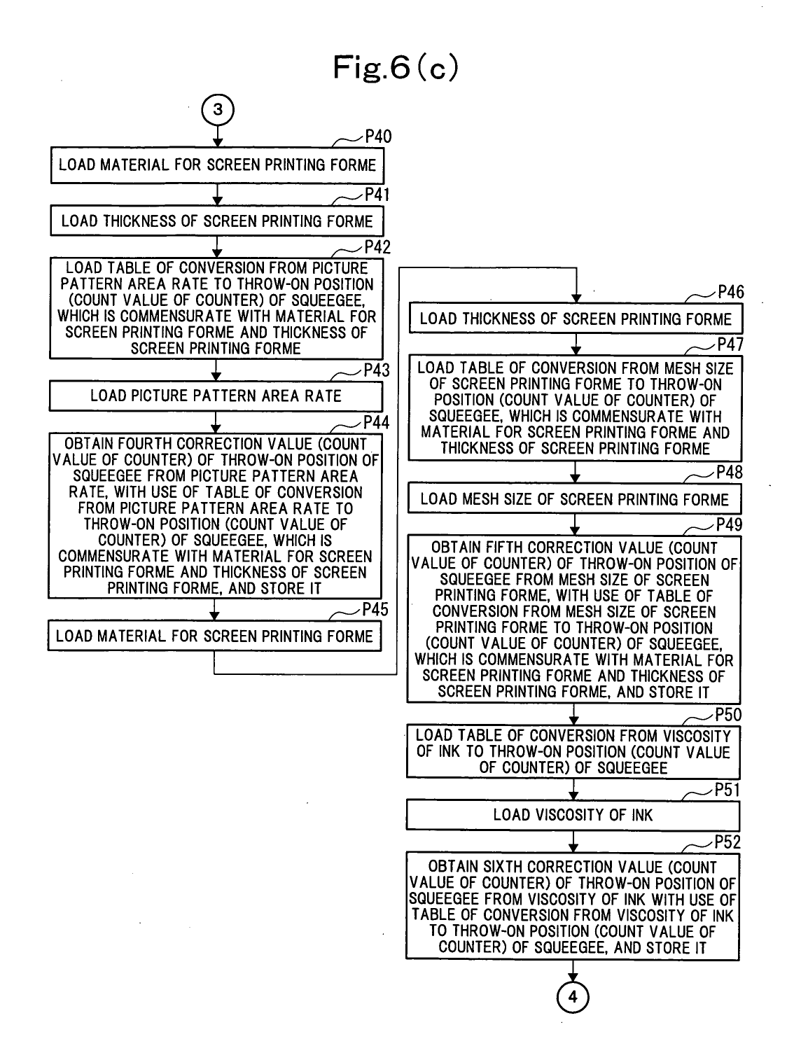

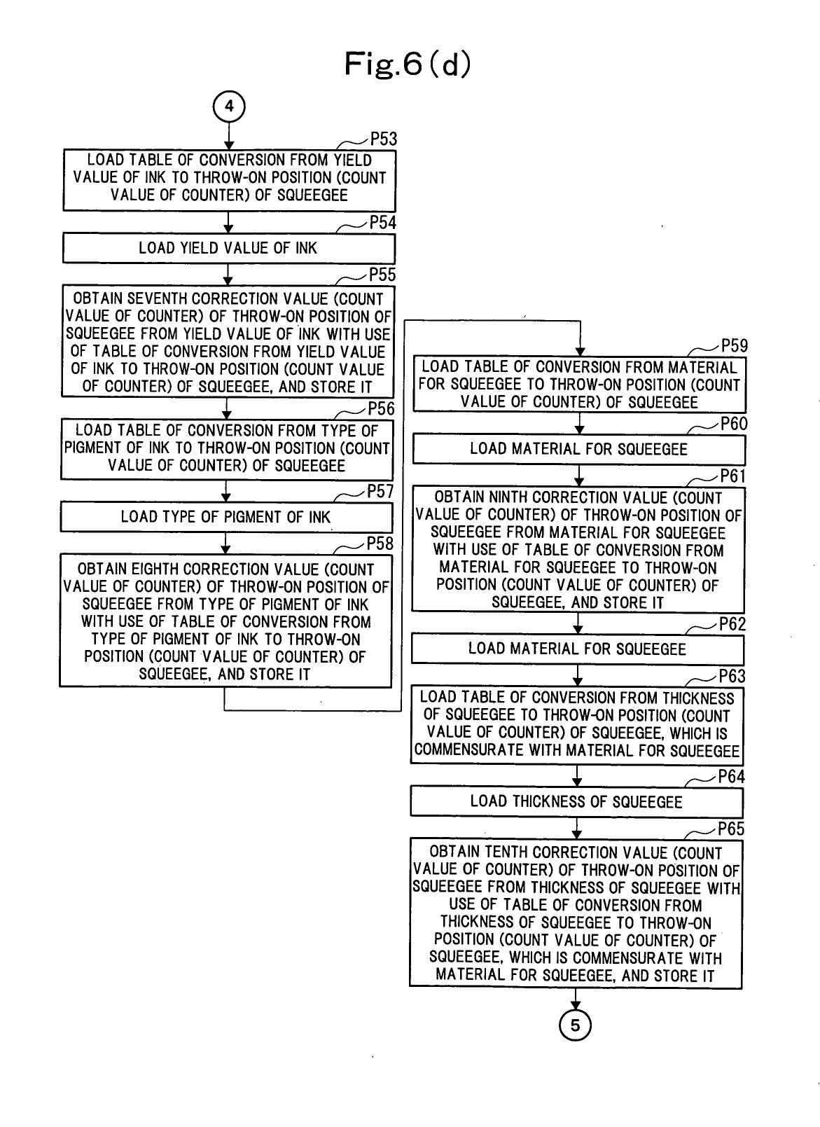

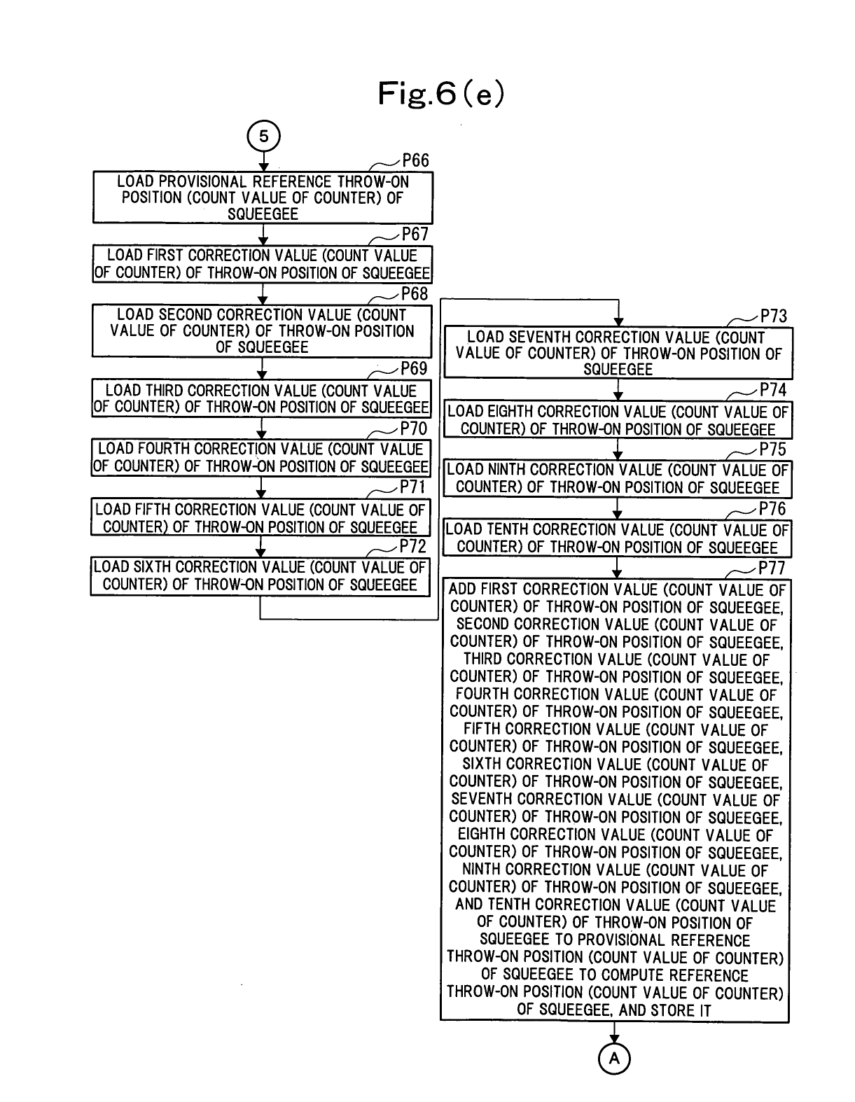

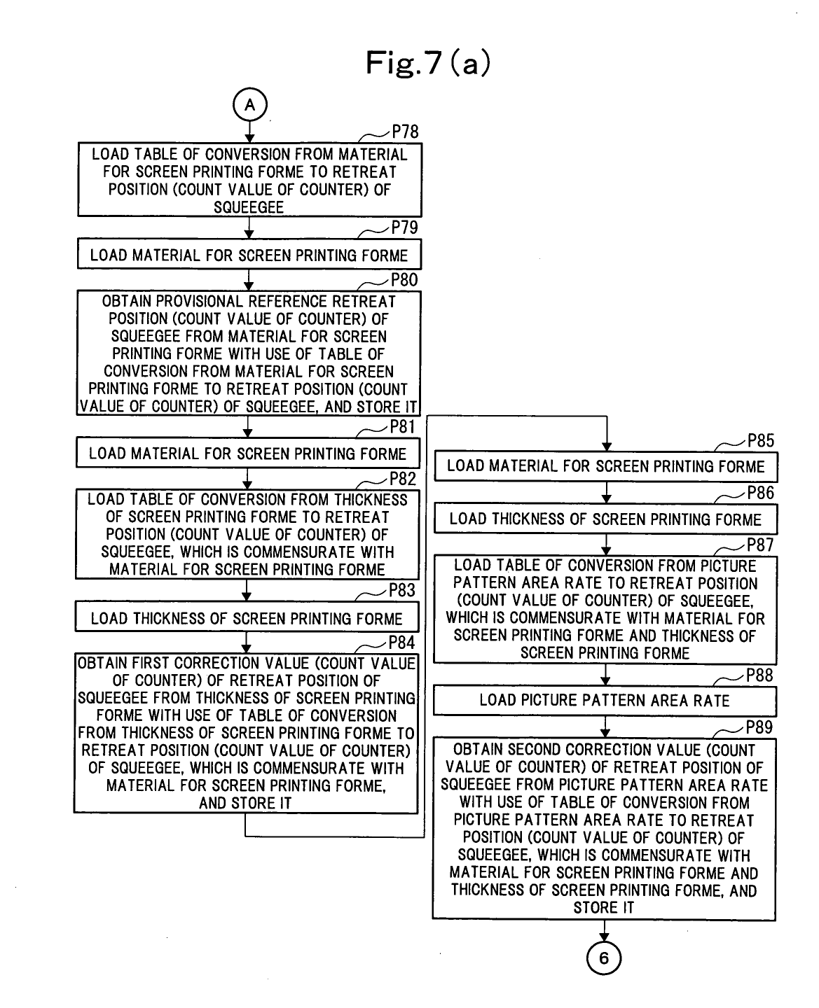

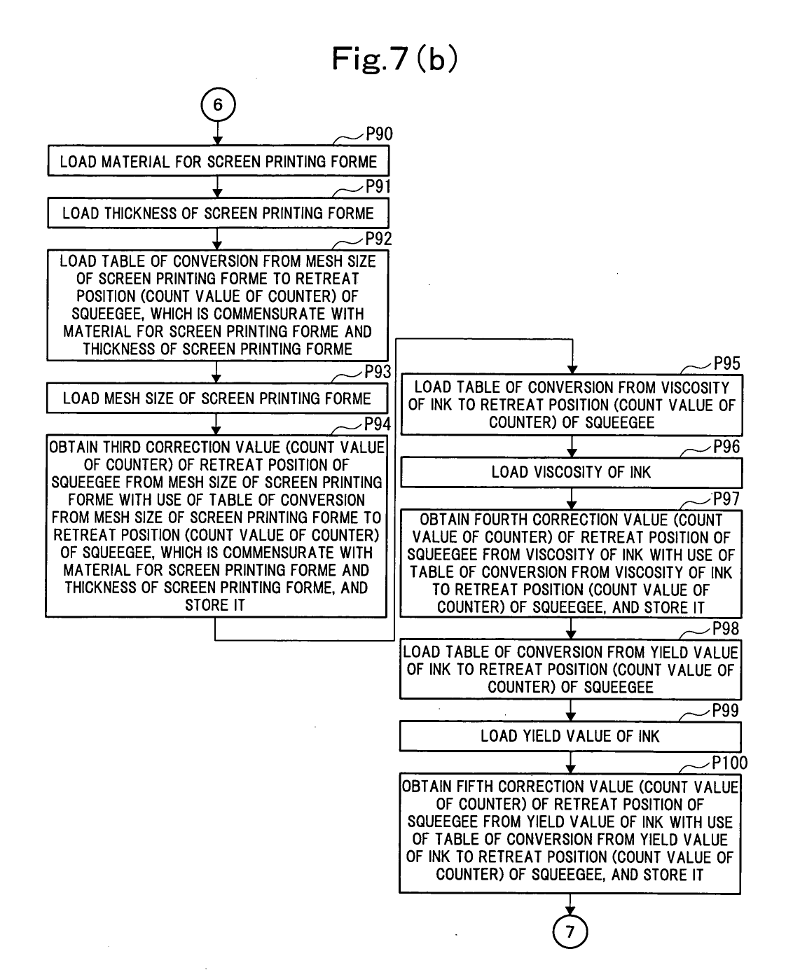

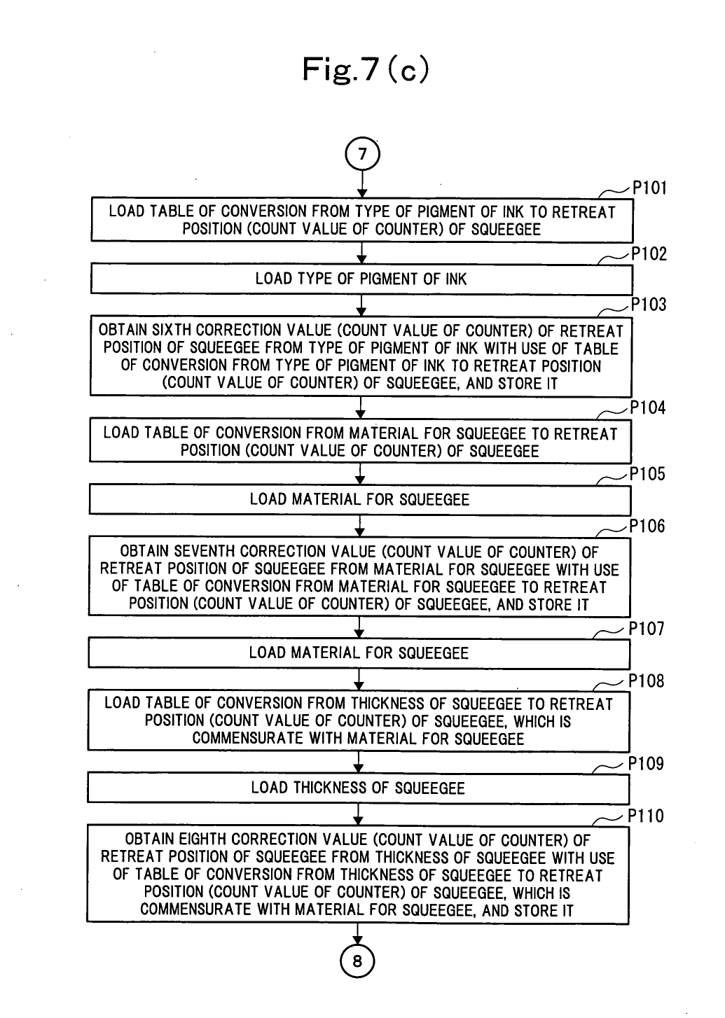

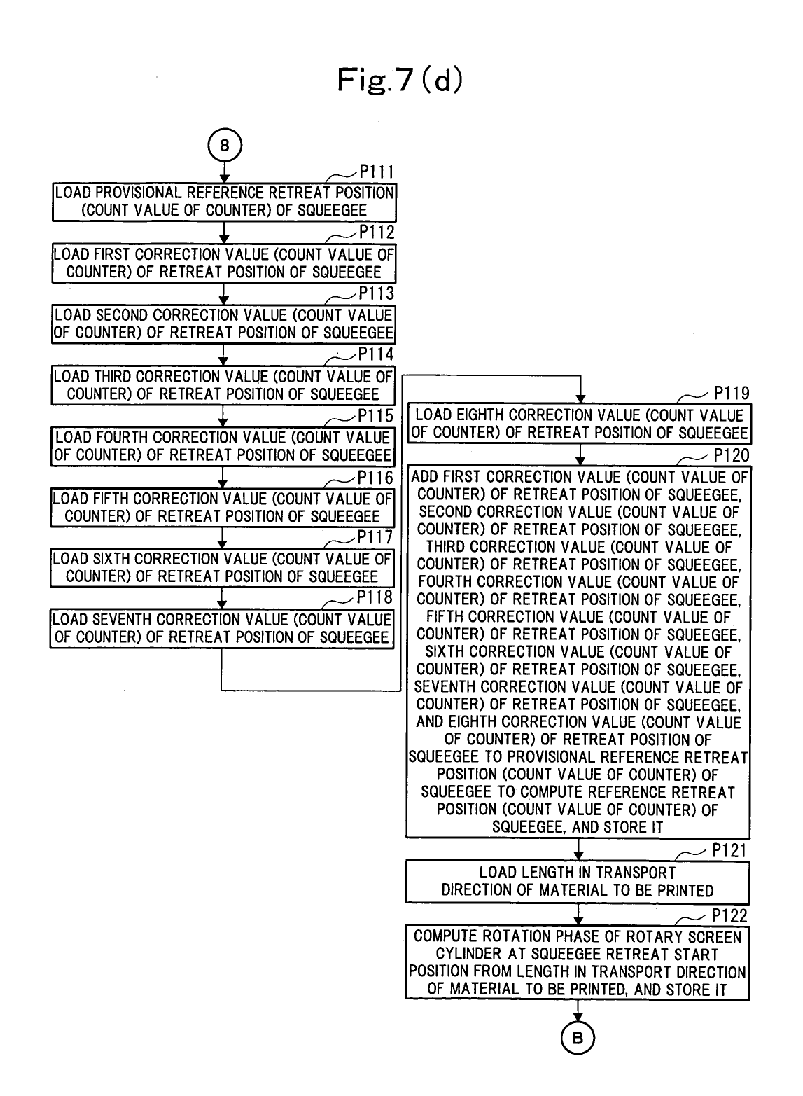

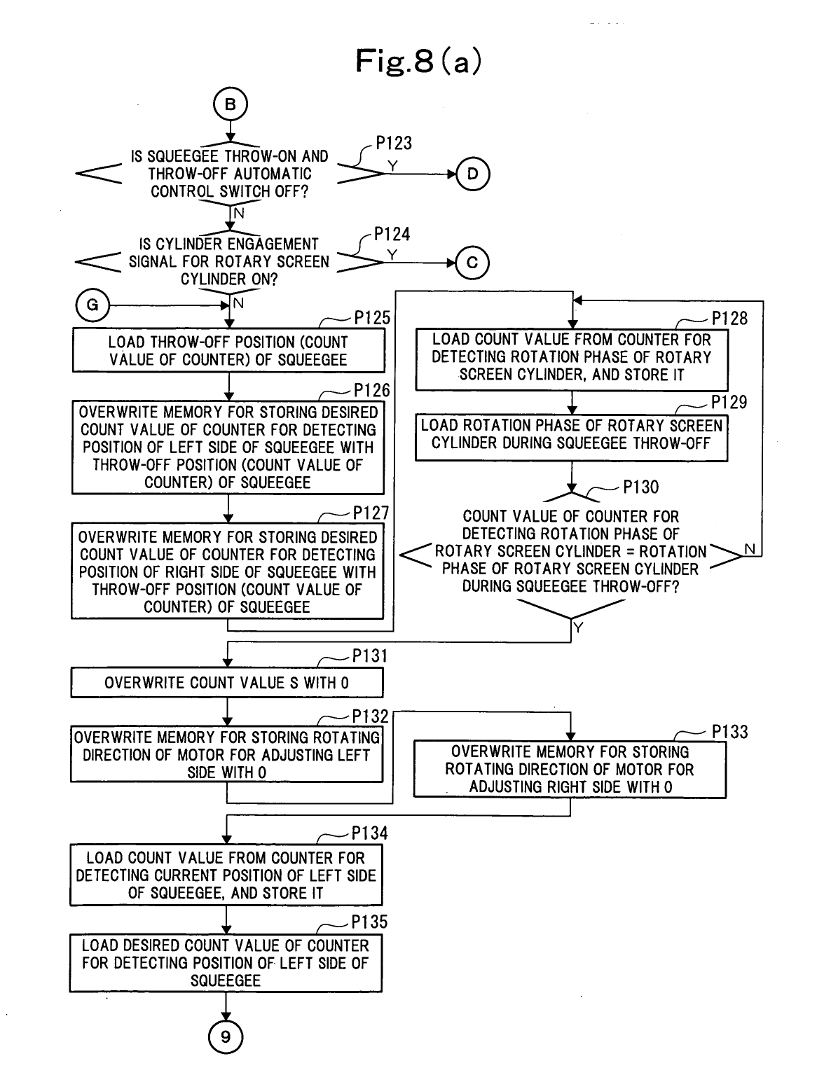

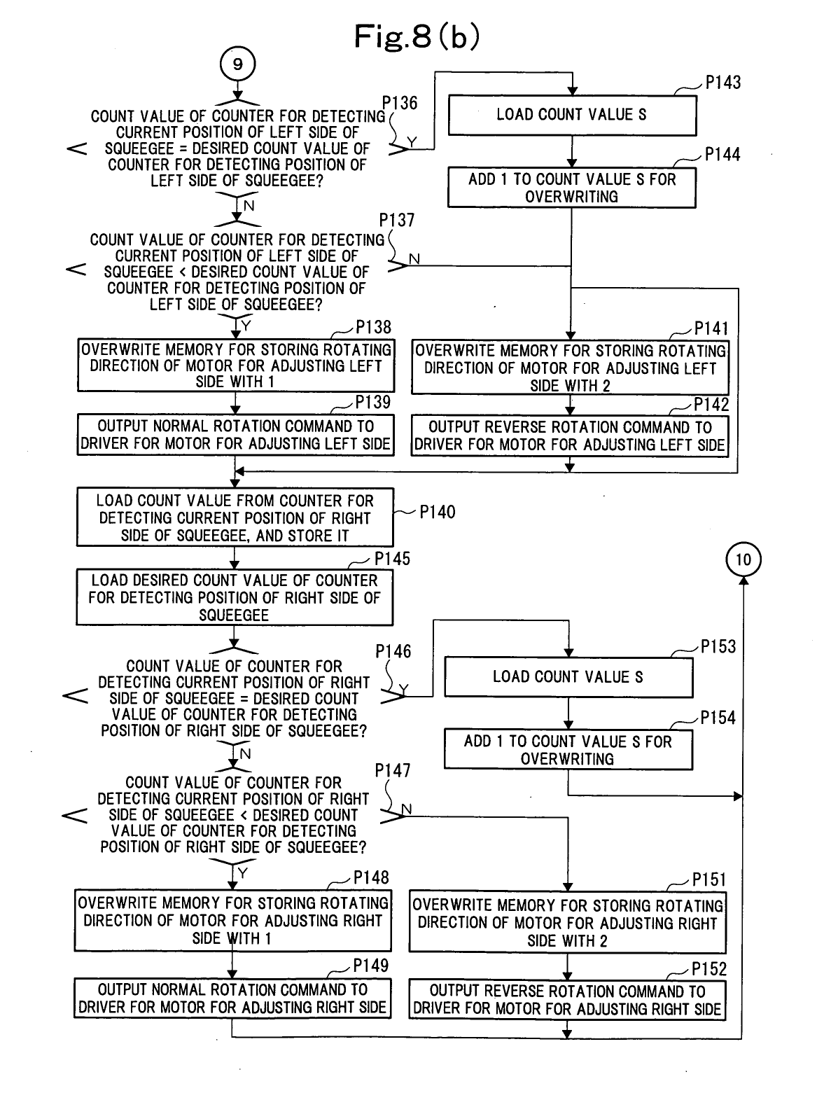

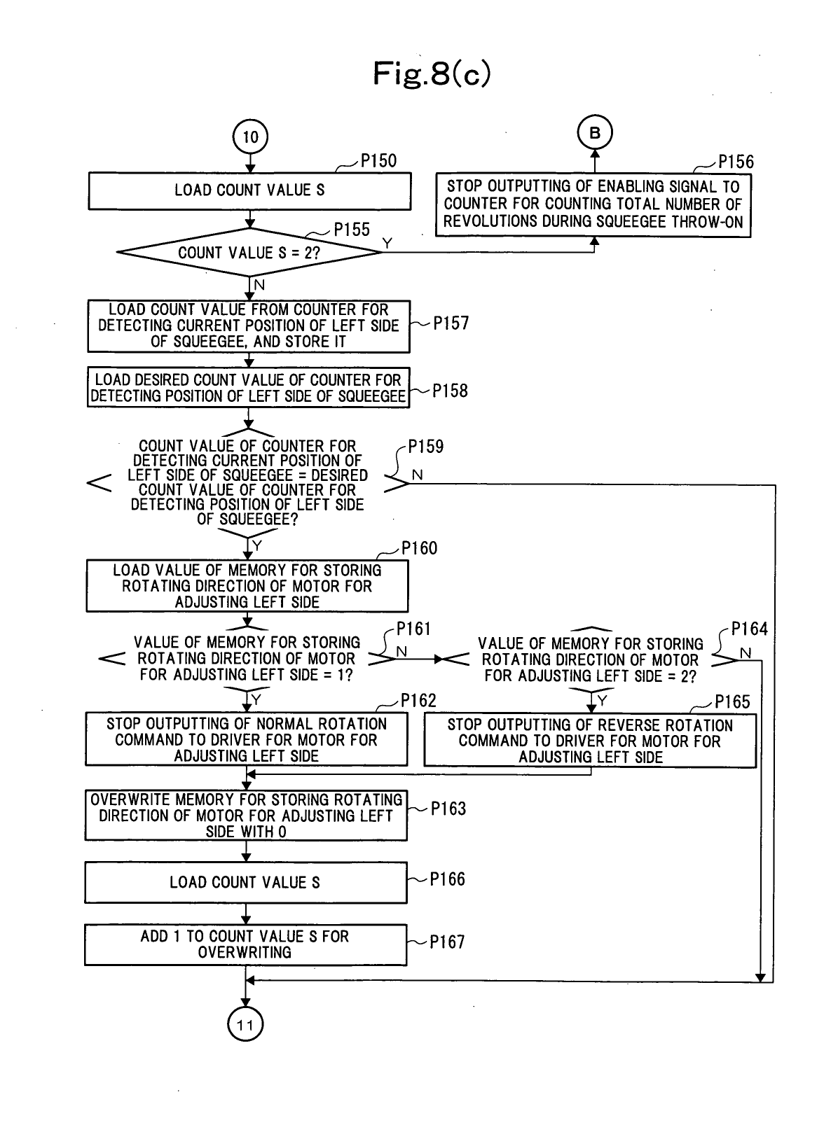

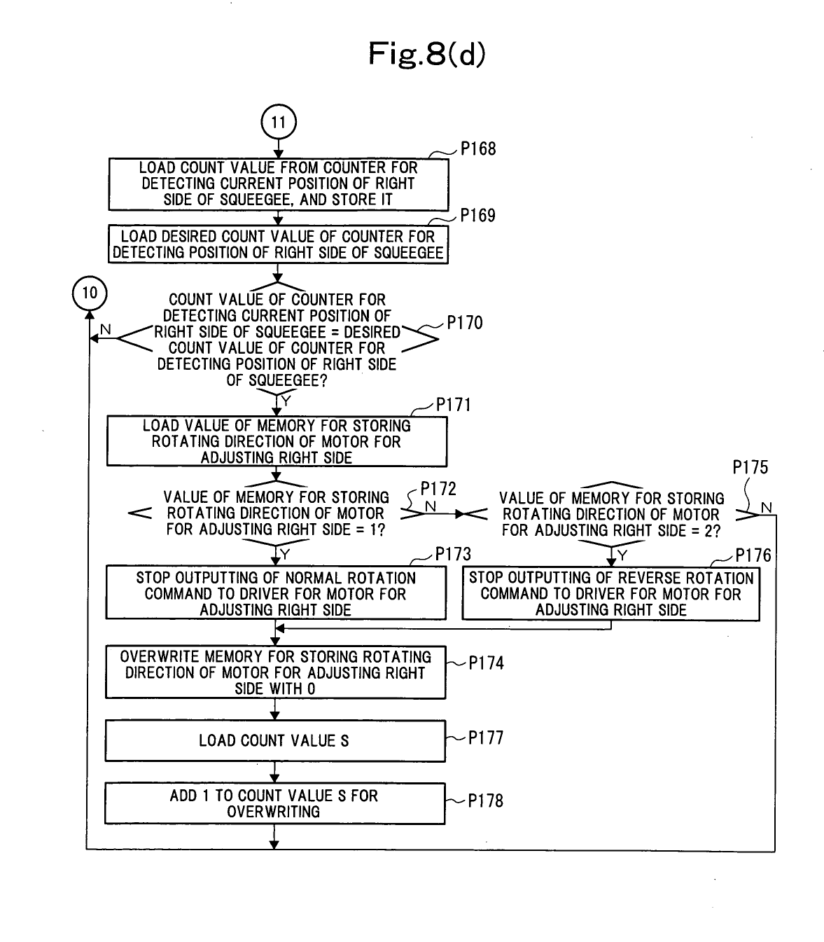

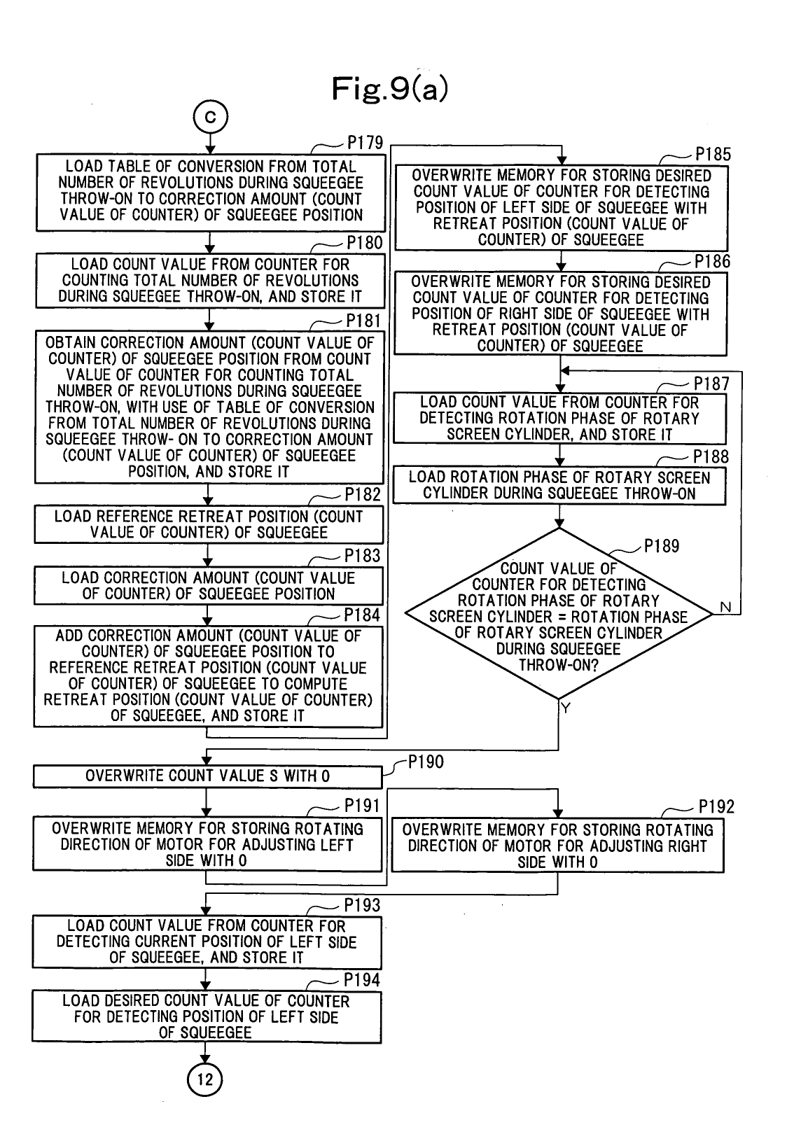

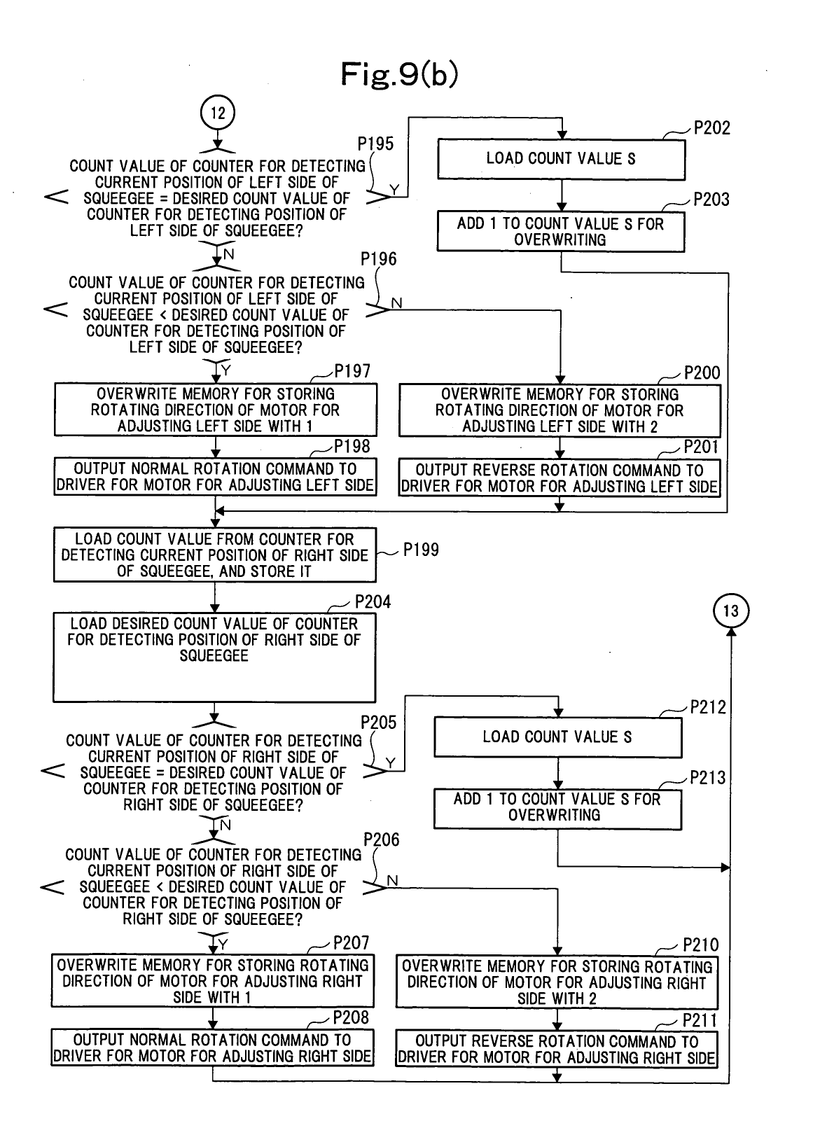

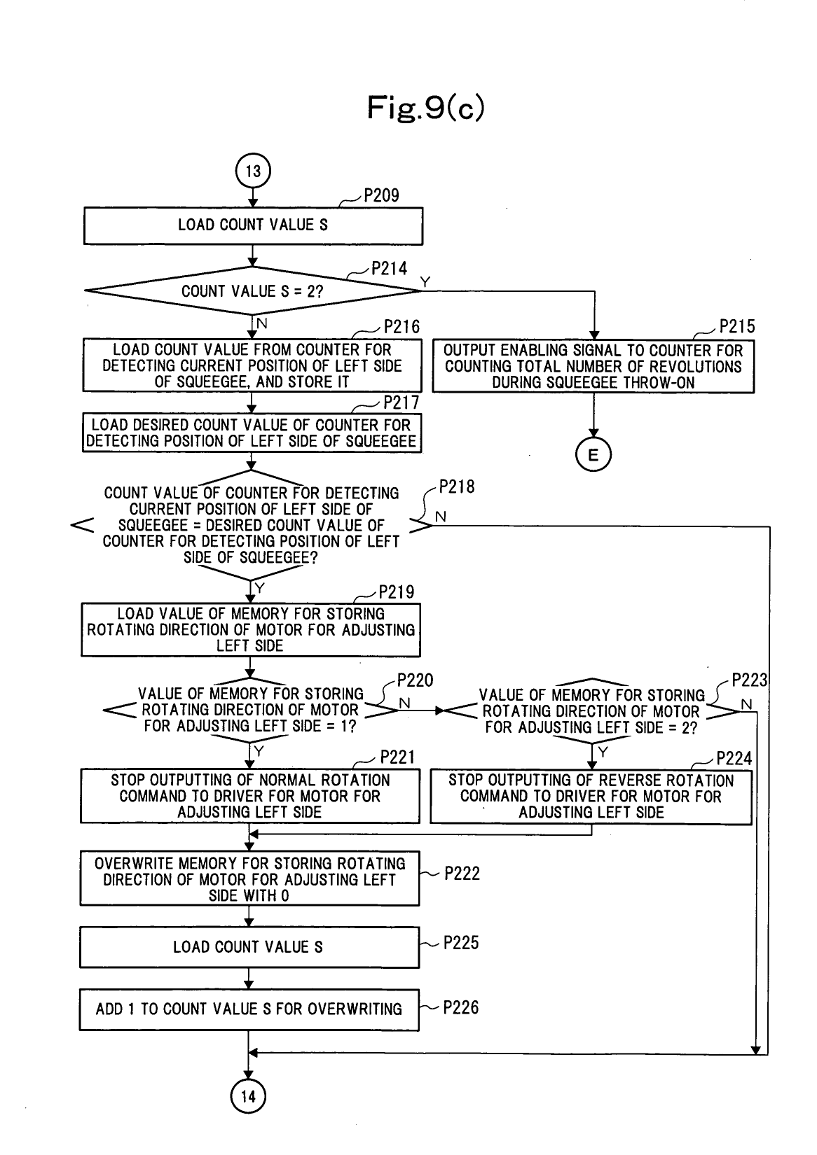

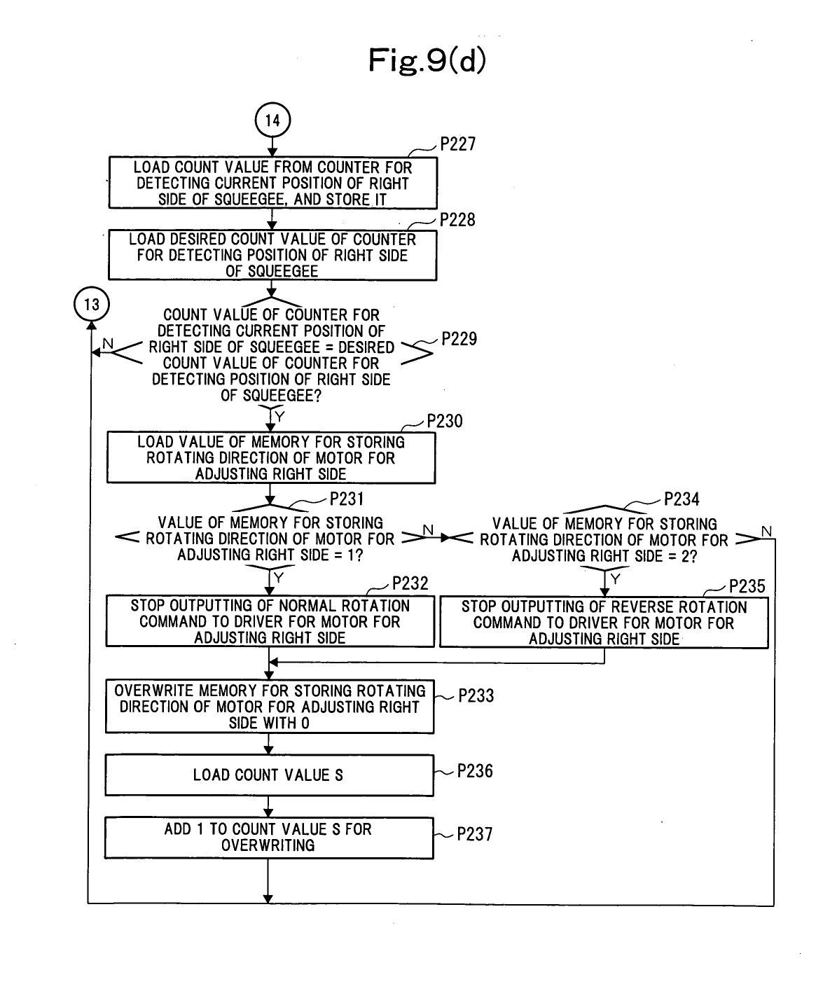

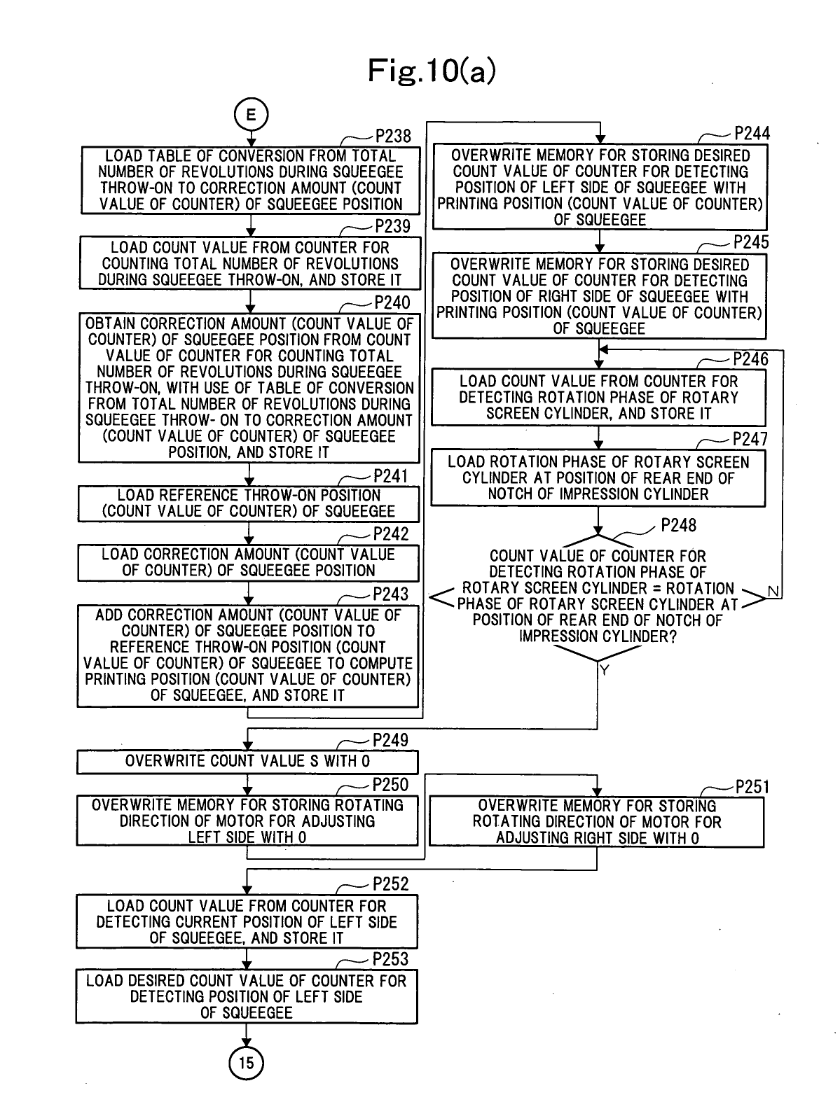

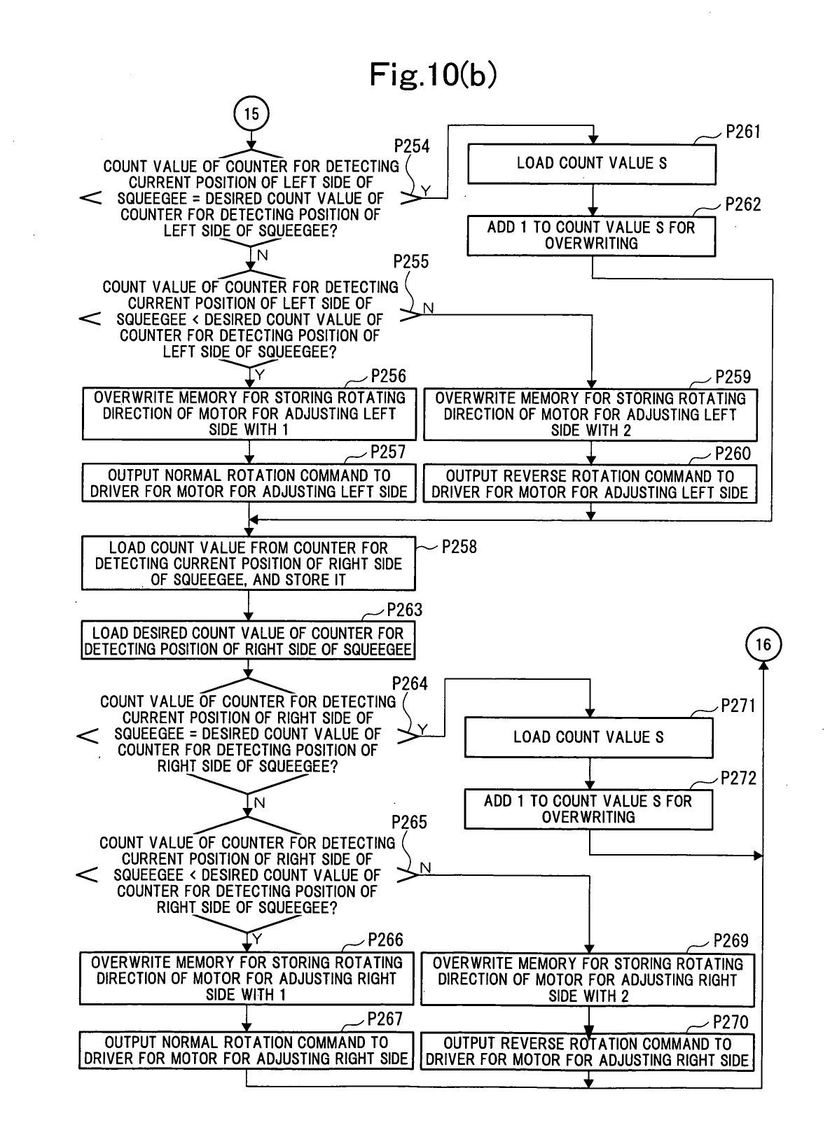

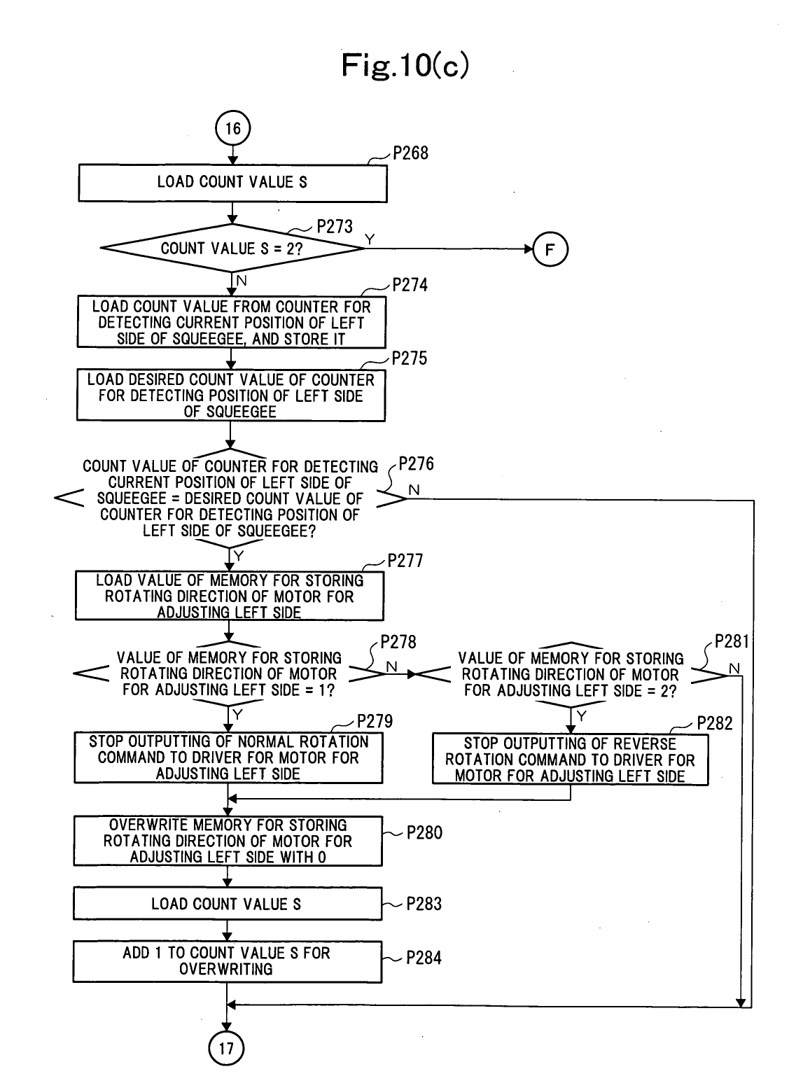

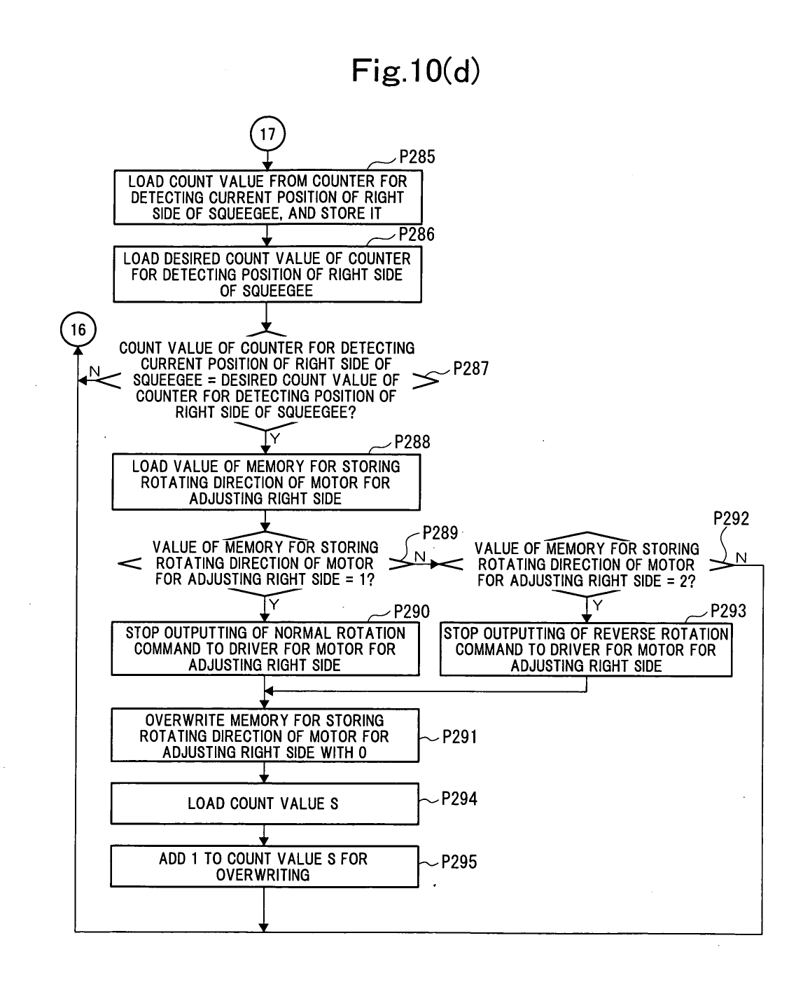

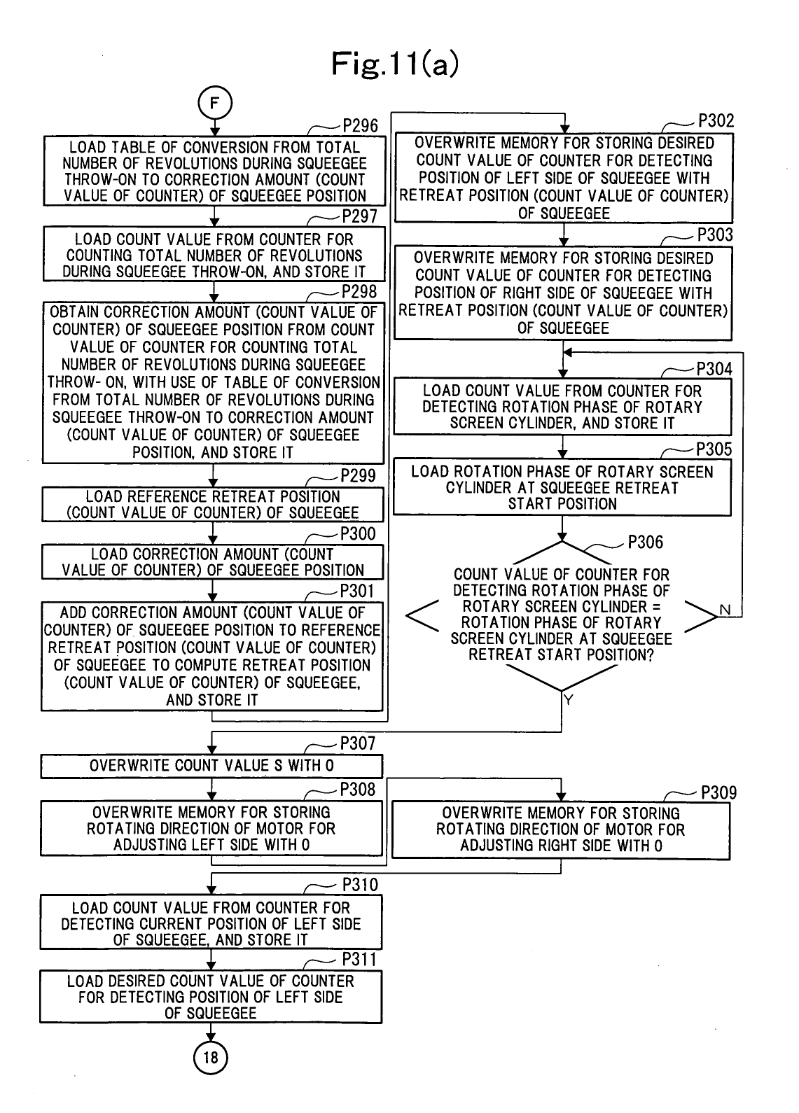

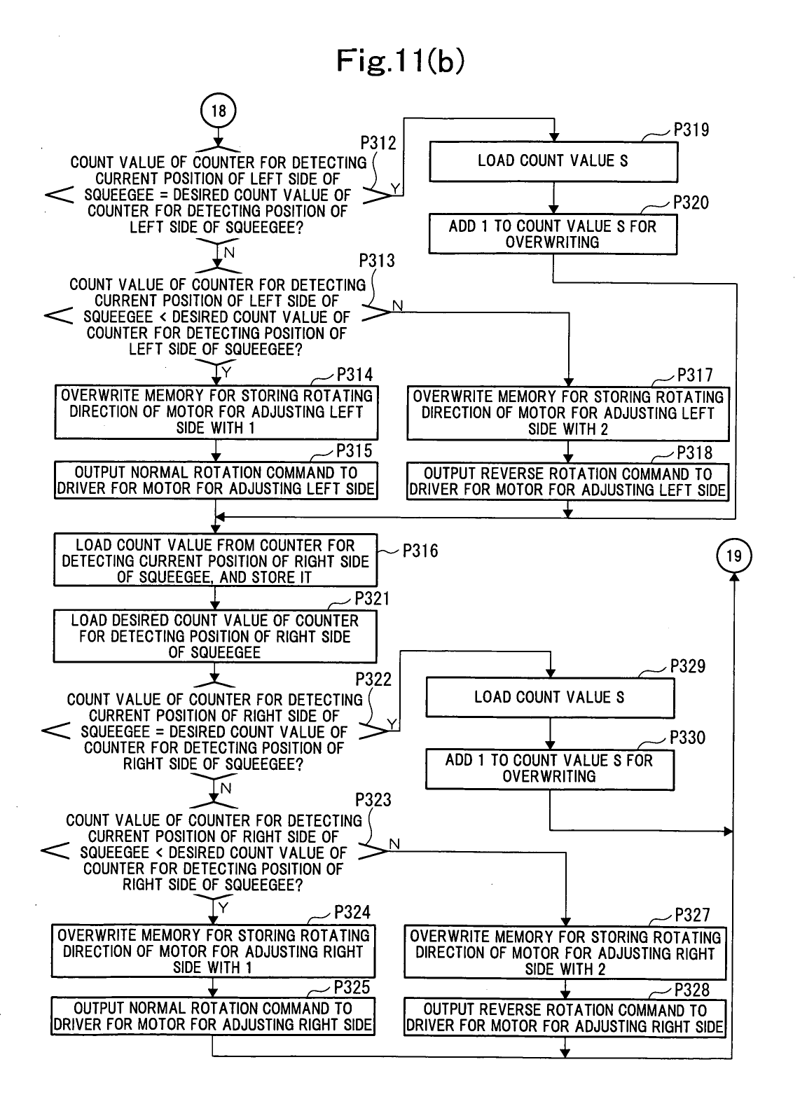

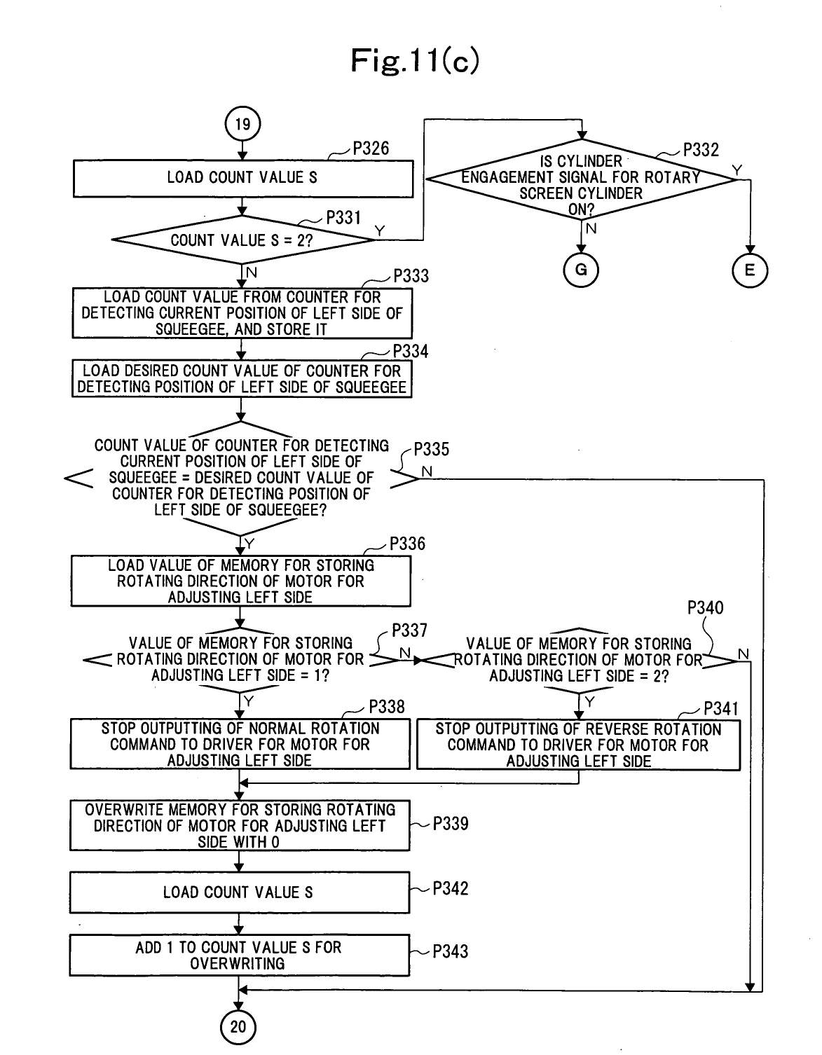

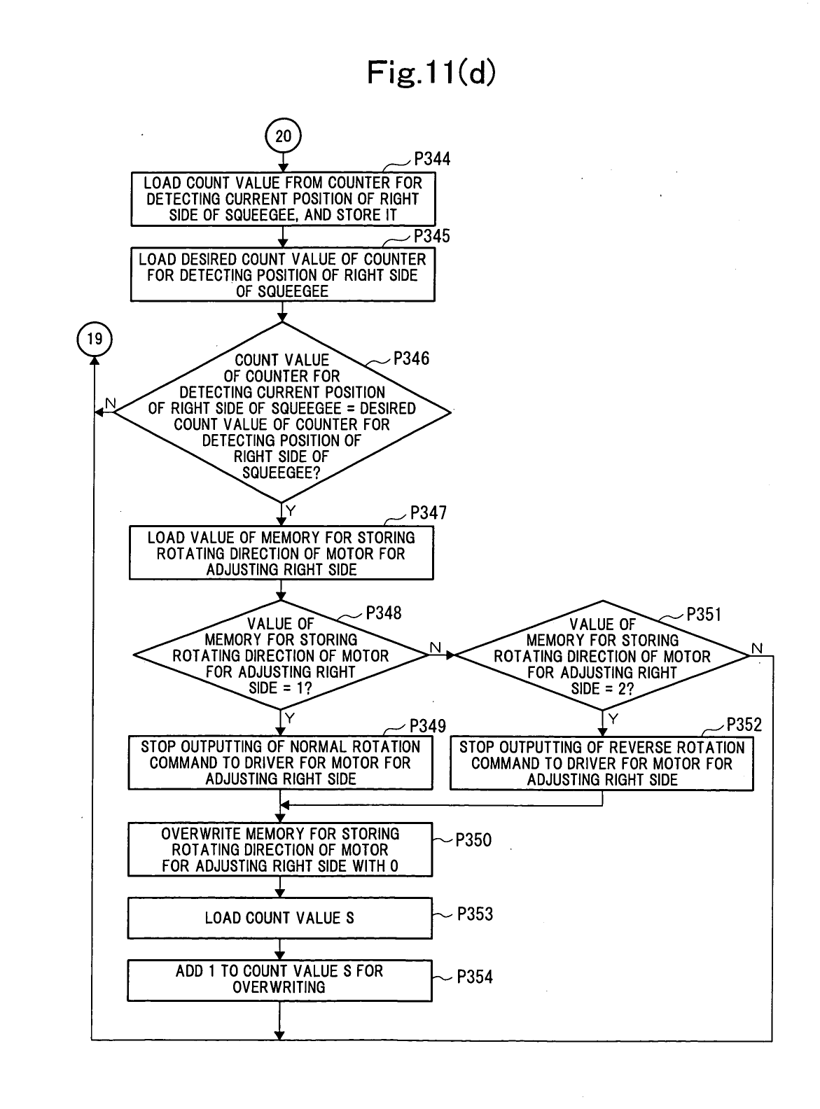

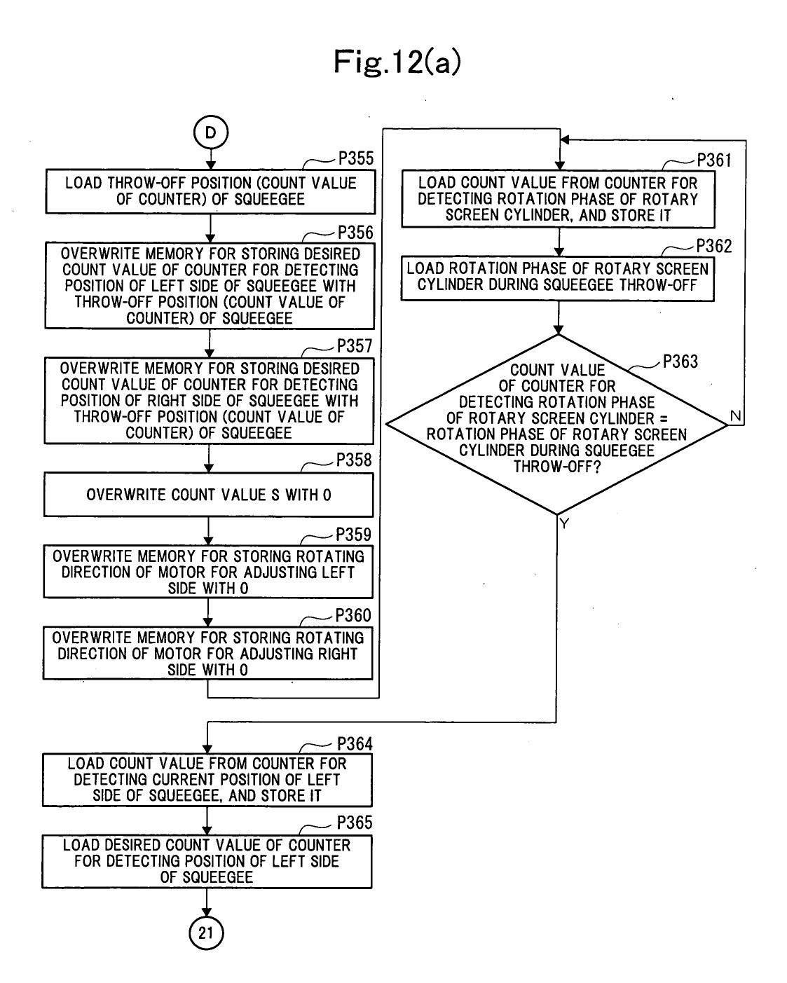

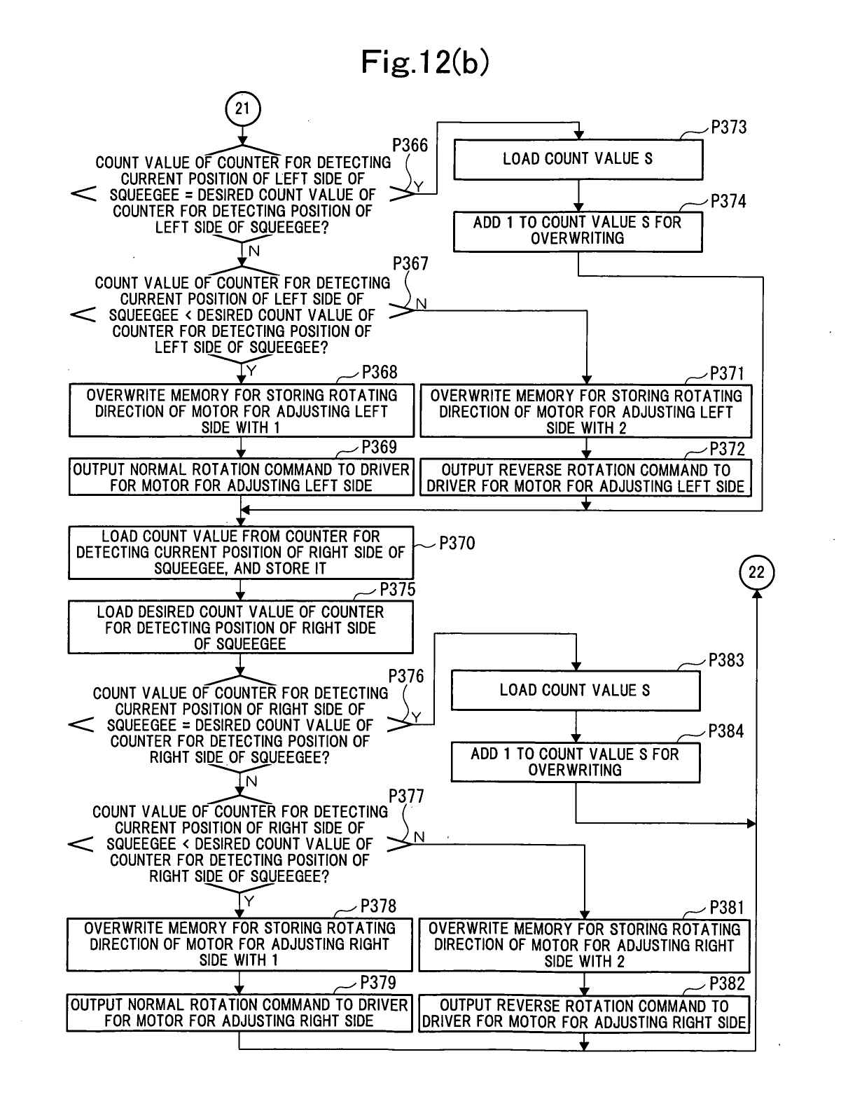

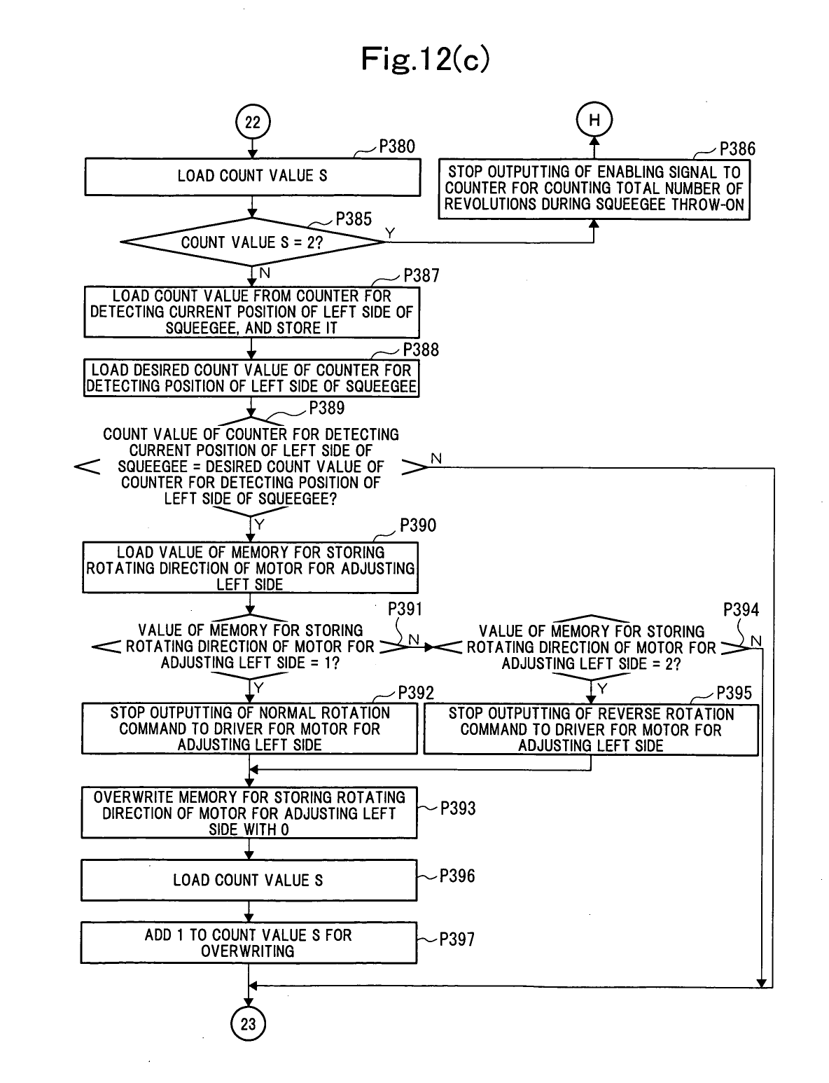

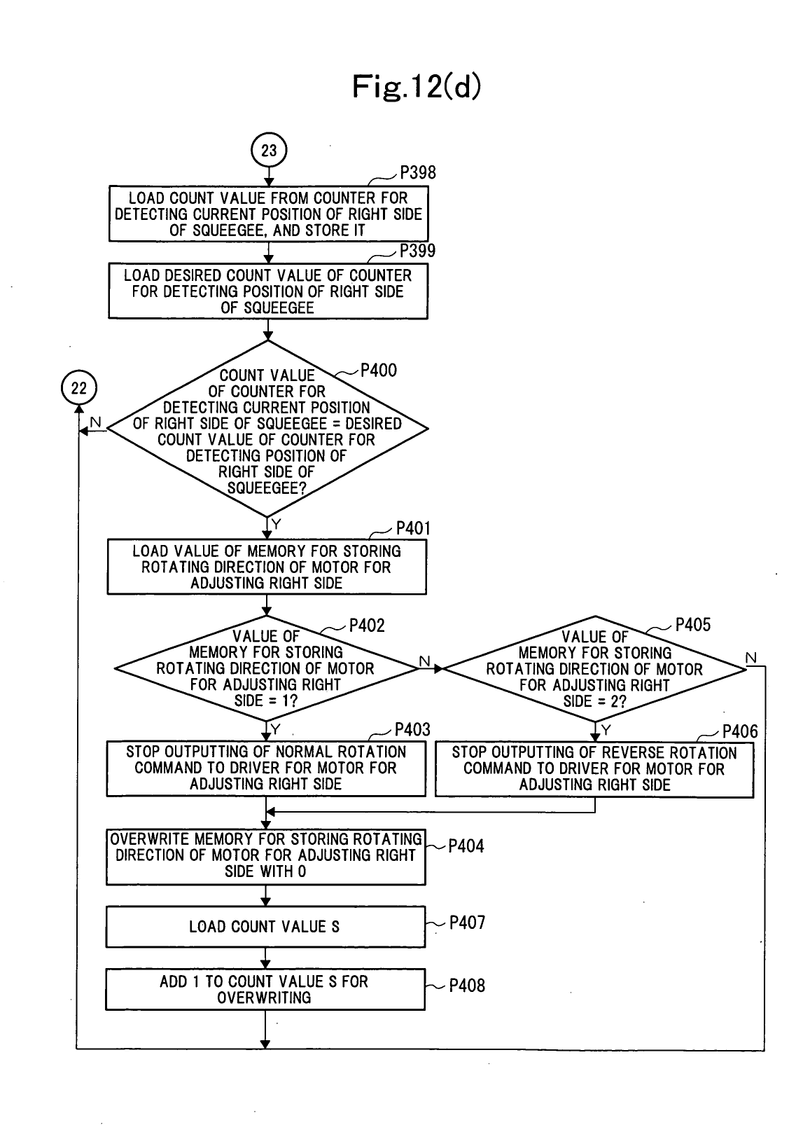

FIG. 1 is a schematic configurational sectional view of a rotary screen printing unit in a rotary screen printing press showing Embodiment 1 of the present invention. FIG. 2 is a right side view of the rotary screen printing unit in FIG. 1. FIG. 3 is a left side view of the rotary screen printing unit in FIG. 1. FIGS. 4(a) and 4(b) are operating state views. FIGS. 5(a) to 5(c) are control block diagrams of a squeegee throw-on and throw-off control device. FIGS. 6(a) to 6(e) are motion flow charts of the squeegee throw-on and throw-off control device. FIGS. 7(a) to 7(d) are motion flow charts of the squeegee throw-on and throw-off control device. FIGS. 8(a) to 8(d) are motion flow charts of the squeegee throw-on and throw-off control device. FIGS. 9(a) to 9(d) are motion flow charts of the squeegee throw-on and throw-off control device. FIGS. 10(a) to 10(d) are motion flow charts of the squeegee throw-on and throw-off control device. FIGS. 11(a) to 11(d) are motion flow charts of the squeegee throw-on and throw-off control device. FIGS. 12(a) to 12(d) are motion flow charts of the squeegee throw-on and throw-off control device.

In the rotary screen printing unit in the rotary screen printing press (rotary stencil printing press=rotary stencil printing plate liquid coating machine), as shown in FIG. 1, a rotary screen cylinder (stencil printing plate cylinder) 11 is supported between right and left frames 10 via eccentric bearings 12 to be capable of being thrown on and thrown off an impression cylinder 13. The right and left eccentric bearings 12 are supported by the right and left frames 10 to be pivotable and slidable in a lateral direction (axial direction).

The impression cylinder 13 has notches (concavities) 13b provided in an outer peripheral surface thereof, each notch 13b accommodating a gripper device (a device for holding a material to be printed) 13a for holding a material to be printed (a material to be liquid coated), W, such as paper, as shown in FIGS. 4(a) and 4(b). In the illustrated embodiment, two of the notches 13b are provided at positions symmetrical with respect to the central point of the impression cylinder 13, but this is not limitative.

The rotary screen cylinder 11 has a cylindrical screen printing forme (stencil printing plate) 11c supported between right and left tubular end members 11a via intermediate members 11b. Also, the rotary screen cylinder 11 is supported by bearings 14 at small-diameter portions of the right and left tubular end members 11a to be rotatable with respect to the eccentric bearings 12.

A gear 15 is located at, and secured to, an end part of the small-diameter portion of the right tubular end member 11a, and a gear 17 secured onto an output shaft of a motor 16 meshes with the gear 15. The motor 16 is mounted on a subframe 18 bound to the right frame 10.

Thus, the rotary screen cylinder 11 can be rotationally driven and circumferentially registered by the motor 16 via the above-mentioned gear mechanism.

One end of a link 19 is pinned to each of the right and left eccentric bearings 12, and the leading end of a lever 20 is pinned to the other end of the link 19. Proximal end portions of the right and left levers 20 are secured to right and left end portions of a rotating shaft 21 journaled between the right and left frames 10. A leading end of an actuator 22 is pinned to the left lever 20.

Hence, the eccentric bearing 12 is pivoted by the actuator 22 via the above-mentioned link mechanism, whereby the rotary screen cylinder 11 is eccentrically rotated to be capable of being thrown on and thrown off the impression cylinder 13 (see FIG. 4(a) and FIG. 4(b)).

An elongated hole, which is formed in a flange portion 12a of each of the right and left eccentric bearings 12, is fitted with a head 23a of a bolt 23 such that the head 23a is rotatable, and movable in the direction of the major diameter of the elongated hole, but immovable in the axial direction. On the other hand, a threaded portion 23b of the bolt 23 is fitted into a tapped hole of the frame 10. A gear 24a is secured to the head 23a of each of the right and left bolts 23, and a gear 24b secured onto an output shaft of a motor 25 meshes with the gear 24a. The right and left motors 25 are mounted on support brackets 26 bound to the right and left frames 10.

Thus, the right and left eccentric bearings 12 are slid in the lateral direction (axial direction) by the motors 25 via the aforementioned gear mechanism and feed screw mechanism to make possible the tension adjustment of the screen printing forme 11c and the movement of the bearing at the time of rotary screen cylinder removal.

As shown in FIGS. 2 and 3 as well, a pipe-shaped support shaft 27 closed at the right end is inserted through the interior of the rotary screen cylinder 11. The right end side of the support shaft 27 is fitted into, and supported by, a fitting hole 28a of a bearing member 28, which is located outwardly and laterally of the subframe 18, in such a manner as to be turnable and movable (slidable) in the lateral direction (axial direction), while the left end side of the support shaft 27 is fitted into, and supported by, a bearing member 29, which is located outwardly and laterally of the left frame 10, in such a manner as not to be turnable and movable (slidable) in the lateral direction (axial direction).

That is, the left end side of the support shaft 27 is inhibited from moving (sliding) in the lateral direction (axial direction) by stepped portions 27a and 27b at two (right and left) locations, and is also inhibited from turning because it is pressed from above by a holding plate 30a while being accommodated within a fitting groove 29a of the bearing member 29 having a groove bottom formed in a taper shape.

The holding plate 30a horizontally rotates about a fulcrum pin 31, and can thus open and close the fitting groove 29a. With the fitting groove 29a being closed, a fixing lever 30b is screwed into the holding plate 30a and the bearing member 29, whereby the closed state is retained.

The right and left bearing members 28 and 29 are supported vertically movably via ball screws 32 by support cases 31 annexed to the frame 10 and the subframe 18. Concretely, a nut member 32a of the ball screw 32 is secured to the interior of the support case 31, and a screw member 32b screwed to the nut member 32a penetrates the interior of the support case 31 in a vertical direction. A non-screw-forming shaft portion of the screw member 32b is supported pivotably and slidably within the support case 31 via a bearing 33.

An upper end portion of the screw member 32b is engaged with an engaging hole 28b or 29b of the bearing member 28 or 29 via a spherical bearing 34 to permit the rotation of the screw member 32b and the inclination of the support shaft 27 during position adjustment (to be described later) of the support shaft 27. A gear 35a is secured to a lower end portion of the screw member 32b, and a gear 35b secured onto an output shaft of a motor 36A or 36B meshes with the gear 35a. The motor 36A for adjusting the left side is mounted on an outer surface of the frame 10, and the motor 36B for adjusting the right side is mounted on an outer surface of the subframe 18.

In FIG. 1, reference numeral 39 denotes a whirl-stop pin for positioning of the bearing member 28 or 29 in the absence of the support shaft 27, and for positioning, in the longitudinal direction, of the support shaft 27.

A rubber squeegee (ink transfer member =liquid transfer member) 38 is supported on the support shaft 27 via a holder 37, as shown in FIGS. 4(a) and 4(b). A leading end of the squeegee 38 makes a sliding contact with the inner peripheral surface of the screen printing forme 11c, with the result that ink (liquid) supplied into the screen printing forme 11c through the interior of the support shaft 27 is transferred onto a printing surface of the material to be printed, W, via holes of the screen printing forme 11c.

In the present Embodiment 1, the motors 36A and 36B are drivingly controlled, independently of each other, by a squeegee throw-on and throw-off control device (control means) 40A to be described later, whereby throw-on and throw-off of the squeegee 38 with respect to the inner peripheral surface of the screen printing forme 11c, and the adjustment of the throw-on position of the squeegee 38 are automatically carried out.

With the present Embodiment 1, moreover, the squeegee 38 is moved by the squeegee throw-on and throw-off control device 40A to the position of retreat from the notch 13b of the impression cylinder 13 with a timing conformed to the preset length in the transport direction of the material W to be printed.

Furthermore, the above-mentioned position of retreat or retreat position is controlled to a position where the leading end of the squeegee 38 makes contact with the inner peripheral surface of the screen printing forme 11c, and the pressing force of the squeegee 38 acting on the inner peripheral surface of the screen printing forme 11c becomes smaller than the pressing force exerted during printing (liquid coating).

The squeegee throw-on and throw-off control device 40A can preset the pressing force of the squeegee 38 at the retreat position of the squeegee 38, in accordance with the type of the screen printing forme 11c (material, forme thickness, mesh size, etc.), the picture pattern area rate (or image area rate) of a picture pattern which is printed on the material W to be printed, the type of ink used in printing (viscosity, yield value, type of pigment, etc.), and the type of the squeegee 38 (material, thickness, etc.). Concretely, relevant motions will be described by motion flow charts to be offered later.

The squeegee throw-on and throw-off control device 40A comprises CPU 41, RAM 42, ROM 43, input/output devices 44 to 50, and an interface 51 connected together by BUS (bus line), as shown in FIGS. 5(a) to 5(c). To the BUS (bus line), the following memories are connected: A memory M1 for storing the type of the material to be printed, a memory M2 for storing the thickness of the material to be printed, a memory M3 for storing the material for the screen printing forme, a memory M4 for storing the thickness of the screen printing forme, a memory M5 for storing the picture pattern area rate, a memory M6 for storing the mesh size of the screen printing forme, a memory M7 for storing the viscosity of ink, a memory M8 for storing the yield value of ink, a memory M9 for storing the type of a pigment of ink, a memory M10 for storing the material for the squeegee, a memory M11 for storing the thickness of the squeegee, and a memory M71 for storing the length in the transport direction of the material to be printed.

To the BUS (bus line), the following memories are further connected: A memory M12 for storing a table of conversion from the type of the material to be printed to the throw-on position (count value of a counter) of the squeegee, a memory M13 for storing the provisional reference throw-on position (count value of the counter) of the squeegee, a memory M14 for storing a table of conversion from the thickness of the material to be printed to the throw-on position (count value of the counter) of the squeegee, a memory M15 for storing the first correction value (count value of the counter) of the throw-on position of the squeegee, a memory M16 for storing a table of conversion from the material for the screen printing forme to the throw-on position (count value of the counter) of the squeegee, a memory M17 for storing the second correction value (count value of the counter) of the throw-on position of the squeegee, a memory M18 for storing a table of conversion from the thickness of the screen printing forme to the throw-on position (count value of the counter) of the squeegee, a memory M19 for storing the third correction value (count value of the counter) of the throw-on position of the squeegee, a memory M20 for storing a table of conversion from the picture pattern area rate to the throw-on position (count value of the counter) of the squeegee, and a memory M21 for storing the fourth correction value (count value of the counter) of the throw-on position of the squeegee.

To the BUS (bus line), the following memories are further connected: A memory M22 for storing a table of conversion from the mesh size of the screen printing forme to the throw-on position (count value of the counter) of the squeegee, a memory M23 for storing the fifth correction value (count value of the counter) of the throw-on position of the squeegee, a memory M24 for storing a table of conversion from the viscosity of ink to the throw-on position (count value of the counter) of the squeegee, a memory M25 for storing the sixth correction value (count value of the counter) of the throw-on position of the squeegee, a memory M26 for storing a table of conversion from the yield value of ink to the throw-on position (count value of the counter) of the squeegee, a memory M27 for storing the seventh correction value (count value of the counter) of the throw-on position of the squeegee, a memory M28 for storing a table of conversion from the type of the pigment of ink to the throw-on position (count value of the counter) of the squeegee, a memory M29 for storing the eighth correction value (count value of the counter) of the throw-on position of the squeegee, a memory M30 for storing a table of conversion from the material for the squeegee to the throw-on position (count value of the counter) of the squeegee, a memory M31 for storing the ninth correction value (count value of the counter) of the throw-on position of the squeegee, a memory M32 for storing a table of conversion from the thickness of the squeegee to the throw-on position (count value of the counter) of the squeegee, and a memory M33 for storing the tenth correction value (count value of the counter) of the throw-on position of the squeegee.

To the BUS (bus line), the following memories are further connected: A memory M34 for storing the reference throw-on position (count value of the counter) of the squeegee, a memory M35 for storing a table of conversion from the material for the screen printing forme to the retreat position (count value of the counter) of the squeegee, a memory M36 for storing the provisional reference retreat position (count value of the counter) of the squeegee, a memory M37 for storing a table of conversion from the thickness of the screen printing forme to the retreat position (count value of the counter) of the squeegee, a memory M38 for storing the first correction value (count value of the counter) of the retreat position of the squeegee, a memory M39 for storing a table of conversion from the picture pattern area rate to the retreat position (count value of the counter) of the squeegee, a memory M40 for storing the second correction value (count value of the counter) of the retreat position of the squeegee, a memory M41 for storing a table of conversion from the mesh size of the screen printing forme to the retreat position (count value of the counter) of the squeegee, a memory M42 for storing the third correction value (count value of the counter) of the retreat position of the squeegee, a memory M43 for storing a table of conversion from the viscosity of ink to the retreat position (count value of the counter) of the squeegee, a memory M44 for storing the fourth correction value (count value of the counter) of the retreat position of the squeegee, a memory M45 for storing a table of conversion from the yield value of ink to the retreat position (count value of the counter) of the squeegee, and a memory M46 for storing the fifth correction value (count value of the counter) of the retreat position of the squeegee.

To the BUS (bus line), the following memories are further connected: A memory M47 for storing a table of conversion from the type of the pigment of ink to the retreat position (count value of the counter) of the squeegee, a memory M48 for storing the sixth correction value (count value of the counter) of the retreat position of the squeegee, a memory M49 for storing a table of conversion from the material for the squeegee to the retreat position (count value of the counter) of the squeegee, a memory M50 for storing the seventh correction value (count value of the counter) of the retreat position of the squeegee, a memory M51 for storing a table of conversion from the thickness of the squeegee to the retreat position (count value of the counter) of the squeegee, a memory M52 for storing the eighth correction value (count value of the counter) of the retreat position of the squeegee, a memory M53 for storing the reference retreat position (count value of the counter) of the squeegee, a memory M72 for storing the rotation phase of the rotary screen cylinder at the position of squeegee retreat start (or squeegee retreat start position), a memory M54 for storing the throw-off position (count value of the counter) of the squeegee, a memory M55 for storing the desired count value of a counter for detecting the position of the left side of the squeegee, a memory M56 for storing the desired count value of a counter for detecting the position of the right side of the squeegee, a memory M57 for storing the rotation phase of the rotary screen cylinder at the position of the rear end of the notch of the impression cylinder, and a memory M58 for storing the rotation phase of the rotary screen cylinder during squeegee throw-off.

To the BUS (bus line), the following memories are further connected: A memory M59 for storing the count value S, a memory M60 for storing the rotating direction of the motor for adjusting the left side, a memory M61 for storing the rotating direction of the motor for adjusting the right side, a memory M62 for storing the count value of a counter for detecting the current position of the left side of the squeegee, a memory M63 for storing the count value of a counter for detecting the current position of the right side of the squeegee, a memory M64 for storing a table of conversion from the total number of revolutions during squeegee throw-on to the correction amount (count value of the counter) of the squeegee position, a memory M65 for storing the count value of a counter for counting the total number of revolutions during squeegee throw-on, a memory M66 for storing the correction amount (count value of the counter) of the squeegee position, a memory M67 for storing the retreat position (count value of the counter) of the squeegee, a memory M68 for storing the count value of a counter for detecting the rotation phase of the rotary screen cylinder, a memory M69 for storing the rotation phase of the rotary screen cylinder during squeegee throw-on, and a memory M70 for storing the printing position (count value of the counter) of the squeegee.

To the input/output device 44, the following are connected: A squeegee throw-on and throw-off automatic control switch 52, an input device 53 such as a keyboard, a display device 54 such as CRT or a display, and an output device 55 such as a printer or a floppy disk (registered trademark) drive.

To the input/output device 45, the following are connected: A setting instrument 56 for the type of the material to be printed, a setting instrument 57 for the thickness of the material to be printed, a setting instrument 58 for the material for the screen printing forme, a setting instrument 59 for the thickness of the screen printing forme, a setting instrument 60 for the mesh size of the screen printing forme, a setting instrument 61 for the viscosity of ink, a setting instrument 62 for the yield value of ink, a setting instrument 63 for the type of the pigment of ink, a setting instrument 64 for the material for the squeegee, a setting instrument 65 for the thickness of the squeegee, and a setting instrument 71 for the length in the transport direction of the material to be printed.

To the input/output device 46, the motor 36A for adjusting the left side is connected via a driver 66 for the motor for adjusting the left side, and a rotary encoder 69 for the motor for adjusting the left side which is drivingly connected to the motor 36A is connected via a counter 68 for detecting the current position of the left side of the squeegee.

To the input/output device 47, the motor 36B for adjusting the right side is connected via a driver 70 for the motor for adjusting the right side, and a rotary encoder 73 for the motor for adjusting the right side which is drivingly connected to the motor 36B is connected via a counter 72 for detecting the current position of the right side of the squeegee.

To the input/output device 48, a rotary encoder 75 for detecting the rotation phase of the rotary screen cylinder is connected via a counter 74 for detecting the rotation phase of the rotary screen cylinder. The rotary encoder 75 for detecting the rotation phase of the rotary screen cylinder is provided on a rotating part of the rotary screen printing press rotating in synchronism with the rotary screen cylinder in such a manner as to generate a zero pulse in the reference rotation phase of the rotary screen cylinder. Thus, the counter 74 for detecting the rotation phase of the rotary screen cylinder is reset in the reference rotation phase of the rotary screen cylinder each time the rotary screen cylinder makes one rotation. Then, the counter 74 for detecting the rotation phase of the rotary screen cylinder counts clock pulses generated in accordance with the rotation of the rotary screen cylinder, producing a count value conformed to the rotation phase of the rotary screen cylinder.

To the input/output device 49, a sensor 77 for detecting one rotation of the rotary screen cylinder is connected via a counter 76 for counting the total number of revolutions during squeegee throw-on. The sensor 77 for detecting one rotation of the rotary screen cylinder is provided on a rotating part of the rotary screen printing press so as to produce one pulse each time the rotary screen cylinder makes one rotation. Thus, the counter 76 for counting the total number of revolutions during squeegee throw-on is adapted to count the number of revolutions of the rotary screen cylinder in an operating state.

To the input/output device 50, a cylinder engagement circuit 78 for the rotary screen cylinder is connected.

To the interface 51, a picture pattern area rate measuring device 79 for measuring the picture pattern area rate of the picture pattern to be printed on the material W to be printed is connected. The picture pattern area rate measuring device 79 used is a publicly known one, for example, that which images the picture pattern surface of the screen printing forme 11c by a TV camera having solid photoelectric conversion elements arranged in a matrix form, and measures the picture pattern area rate.

The control actions or motions of the squeegee throw-on and throw-off control device 40A configured as above will be described in detail based on the motion flow charts of FIGS. 6(a) to 6(e), FIGS. 7(a) to 7(d), FIGS. 8(a) to 8(d), FIGS. 9(a) to 9(d), FIGS. 10(a) to 10(d), FIGS. 11(a) to 11(d), and FIGS. 12(a) to 12(d).

In Step P1, it is determined whether there is an input to the setting instrument 56 for the type of the material to be printed. If the answer is Y (yes), the type of the material W to be printed is loaded from the setting instrument 56 for the type of the material to be printed, and stored into the memory Ml, in Step P2, and the program proceeds to Step P3. If the answer is N (no), the program directly shifts to Step P3.

Then, in Step P3, it is determined whether there is an input to the setting instrument 57 for the thickness of the material to be printed. If the answer is Y, the thickness of the material to be printed is loaded from the setting instrument 57 for the thickness of the material to be printed, and stored into the memory M2, in Step P4. Then, the program proceeds to Step PS. If the answer is N, the program directly shifts to Step P5.

Then, in Step P5, it is determined whether there is an input to the setting instrument 58 for the material for the screen printing forme. If the answer is Y, the material for the screen printing forme 11c is loaded from the setting instrument 58 for the material for the screen printing forme, and stored into the memory M3, in Step P6. Then, the program proceeds to Step P7. If the answer is N, the program directly shifts to Step P7.

Then, in Step P7, it is determined whether there is an input to the setting instrument 59 for the thickness of the screen printing forme. If the answer is Y, the thickness of the screen printing forme is loaded from the setting instrument 59 for the thickness of the screen printing forme, and stored into the memory M4, in Step P8. Then, the program proceeds to Step P9. If the answer is N, the program directly shifts to Step P9.

Then, in Step P9, it is determined whether the picture pattern area rate has been transmitted from the picture pattern area rate measuring device 79. If the answer is Y, the picture pattern area rate is received from the picture pattern area rate measuring device 79, and stored into the memory M5, in Step P10. Then, the program proceeds to Step P11. If the answer is N, the program directly shifts to Step P11.

Then, in Step P11, it is determined whether there is an input to the setting instrument 60 for the mesh size of the screen printing forme. If the answer is Y, the mesh size of the screen printing forme 11c is loaded from the setting instrument 60 for the mesh size of the screen printing forme, and stored into the memory M6, in Step P12. Then, the program proceeds to Step P13. If the answer is N, the program directly shifts to Step P13.

Then, in Step P13, it is determined whether there is an input to the setting instrument 61 for the viscosity of ink. If the answer is Y, the viscosity of ink is loaded from the setting instrument 61 for the viscosity of ink, and stored into the memory M7, in Step P14. Then, the program proceeds to Step P15. If the answer is N, the program directly shifts to Step P15.

Then, in Step P15, it is determined whether there is an input to the setting instrument 62 for the yield value of ink. If the answer is Y, the yield value of ink is loaded from the setting instrument 62 for the yield value of ink, and stored into the memory M8, in Step P16. Then, the program proceeds to Step P17. If the answer is N, the program directly shifts to Step P17.

Then, in Step P17, it is determined whether there is an input to the setting instrument 63 for the type of the pigment of ink. If the answer is Y, the type of the pigment of ink is loaded from the setting instrument 63 for the type of the pigment of ink, and stored into the memory M9, in Step P18. Then, the program proceeds to Step P19. If the answer is N, the program directly shifts to Step P19.

Then, in Step P19, it is determined whether there is an input to the setting instrument 64 for the material for the squeegee. If the answer is Y, the material for the squeegee 38 is loaded from the setting instrument 64 for the material for the squeegee, and stored into the memory M10, in Step P20. Then, the program proceeds to Step P21. If the answer is N, the program directly shifts to Step P21.

Then, in Step P21, it is determined whether there is an input to the setting instrument 65 for the thickness of the squeegee. If the answer is Y, the thickness of the squeegee is loaded from the setting instrument 65 for the thickness of the squeegee, and stored into the memory M11, in Step P22. Then, the program proceeds to Step P23. If the answer is N, the program directly shifts to Step P23.

Then, in Step P23, it is determined whether there is an input to the setting instrument 71 for the length in the transport direction of the material to be printed. If the answer is Y, the length in the transport direction of the material to be printed is loaded from the setting instrument 71 for the length in the transport direction of the material to be printed, and stored into the memory M71, in Step P24. Then, the program proceeds to Step P25. If the answer is N, the program directly shifts to Step P25.

Then, in Step P25, it is determined whether the squeegee throw-on and throw-off automatic control switch 52 is ON. If the answer is Y, the table of conversion from the type of the material to be printed to the throw-on position (count value of the counter) of the squeegee is loaded from the memory M12 in Step P26. If the answer is N, the program returns to Step P1.

Then, in Step P27, the type of the material W to be printed is loaded from the memory M1. Then, in Step P28, the provisional reference throw-on position (count value of the counter) of the squeegee is obtained from the type of the material W to be printed, with the use of the table of conversion from the type of the material to be printed to the throw-on position (count value of the counter) of the squeegee, and is stored into the memory M13.

Then, in Step P29, the type of the material W to be printed is loaded from the memory M1. Then, in Step P30, the table of conversion from the thickness of the material to be printed to the throw-on position (count value of the counter) of the squeegee, which is commensurate with the type of the material to be printed, is loaded from the memory M14.

Then, in Step P31, the thickness of the material to be printed is loaded from the memory M2. Then, in Step P32, the first correction value (count value of the counter) of the throw-on position of the squeegee is obtained from the thickness of the material to be printed, with the use of the table of conversion from the thickness of the material to be printed to the throw-on position (count value of the counter) of the squeegee, which is commensurate with the type of the material to be printed, and this correction value is stored into the memory M15.

Then, in Step P33, the table of conversion from the material for the screen printing forme to the throw-on position (count value of the counter) of the squeegee is loaded from the memory M16. Then, in Step P34, the material for the screen printing forme 11c is loaded from the memory M3. Then, in Step P35, the second correction value (count value of the counter) of the throw-on position of the squeegee is obtained from the material for the screen printing forme 11c, with the use of the table of conversion from the material for the screen printing forme to the throw-on position (count value of the counter) of the squeegee, and this correction value is stored into the memory M17.

Then, in Step P36, the material for the screen printing forme 11c is loaded from the memory M3. Then, in Step P37, the table of conversion from the thickness of the screen printing forme to the throw-on position (count value of the counter) of the squeegee, which is commensurate with the material for the screen printing forme, is loaded from the memory M18.

Then, in Step P38, the thickness of the screen printing forme is loaded from the memory M4. Then, in Step P39, the third correction value (count value of the counter) of the throw-on position of the squeegee is obtained from the thickness of the screen printing forme, with the use of the table of conversion from the thickness of the screen printing forme to the throw-on position (count value of the counter) of the squeegee, which is commensurate with the material for the screen printing forme, and this correction value is stored into the memory M19.

Then, in Step P40, the material for the screen printing forme 11c is loaded from the memory M3. Then, in Step P41, the thickness of the screen printing forme is loaded from the memory M4. Then, in Step P42, the table of conversion from the picture pattern area rate to the throw-on position (count value of the counter) of the squeegee, which is commensurate with the material for the screen printing forme and the thickness of the screen printing forme, is loaded from the memory M20.

Then, in Step P43, the picture pattern area rate is loaded from the memory MS. Then, in Step P44, the fourth correction value (count value of the counter) of the throw-on position of the squeegee is obtained from the picture pattern area rate, with the use of the table of conversion from the picture pattern area rate to the throw-on position (count value of the counter) of the squeegee, which is commensurate with the material for the screen printing forme and the thickness of the screen printing forme, and this correction value is stored into the memory M21.

Then, in Step P45, the material for the screen printing forme 11c is loaded from the memory M3. Then, in Step P46, the thickness of the screen printing forme is loaded from the memory M4. Then, in Step P47, the table of conversion from the mesh size of the screen printing forme to the throw-on position (count value of the counter) of the squeegee, which is commensurate with the material for the screen printing forme and the thickness of the screen printing forme, is loaded from the memory M22.

Then, in Step P48, the mesh size of the screen printing forme is loaded from the memory M6. Then, in Step P49, the fifth correction value (count value of the counter) of the throw-on position of the squeegee is obtained from the mesh size of the screen printing forme, with the use of the table of conversion from the mesh size of the screen printing forme to the throw-on position (count value of the counter) of the squeegee, which is commensurate with the material for the screen printing forme and the thickness of the screen printing forme, and this correction value is stored into the memory M23.

Then, in Step P50, the table of conversion from the viscosity of ink to the throw-on position (count value of the counter) of the squeegee is loaded from the memory M24. Then, in Step P51, the viscosity of ink is loaded from the memory M7. Then, in Step P52, the sixth correction value (count value of the counter) of the throw-on position of the squeegee is obtained from the viscosity of ink with the use of the table of conversion from the viscosity of ink to the throw-on position (count value of the counter) of the squeegee, and this correction value is stored into the memory M25.

Then, in Step P53, the table of conversion from the yield value of ink to the throw-on position (count value of the counter) of the squeegee is loaded from the memory M26. Then, in Step P54, the yield value of ink is loaded from the memory M8. Then, in Step P55, the seventh correction value (count value of the counter) of the throw-on position of the squeegee is obtained from the yield value of ink with the use of the table of conversion from the yield value of ink to the throw-on position (count value of the counter) of the squeegee, and this correction value is stored into the memory M27.

Then, in Step P56, the table of conversion from the type of the pigment of ink to the throw-on position (count value of the counter) of the squeegee is loaded from the memory M28. Then, in Step P57, the type of the pigment of ink is loaded from the memory M9. Then, in Step P58, the eighth correction value (count value of the counter) of the throw-on position of the squeegee is obtained from the type of the pigment of ink with the use of the table of conversion from the type of the pigment of ink to the throw-on position (count value of the counter) of the squeegee, and this correction value is stored into the memory M29.

Then, in Step P59, the table of conversion from the material for the squeegee to the throw-on position (count value of the counter) of the squeegee is loaded from the memory M30. Then, in Step P60, the material for the squeegee 38 is loaded from the memory M10. Then, in Step P61, the ninth correction value (count value of the counter) of the throw-on position of the squeegee is obtained from the material for the squeegee 38 with the use of the table of conversion from the material for the squeegee to the throw-on position (count value of the counter) of the squeegee, and this correction value is stored into the memory M31.

Then, in Step P62, the material for the squeegee 38 is loaded from the memory M10. Then, in Step P63, the table of conversion from the thickness of the squeegee to the throw-on position (count value of the counter) of the squeegee, which is commensurate with the material for the squeegee, is loaded from the memory M32.

Then, in Step P64, the thickness of the squeegee is loaded from the memory M11. Then, in Step P65, the tenth correction value (count value of the counter) of the throw-on position of the squeegee is obtained from the thickness of the squeegee with the use of the table of conversion from the thickness of the squeegee to the throw-on position (count value of the counter) of the squeegee, which is commensurate with the material for the squeegee, and this correction value is stored into the memory M33.

Then, in Step P66, the provisional reference throw-on position (count value of the counter) of the squeegee is loaded from the memory M13, whereafter, in Step P67, the first correction value (count value of the counter) of the throw-on position of the squeegee is loaded from the memory M15. Then, in Step P68, the second correction value (count value of the counter) of the throw-on position of the squeegee is loaded from the memory M17.

Then, in Step P69, the third correction value (count value of the counter) of the throw-on position of the squeegee is loaded from the memory M19, whereafter, in Step P70, the fourth correction value (count value of the counter) of the throw-on position of the squeegee is loaded from the memory M21. Then, in Step P71, the fifth correction value (count value of the counter) of the throw-on position of the squeegee is loaded from the memory M23.

Then, in Step P72, the sixth correction value (count value of the counter) of the throw-on position of the squeegee is loaded from the memory M25, whereafter, in Step P73, the seventh correction value (count value of the counter) of the throw-on position of the squeegee is loaded from the memory M27. Then, in Step P74, the eighth correction value (count value of the counter) of the throw-on position of the squeegee is loaded from the memory M29.

Then, in Step P75, the ninth correction value (count value of the counter) of the throw-on position of the squeegee is loaded from the memory M31, whereafter, in Step P76, the tenth correction value (count value of the counter) of the throw-on position of the squeegee is loaded from the memory M33.

Then, in Step P77, the first correction value (count value of the counter) of the throw-on position of the squeegee, the second correction value (count value of the counter) of the throw-on position of the squeegee, the third correction value (count value of the counter) of the throw-on position of the squeegee, the fourth correction value (count value of the counter) of the throw-on position of the squeegee, the fifth correction value (count value of the counter) of the throw-on position of the squeegee, the sixth correction value (count value of the counter) of the throw-on position of the squeegee, the seventh correction value (count value of the counter) of the throw-on position of the squeegee, the eighth correction value (count value of the counter) of the throw-on position of the squeegee, the ninth correction value (count value of the counter) of the throw-on position of the squeegee, and the tenth correction value (count value of the counter) of the throw-on position of the squeegee are added to the provisional reference throw-on position (count value of the counter) of the squeegee to compute the reference throw-on position (count value of the counter) of the squeegee, and this reference throw-on position (count value of the counter) of the squeegee is stored into the memory M34.

In accordance with the above-described motion flow, the throw-on position of the squeegee 38 during printing is preset, based on the type of the material W to be printed, in conformity with the thickness of the material to be printed, the material for the screen printing forme 11c, the thickness of the screen printing forme, the picture pattern area rate, the mesh size of the screen printing forme 11c, the viscosity of ink, the yield value of ink, the type of the pigment of ink, the material for the squeegee, and the thickness of the squeegee.

Then, in Step P78, the table of conversion from the material for the screen printing forme to the retreat position (count value of the counter) of the squeegee is loaded from the memory M35. Then, in Step P79, the material for the screen printing forme 11c is loaded from the memory M3. Then, in Step P80, the provisional reference retreat position (count value of the counter) of the squeegee is obtained from the material for the screen printing forme 11c with the use of the table of conversion from the material for the screen printing forme to the retreat position (count value of the counter) of the squeegee, and is stored into the memory M36.

Then, in Step P81, the material for the screen printing forme 11c is loaded from the memory M3. Then, in Step P82, the table of conversion from the thickness of the screen printing forme to the retreat position (count value of the counter) of the squeegee, which is commensurate with the material for the screen printing forme, is loaded from the memory M37.

Then, in Step P83, the thickness of the screen printing forme is loaded from the memory M4. Then, in Step P84, the first correction value (count value of the counter) of the retreat position of the squeegee is obtained from the thickness of the screen printing forme with the use of the table of conversion from the thickness of the screen printing forme to the retreat position (count value of the counter) of the squeegee, which is commensurate with the material for the screen printing forme, and this correction value is stored into the memory M38.

Then, in Step P85, the material for the screen printing forme 11c is loaded from the memory M3, whereafter, in Step P86, the thickness of the screen printing forme is loaded from the memory M4. Then, in Step P87, the table of conversion from the picture pattern area rate to the retreat position (count value of the counter) of the squeegee, which is commensurate with the material for the screen printing forme and the thickness of the screen printing forme, is loaded from the memory M39.

Then, in Step P88, the picture pattern area rate is loaded from the memory M5. Then, in Step P89, the second correction value (count value of the counter) of the retreat position of the squeegee is obtained from the picture pattern area rate with the use of the table of conversion from the picture pattern area rate to the retreat position (count value of the counter) of the squeegee, which is commensurate with the material for the screen printing forme and the thickness of the screen printing forme, and this correction value is stored into the memory M40.

Then, in Step P90, the material for the screen printing forme is loaded from the memory M3. Then, in Step P91, the thickness of the screen printing forme is loaded from the memory M4. Then, in Step P92, the table of conversion from the mesh size of the screen printing forme to the retreat position (count value of the counter) of the squeegee, which is commensurate with the material for the screen printing forme and the thickness of the screen printing forme, is loaded from the memory M41.

Then, in Step P93, the mesh size of the screen printing forme 11c is loaded from the memory M6. Then, in Step P94, the third correction value (count value of the counter) of the retreat position of the squeegee is obtained from the mesh size of the screen printing forme 11c with the use of the table of conversion from the mesh size of the screen printing forme to the retreat position (count value of the counter) of the squeegee, which is commensurate with the material for the screen printing forme and the thickness of the screen printing forme, and this correction value is stored into the memory M42.

Then, in Step P95, the table of conversion from the viscosity of ink to the retreat position (count value of the counter) of the squeegee is loaded from the memory M43. Then, in Step P96, the viscosity of ink is loaded from the memory M7. Then, in Step P97, the fourth correction value (count value of the counter) of the retreat position of the squeegee is obtained from the viscosity of ink with the use of the table of conversion from the viscosity of ink to the retreat position (count value of the counter) of the squeegee, and this correction value is stored into the memory M44.

Then, in Step P98, the table of conversion from the yield value of ink to the retreat position (count value of the counter) of the squeegee is loaded from the memory M45. Then, in Step P99, the yield value of ink is loaded from the memory M8. Then, in Step P100, the fifth correction value (count value of the counter) of the retreat position of the squeegee is obtained from the yield value of ink with the use of the table of conversion from the yield value of ink to the retreat position (count value of the counter) of the squeegee, and this correction value is stored into the memory M46.

Then, in Step P101, the table of conversion from the type of the pigment of ink to the retreat position (count value of the counter) of the squeegee is loaded from the memory M47. Then, in Step P102, the type of the pigment of ink is loaded from the memory M9. Then, in Step P103, the sixth correction value (count value of the counter) of the retreat position of the squeegee is obtained from the type of the pigment of ink with the use of the table of conversion from the type of the pigment of ink to the retreat position (count value of the counter) of the squeegee, and this correction value is stored into the memory M48.

Then, in Step P104, the table of conversion from the material for the squeegee to the retreat position (count value of the counter) of the squeegee is loaded from the memory M49. Then, in Step P105, the material for the squeegee is loaded from the memory M10. Then, in Step P106, the seventh correction value (count value of the counter) of the retreat position of the squeegee is obtained from the material for the squeegee with the use of the table of conversion from the material for the squeegee to the retreat position (count value of the counter) of the squeegee, and this correction value is stored into the memory M50.

Then, in Step P107, the material for the squeegee is loaded from the memory M10. Then, in Step P108, the table of conversion from the thickness of the squeegee to the retreat position (count value of the counter) of the squeegee, which is commensurate with the material for the squeegee, is loaded from the memory M51.

Then, in Step P109, the thickness of the squeegee is loaded from the memory M11. Then, in Step P110, the eighth correction value (count value of the counter) of the retreat position of the squeegee is obtained from the thickness of the squeegee with the use of the table of conversion from the thickness of the squeegee to the retreat position (count value of the counter) of the squeegee, which is commensurate with the material for the squeegee, and this correction value is stored into the memory M52.

Then, in Step P111, the provisional reference retreat position (count value of the counter) of the squeegee is loaded from the memory M36, whereafter, in Step P112, the first correction value (count value of the counter) of the retreat position of the squeegee is loaded from the memory M38. Then, in Step P113, the second correction value (count value of the counter) of the retreat position of the squeegee is loaded from the memory M40.

Then, in Step P114, the third correction value (count value of the counter) of the retreat position of the squeegee is loaded from the memory M42, whereafter, in Step P115, the fourth correction value (count value of the counter) of the retreat position of the squeegee is loaded from the memory M44. Then, in Step P116, the fifth correction value (count value of the counter) of the retreat position of the squeegee is loaded from the memory M46.

Then, in Step P117, the sixth correction value (count value of the counter) of the retreat position of the squeegee is loaded from the memory M48, whereafter, in Step P118, the seventh correction value (count value of the counter) of the retreat position of the squeegee is loaded from the memory M50. Then, in Step P119, the eighth correction value (count value of the counter) of the retreat position of the squeegee is loaded from the memory M52.

Then, in Step P120, the first correction value (count value of the counter) of the retreat position of the squeegee, the second correction value (count value of the counter) of the retreat position of the squeegee, the third correction value (count value of the counter) of the retreat position of the squeegee, the fourth correction value (count value of the counter) of the retreat position of the squeegee, the fifth correction value (count value of the counter) of the retreat position of the squeegee, the sixth correction value (count value of the counter) of the retreat position of the squeegee, the seventh correction value (count value of the counter) of the retreat position of the squeegee, and the eighth correction value (count value of the counter) of the retreat position of the squeegee are added to the provisional reference retreat position (count value of the counter) of the squeegee to compute the reference retreat position (count value of the counter) of the squeegee, and this reference retreat position (count value of the counter) of the squeegee is stored into the memory M53. The reference retreat position (count value of the counter) of the squeegee obtained is a position closer to the throw-off position of the squeegee than to the reference throw-on position of the squeegee obtained in Step P77, in other words, a position at which the leading end of the squeegee 38 does not leave the inner peripheral surface of the screen printing forme 11c, and its pressing force decreases.

Then, in Step P121, the length in the transport direction of the material to be printed is loaded from the memory M71. Then, in Step P122, the rotation phase of the rotary screen cylinder at the squeegee retreat start position is computed from the length in the transport direction of the material to be printed, and is stored into the memory M72. The obtained rotation phase of the rotary screen cylinder at the squeegee retreat start position is the rotation phase of the rotary screen cylinder at a time when the squeegee opposes a position between the rear end in the transport direction of the material to be printed and the rear end of the printing region where the picture pattern is printed, in other words, a position slightly spaced from the rear end in the transport direction of the material to be printed toward the front end in the transport direction of the material to be printed.

In accordance with the above-described motion flow, the retreat position of the squeegee 38 when opposing the notch 13b of the impression cylinder 13 is preset, based on the material for the screen printing forme 11c, in conformity with the thickness of the screen printing forme, the picture pattern area rate, the mesh size of the screen printing forme 11c, the viscosity of ink, the yield value of ink, the type of the pigment of ink, the material for the squeegee, and the thickness of the squeegee.

Then, in Step P123, it is determined whether the squeegee throw-on and throw-off automatic control switch 52 is OFF. If the answer is Y (yes), the program shifts to Step P355 to be described later. If the answer is N (no), it is determined, in Step P124, whether a cylinder engagement signal from the cylinder engagement circuit 78 for the rotary screen cylinder is ON.

If the answer is Y in the above Step P124, the program shifts to Step P179 to be described later. If the answer is N, the throw-off position (count value of the counter) of the squeegee is loaded from the memory M54 in Step P125.

Then, in Step P126, the memory M55 for storing the desired count value of the counter for detecting the position of the left side of the squeegee is overwritten with the throw-off position (count value of the counter) of the squeegee. Then, in Step P127, the memory M56 for storing the desired count value of the counter for detecting the position of the right side of the squeegee is overwritten with the throw-off position (count value of the counter) of the squeegee.

Then, in Step P128, the count value is loaded from the counter 74 for detecting the rotation phase of the rotary screen cylinder, and stored into the memory M68. Then, in Step P129, the rotation phase of the rotary screen cylinder during squeegee throw-off is loaded from the memory M58.

Then, in Step P130, it is determined whether the count value of the counter for detecting the rotation phase of the rotary screen cylinder is equal to the rotation phase of the rotary screen cylinder during squeegee throw-off. If the answer is N, the program returns to Step P128 mentioned above. If the answer is Y, the count value S of the memory M59 is overwritten with 0 in Step P131.

Then, in Step P132, the memory M60 for storing the rotating direction of the motor for adjusting the left side is overwritten with 0. Then, in Step P133, the memory M61 for storing the rotating direction of the motor for adjusting the right side is overwritten with 0.

Then, in Step P134, the count value is loaded from the counter 68 for detecting the current position of the left side of the squeegee, and stored into the memory M62. Then, in Step P135, the desired count value of the counter for detecting the position of the left side of the squeegee is loaded from the memory M55.

Then, in Step P136, it is determined whether the count value of the counter for detecting the current position of the left side of the squeegee is equal to the desired count value of the counter for detecting the position of the left side of the squeegee. If the answer is N, it is determined, in Step P137, whether the count value of the counter for detecting the current position of the left side of the squeegee is less than the desired count value of the counter for detecting the position of the left side of the squeegee.

If the answer is Y in the above Step P137, the memory M60 for storing the rotating direction of the motor for adjusting the left side is overwritten with 1 in Step P138. Then, in Step P139, a normal rotation command is outputted to the driver 66 for the motor for adjusting the left side, whereafter the program proceeds to Step P140. If the answer is N in Step P137, the memory M60 for storing the rotating direction of the motor for adjusting the left side is overwritten with 2 in Step P141. Then, in Step P142, a reverse rotation command is outputted to the driver 66 for the motor for adjusting the left side, whereafter the program shifts to Step P140.

If the answer is Y in the aforementioned Step P136, the count value S is loaded from the memory M59 in Step P143. Then, in Step P144, 1 is added to the count value S of the memory M59 for overwriting, whereafter the program shifts to Step P140 mentioned above.

Then, in the aforementioned Step P140, the count value is loaded from the counter 72 for detecting the current position of the right side of the squeegee, and stored into the memory M63. Then, in Step P145, the desired count value of the counter for detecting the position of the right side of the squeegee is loaded from the memory M56.

Then, in Step P146, it is determined whether the count value of the counter for detecting the current position of the right side of the squeegee is equal to the desired count value of the counter for detecting the position of the right side of the squeegee. If the answer is N, it is determined, in Step P147, whether the count value of the counter for detecting the current position of the right side of the squeegee is less than the desired count value of the counter for detecting the position of the right side of the squeegee.

If the answer is Y in the above Step P147, the memory M61 for storing the rotating direction of the motor for adjusting the right side is overwritten with 1 in Step P148. Then, in Step P149, a normal rotation command is outputted to the driver 70 for the motor for adjusting the right side, whereafter the program proceeds to Step P150. If the answer is N in Step P147, the memory M61 for storing the rotating direction of the motor for adjusting the right side is overwritten with 2 in Step P151. Then, in Step P152, a reverse rotation command is outputted to the driver 70 for the motor for adjusting the right side, whereafter the program shifts to Step P150.

If the answer is Y in the aforementioned Step P146, the count value S is loaded from the memory M59 in Step P153. Then, in Step P154, 1 is added to the count value S of the memory M59 for overwriting, whereafter the program shifts to Step P150 mentioned above.

Then, in Step P150 mentioned above, the count value S is loaded from the memory M59, whereafter it is determined in Step P155 whether the count value S is 2. If the answer is Y, outputting of the enabling signal to the counter 76 for counting the total number of revolutions during squeegee throw-on is stopped in Step P156, and the program returns to Step P123 mentioned earlier.

Then, in Step P157, the count value is loaded from the counter 68 for detecting the current position of the left side of the squeegee, and stored into the memory M62. Then, in Step P158, the desired count value of the counter for detecting the position of the left side of the squeegee is loaded from the memory M55.

Then, in Step P159, it is determined whether the count value of the counter for detecting the current position of the left side of the squeegee is equal to the desired count value of the counter for detecting the position of the left side of the squeegee. If the answer is Y, the value of the memory M60 for storing the rotating direction of the motor for adjusting the left side is loaded in Step P160. If the answer is N, the program shifts to Step P168 to be described later.

Then, in Step P161, it is determined whether the value of the memory for storing the rotating direction of the motor for adjusting the left side is 1. If the answer is Y, outputting of the normal rotation command to the driver 66 for the motor for adjusting the left side is stopped in Step P162, and the program proceeds to Step P163. If the answer is N, it is determined in Step P164 whether the value of the memory for storing the rotating direction of the motor for adjusting the left side is 2.

If the answer is Y in the above Step P164, outputting of the reverse rotation command to the driver 66 for the motor for adjusting the left side is stopped in Step P165, and the program shifts to the aforementioned Step P163. If the answer is N, the program shifts to the aforementioned Step P168.

Then, in the above-mentioned Step P163, the memory M60 for storing the rotating direction of the motor for adjusting the left side is overwritten with 0. Then, in Step P166, the count value S is loaded from the memory M59, whereafter 1 is added to the count value S of the memory M59 for overwriting in Step P167.

Then, in Step P168, the count value is loaded from the counter 72 for detecting the current position of the right side of the squeegee, and stored into the memory M63. Then, in Step P169, the desired count value of the counter for detecting the position of the right side of the squeegee is loaded from the memory M56.

Then, in Step P170, it is determined whether the count value of the counter for detecting the current position of the right side of the squeegee is equal to the desired count value of the counter for detecting the position of the right side of the squeegee. If the answer is Y, the value of the memory M61 for storing the rotating direction of the motor for adjusting the right side is loaded in Step P171. If the answer is N, the program returns to Step P150.

Then, in Step P172, it is determined whether the value of the memory for storing the rotating direction of the motor for adjusting the right side is 1. If the answer is Y, outputting of the normal rotation command to the driver 70 for the motor for adjusting the right side is stopped in Step P173, and the program proceeds to Step P174. If the answer is N, it is determined in Step P175 whether the value of the memory for storing the rotating direction of the motor for adjusting the right side is 2.

If the answer is Y in the above Step P175, outputting of the reverse rotation command to the driver 70 for the motor for adjusting the right side is stopped in Step P176, and the program shifts to the aforementioned Step P174. If the answer is N, the program returns to Step P150.

Then, in the aforementioned Step P174, the memory M61 for storing the rotating direction of the motor for adjusting the right side is overwritten with 0. Then, in Step P177, the count value S is loaded from the memory M59, whereafter 1 is added to the count value S of the memory M59 for overwriting in Step P178. Then, the program returns to Step P150.

In accordance with the above-described motion flow, when the squeegee throw-on and throw-off automatic control switch 52 is ON and the cylinder engagement signal for the rotary screen cylinder 11 is OFF, the squeegee 38 is moved to the throw-off position.

Then, in Step P179 shifted from the aforementioned Step P124, the table of conversion from the total number of revolutions during squeegee throw-on to the correction amount (count value of the counter) of the squeegee position is loaded from the memory M64. Then, in Step P180, the count value is loaded from the counter 76 for counting the total number of revolutions during squeegee throw-on, and stored into the memory M65.

Then, in Step P181, the correction amount (count value of the counter) of the squeegee position is obtained from the count value of the counter 76 for counting the total number of revolutions during squeegee throw-on, with the use of the table of conversion from the total number of revolutions during squeegee throw-on to the correction amount (count value of the counter) of the squeegee position, and this correction amount is stored into the memory M66. Then, in Step P182, the reference retreat position (count value of the counter) of the squeegee is loaded from the memory M53.

Then, in Step P183, the correction amount (count value of the counter) of the squeegee position is loaded from the memory M66. Then, in Step P184, the correction amount (count value of the counter) of the squeegee position is added to the reference retreat position (count value of the counter) of the squeegee to compute the retreat position (count value of the counter) of the squeegee, which is stored into the memory M67.

Then, in Step P185, the memory M55 for storing the desired count value of the counter for detecting the position of the left side of the squeegee is overwritten with the retreat position (count value of the counter) of the squeegee. Then, in Step P186, the memory M56 for storing the desired count value of the counter for detecting the position of the right side of the squeegee is overwritten with the retreat position (count value of the counter) of the squeegee.

Then, in Step P187, the count value is loaded from the counter 74 for detecting the rotation phase of the rotary screen cylinder, and stored into the memory M68. Then, in Step P188, the rotation phase of the rotary screen cylinder during squeegee throw-on is loaded from the memory M69.

Then, in Step P189, it is determined whether the count value of the counter for detecting the rotation phase of the rotary screen cylinder is equal to the rotation phase of the rotary screen cylinder during squeegee throw-on. If the answer is N, the program returns to Step P187 mentioned above. If the answer is Y, the count value S of the memory M59 is overwritten with 0 in Step P190. Then, in Step P191, the memory M60 for storing the rotating direction of the motor for adjusting the left side is overwritten with 0. Then, in Step P192, the memory M61 for storing the rotating direction of the motor for adjusting the right side is overwritten with 0.

Then, in Step P193, the count value is loaded from the counter 68 for detecting the current position of the left side of the squeegee, and stored into the memory M62. Then, in Step P194, the desired count value of the counter for detecting the position of the left side of the squeegee is loaded from the memory M55.

Then, in Step P195, it is determined whether the count value of the counter for detecting the current position of the left side of the squeegee is equal to the desired count value of the counter for detecting the position of the left side of the squeegee. If the answer is N, it is determined, in Step P196, whether the count value of the counter for detecting the current position of the left side of the squeegee is less than the desired count value of the counter for detecting the position of the left side of the squeegee.

If the answer is Y in the above Step P196, the memory M60 for storing the rotating direction of the motor for adjusting the left side is overwritten with 1 in Step P197. Then, in Step P198, a normal rotation command is outputted to the driver 66 for the motor for adjusting the left side, whereafter the program proceeds to Step P199. If the answer is N in Step P196, the memory M60 for storing the rotating direction of the motor for adjusting the left side is overwritten with 2 in Step P200. Then, in Step P201, a reverse rotation command is outputted to the driver 66 for the motor for adjusting the left side, whereafter the program shifts to the aforementioned Step P199.

If the answer is Y in Step P195, the count value S is loaded from the memory M59 in Step P202. Then, in Step P203, 1 is added to the count value S of the memory M59 for overwriting, whereafter the program shifts to Step P199 mentioned above.

Then, in the aforementioned Step P199, the count value is loaded from the counter 72 for detecting the current position of the right side of the squeegee, and stored into the memory M63. Then, in Step P204, the desired count value of the counter for detecting the position of the right side of the squeegee is loaded from the memory M56.

Then, in Step P205, it is determined whether the count value of the counter for detecting the current position of the right side of the squeegee is equal to the desired count value of the counter for detecting the position of the right side of the squeegee. If the answer is N, it is determined, in Step P206, whether the count value of the counter for detecting the current position of the right side of the squeegee is less than the desired count value of the counter for detecting the position of the right side of the squeegee.

If the answer is Y in the above Step P206, the memory M61 for storing the rotating direction of the motor for adjusting the right side is overwritten with 1 in Step P207. Then, in Step P208, a normal rotation command is outputted to the driver 70 for the motor for adjusting the right side, whereafter the program proceeds to Step P209. If the answer is N in Step P206, the memory M61 for storing the rotating direction of the motor for adjusting the right side is overwritten with 2 in Step P210. Then, in Step P211, a reverse rotation command is outputted to the driver 70 for the motor for adjusting the right side, whereafter the program shifts to Step P209.

If the answer is Y in the aforementioned Step P205, the count value S is loaded from the memory M59 in Step P212. Then, in Step P213, 1 is added to the count value S of the memory M59 for overwriting, whereafter the program shifts to Step P209 mentioned above.

Then, in Step P209 mentioned above, the count value S is loaded from the memory M59, whereafter it is determined in Step P214 whether the count value S is 2. If the answer is Y, an enabling signal is outputted in Step P215 to the counter 76 for counting the total number of revolutions during squeegee throw-on, and the program shifts to Step P238 to be described later.

If the answer is N in the above-mentioned Step P214, the count value is loaded from the counter 68 for detecting the current position of the left side of the squeegee, and stored into the memory M62, in Step P216. Then, in Step P217, the desired count value of the counter for detecting the position of the left side of the squeegee is loaded from the memory M55.

Then, in Step P218, it is determined whether the count value of the counter for detecting the current position of the left side of the squeegee is equal to the desired count value of the counter for detecting the position of the left side of the squeegee. If the answer is Y, the value of the memory M60 for storing the rotating direction of the motor for adjusting the left side is loaded in Step P219. If the answer is N, the program shifts to Step P227 to be described later.

Then, in Step P220, it is determined whether the value of the memory for storing the rotating direction of the motor for adjusting the left side is 1. If the answer is Y, outputting of the normal rotation command to the driver 66 for the motor for adjusting the left side is stopped in Step P221, and the program proceeds to Step P222. If the answer is N, it is determined in Step P223 whether the value of the memory for storing the rotating direction of the motor for adjusting the left side is 2.

If the answer is Y in the above Step P223, outputting of the reverse rotation command to the driver 66 for the motor for adjusting the left side is stopped in Step P224, and the program shifts to the aforementioned Step P222. If the answer is N, the program shifts to the aforementioned Step P227.

Then, in the above-mentioned Step P222, the memory M60 for storing the rotating direction of the motor for adjusting the left side is overwritten with 0. Then, in Step P225, the count value S is loaded from the memory M59, whereafter 1 is added to the count value S of the memory M59 for overwriting in Step P226.

Then, in Step P227, the count value is loaded from the counter 72 for detecting the current position of the right side of the squeegee, and stored into the memory M63. Then, in Step P228, the desired count value of the counter for detecting the position of the right side of the squeegee is loaded from the memory M56.

Then, in Step P229, it is determined whether the count value of the counter for detecting the current position of the right side of the squeegee is equal to the desired count value of the counter for detecting the position of the right side of the squeegee. If the answer is Y, the value of the memory M61 for storing the rotating direction of the motor for adjusting the right side is loaded in Step P230. If the answer is N, the program returns to Step P209.

Then, in Step P231, it is determined whether the value of the memory for storing the rotating direction of the motor for adjusting the right side is 1. If the answer is Y, outputting of the normal rotation command to the driver 70 for the motor for adjusting the right side is stopped in Step P232, and the program proceeds to Step P233. If the answer is N, it is determined in Step P234 whether the value of the memory for storing the rotating direction of the motor for adjusting the right side is 2.

If the answer is Y in the above Step P234, outputting of the reverse rotation command to the driver 70 for the motor for adjusting the right side is stopped in Step P235, and the program shifts to the aforementioned Step P233. If the answer is N, the program returns to Step P209.

Then, in the aforementioned Step P233, the memory M61 for storing the rotating direction of the motor for adjusting the right side is overwritten with 0. Then, in Step P236, the count value S is loaded from the memory M59, whereafter 1 is added to the count value S of the memory M59 for overwriting in Step P237. Then, the program returns to Step P209.

In accordance with the above-described motion flow, when the squeegee throw-on and throw-off automatic control switch 52 is ON and the cylinder engagement signal for the rotary screen cylinder 11 is ON, the squeegee 38 is moved to the predetermined retreat position when it opposes the notch 13b of the impression cylinder 13.

Then, in Step P238 shifted from the aforementioned Step P215, the table of conversion from the total number of revolutions during squeegee throw-on to the correction amount (count value of the counter) of the squeegee position is loaded from the memory M64. Then, in Step P239, the count value is loaded from the counter 76 for counting the total number of revolutions during squeegee throw-on, and stored into the memory M65.

Then, in Step P240, the correction amount (count value of the counter) of the squeegee position is obtained from the count value of the counter 76 for counting the total number of revolutions during squeegee throw-on, with the use of the table of conversion from the total number of revolutions during squeegee throw-on to the correction amount (count value of the counter) of the squeegee position, and this correction amount is stored into the memory M66. Then, in Step P241, the reference throw-on position (count value of the counter) of the squeegee is loaded from the memory M34.

Then, in Step P242, the correction amount (count value of the counter) of the squeegee position is loaded from the memory M66. Then, in Step P243, the correction amount (count value of the counter) of the squeegee position is added to the reference throw-on position (count value of the counter) of the squeegee to compute the printing position (count value of the counter) of the squeegee, which is stored into the memory M70.

Then, in Step P244, the memory M55 for storing the desired count value of the counter for detecting the position of the left side of the squeegee is overwritten with the printing position (count value of the counter) of the squeegee. Then, in Step P245, the memory M56 for storing the desired count value of the counter for detecting the position of the right side of the squeegee is overwritten with the printing position (count value of the counter) of the squeegee.

Then, in Step P246, the count value is loaded from the counter 74 for detecting the rotation phase of the rotary screen cylinder, and stored into the memory M68. Then, in Step P247, the rotation phase of the rotary screen cylinder at the position of the rear end of the notch of the impression cylinder is loaded from the memory M57.

Then, in Step P248, it is determined whether the count value of the counter for detecting the rotation phase of the rotary screen cylinder is equal to the rotation phase of the rotary screen cylinder at the position of the rear end of the notch of the impression cylinder. If the answer is N, the program returns to Step P246 mentioned above. If the answer is Y, the count value S of the memory M59 is overwritten with 0 in Step P249. Then, in Step P250, the memory M60 for storing the rotating direction of the motor for adjusting the left side is overwritten with 0. Then, in Step P251, the memory M61 for storing the rotating direction of the motor for adjusting the right side is overwritten with 0.

Then, in Step P252, the count value is loaded from the counter 68 for detecting the current position of the left side of the squeegee, and stored into the memory M62. Then, in Step P253, the desired count value of the counter for detecting the position of the left side of the squeegee is loaded from the memory M55.

Then, in Step P254, it is determined whether the count value of the counter for detecting the current position of the left side of the squeegee is equal to the desired count value of the counter for detecting the position of the left side of the squeegee. If the answer is N, it is determined, in Step P255, whether the count value of the counter for detecting the current position of the left side of the squeegee is less than the desired count value of the counter for detecting the position of the left side of the squeegee.

If the answer is Y in the above Step P255, the memory M60 for storing the rotating direction of the motor for adjusting the left side is overwritten with 1 in Step P256. Then, in Step P257, a normal rotation command is outputted to the driver 66 for the motor for adjusting the left side, whereafter the program proceeds to Step P258. If the answer is N in Step P255, the memory M60 for storing the rotating direction of the motor for adjusting the left side is overwritten with 2 in Step P259. Then, in Step P260, a reverse rotation command is outputted to the driver 66 for the motor for adjusting the left side, whereafter the program shifts to the aforementioned Step P258.

If the answer is Y in the aforementioned Step P254, the count value S is loaded from the memory M59 in Step P261. Then, in Step P262, 1 is added to the count value S of the memory M59 for overwriting, whereafter the program shifts to Step P258 mentioned above.

Then, in the aforementioned Step P258, the count value is loaded from the counter 72 for detecting the current position of the right side of the squeegee, and stored into the memory M63. Then, in Step P263, the desired count value of the counter for detecting the position of the right side of the squeegee is loaded from the memory M56.

Then, in Step P264, it is determined whether the count value of the counter for detecting the current position of the right side of the squeegee is equal to the desired count value of the counter for detecting the position of the right side of the squeegee. If the answer is N, it is determined, in Step P265, whether the count value of the counter for detecting the current position of the right side of the squeegee is less than the desired count value of the counter for detecting the position of the right side of the squeegee.

If the answer is Y in the above Step P265, the memory M61 for storing the rotating direction of the motor for adjusting the right side is overwritten with 1 in Step P266. Then, in Step P267, a normal rotation command is outputted to the driver 70 for the motor for adjusting the right side, whereafter the program proceeds to Step P268. If the answer is N in Step P265, the memory M61 for storing the rotating direction of the motor for adjusting the right side is overwritten with 2 in Step P269. Then, in Step P270, a reverse rotation command is outputted to the driver 70 for the motor for adjusting the right side, whereafter the program shifts to Step P268.

If the answer is Y in the aforementioned Step P264, the count value S is loaded from the memory M59 in Step P271. Then, in Step P272, 1 is added to the count value S of the memory M59 for overwriting, whereafter the program shifts to Step P268 mentioned above.

Then, in Step P268 mentioned above, the count value S is loaded from the memory M59, whereafter it is determined in Step P273 whether the count value S is 2. If the answer is Y, the program shifts to Step P296 to be described later.

If the answer is N in the above-mentioned Step P273, the count value is loaded from the counter 68 for detecting the current position of the left side of the squeegee, and stored into the memory M62, in Step P274. Then, in Step P275, the desired count value of the counter for detecting the position of the left side of the squeegee is loaded from the memory M55.

Then, in Step P276, it is determined whether the count value of the counter for detecting the current position of the left side of the squeegee is equal to the desired count value of the counter for detecting the position of the left side of the squeegee. If the answer is Y, the value of the memory M60 for storing the rotating direction of the motor for adjusting the left side is loaded in Step P277. If the answer is N, the program shifts to Step P285 to be described later.

Then, in Step P278, it is determined whether the value of the memory for storing the rotating direction of the motor for adjusting the left side is 1. If the answer is Y, outputting of the normal rotation command to the driver 66 for the motor for adjusting the left side is stopped in Step P279, and the program proceeds to Step P280. If the answer is N, it is determined in Step P281 whether the value of the memory for storing the rotating direction of the motor for adjusting the left side is 2.

If the answer is Y in the above Step P281, outputting of the reverse rotation command to the driver 66 for the motor for adjusting the left side is stopped in Step P282, and the program shifts to the aforementioned Step P280. If the answer is N, the program shifts to the aforementioned Step P285.

Then, in the above-mentioned Step P280, the memory M60 for storing the rotating direction of the motor for adjusting the left side is overwritten with 0. Then, in Step P283, the count value S is loaded from the memory M59, whereafter 1 is added to the count value S of the memory M59 for overwriting in Step P284.

Then, in Step P285, the count value is loaded from the counter 72 for detecting the current position of the right side of the squeegee, and stored into the memory M63. Then, in Step P286, the desired count value of the counter for detecting the position of the right side of the squeegee is loaded from the memory M56.

Then, in Step P287, it is determined whether the count value of the counter for detecting the current position of the right side of the squeegee is equal to the desired count value of the counter for detecting the position of the right side of the squeegee. If the answer is Y, the value of the memory M61 for storing the rotating direction of the motor for adjusting the right side is loaded in Step P288. If the answer is N, the program returns to Step P268.

Then, in Step P289, it is determined whether the value of the memory for storing the rotating direction of the motor for adjusting the right side is 1. If the answer is Y, outputting of the normal rotation command to the driver 70 for the motor for adjusting the right side is stopped in Step P290, and the program proceeds to Step P291. If the answer is N, it is determined in Step P292 whether the value of the memory for storing the rotating direction of the motor for adjusting the right side is 2.

If the answer is Y in the above Step P292, outputting of the reverse rotation command to the driver 70 for the motor for adjusting the right side is stopped in Step P293, and the program shifts to the aforementioned Step P291. If the answer is N, the program returns to Step P268.

Then, in the aforementioned Step P291, the memory M61 for storing the rotating direction of the motor for adjusting the right side is overwritten with 0. Then, in Step P294, the count value S is loaded from the memory M59, whereafter 1 is added to the count value S of the memory M59 for overwriting in Step P295. Then, the program returns to Step P268.

In accordance with the above-described motion flow, when the squeegee throw-on and throw-off automatic control switch 52 is ON and the cylinder engagement signal for the rotary screen cylinder 11 is ON, the squeegee 38 is moved to the predetermined printing position when it enters the rotation phase of the rotary screen cylinder 11 corresponding to the position of the rear end of the notch of the impression cylinder 13.

Then, in Step P296 shifted from the aforementioned Step P273, the table of conversion from the total number of revolutions during squeegee throw-on to the correction amount (count value of the counter) of the squeegee position is loaded from the memory M64. Then, in Step P297, the count value is loaded from the counter 76 for counting the total number of revolutions during squeegee throw-on, and stored into the memory M65.

Then, in Step P298, the correction amount (count value of the counter) of the squeegee position is obtained from the count value of the counter 76 for counting the total number of revolutions during squeegee throw-on, with the use of the table of conversion from the total number of revolutions during squeegee throw-on to the correction amount (count value of the counter) of the squeegee position, and this correction amount is stored into the memory M66. Then, in Step P299, the reference retreat position (count value of the counter) of the squeegee is loaded from the memory M53.

Then, in Step P300, the correction amount (count value of the counter) of the squeegee position is loaded from the memory M66. Then, in Step P301, the correction amount (count value of the counter) of the squeegee position is added to the reference retreat position (count value of the counter) of the squeegee to compute the retreat position (count value of the counter) of the squeegee, which is stored into the memory M67.

Then, in Step P302, the memory M55 for storing the desired count value of the counter for detecting the position of the left side of the squeegee is overwritten with the retreat position (count value of the counter) of the squeegee. Then, in Step P303, the memory M56 for storing the desired count value of the counter for detecting the position of the right side of the squeegee is overwritten with the retreat position (count value of the counter) of the squeegee.

Then, in Step P304, the count value is loaded from the counter 74 for detecting the rotation phase of the rotary screen cylinder, and stored into the memory M68. Then, in Step P305, the rotation phase of the rotary screen cylinder at the squeegee retreat start position is loaded from the memory M72.

Then, in Step P306, it is determined whether the count value of the counter for detecting the rotation phase of the rotary screen cylinder is equal to the rotation phase of the rotary screen cylinder at the squeegee retreat start position. If the answer is N, the program returns to Step P304 mentioned above. If the answer is Y, the count value S of the memory M59 is overwritten with 0 in Step P307. Then, in Step P308, the memory M60 for storing the rotating direction of the motor for adjusting the left side is overwritten with 0. Then, in Step P309, the memory M61 for storing the rotating direction of the motor for adjusting the right side is overwritten with 0.

Then, in Step P310, the count value is loaded from the counter 68 for detecting the current position of the left side of the squeegee, and stored into the memory M62. Then, in Step P311, the desired count value of the counter for detecting the position of the left side of the squeegee is loaded from the memory M55.

Then, in Step P312, it is determined whether the count value of the counter for detecting the current position of the left side of the squeegee is equal to the desired count value of the counter for detecting the position of the left side of the squeegee. If the answer is N, it is determined, in Step P313, whether the count value of the counter for detecting the current position of the left side of the squeegee is less than the desired count value of the counter for detecting the position of the left side of the squeegee.

If the answer is Y in the above Step P313, the memory M60 for storing the rotating direction of the motor for adjusting the left side is overwritten with 1 in Step P314. Then, in Step P315, a normal rotation command is outputted to the driver 66 for the motor for adjusting the left side, whereafter the program proceeds to Step P316. If the answer is N in Step P313, the memory M60 for storing the rotating direction of the motor for adjusting the left side is overwritten with 2 in Step P317. Then, in Step P318, a reverse rotation command is outputted to the driver 66 for the motor for adjusting the left side, whereafter the program shifts to the aforementioned Step P316.

If the answer is Y in the aforementioned Step P312, the count value S is loaded from the memory M59 in Step P319. Then, in Step P320, 1 is added to the count value S of the memory M59 for overwriting, whereafter the program shifts to Step P316 mentioned above.

Then, in the aforementioned Step P316, the count value is loaded from the counter 72 for detecting the current position of the right side of the squeegee, and stored into the memory M63. Then, in Step P321, the desired count value of the counter for detecting the position of the right side of the squeegee is loaded from the memory M56.

Then, in Step P322, it is determined whether the count value of the counter for detecting the current position of the right side of the squeegee is equal to the desired count value of the counter for detecting the position of the right side of the squeegee. If the answer is N, it is determined, in Step P323, whether the count value of the counter for detecting the current position of the right side of the squeegee is less than the desired count value of the counter for detecting the position of the right side of the squeegee.

If the answer is Y in the above Step P323, the memory M61 for storing the rotating direction of the motor for adjusting the right side is overwritten with 1 in Step P324. Then, in Step P325, a normal rotation command is outputted to the driver 70 for the motor for adjusting the right side, whereafter the program proceeds to Step P326. If the answer is N in Step P323, the memory M61 for storing the rotating direction of the motor for adjusting the right side is overwritten with 2 in Step P327. Then, in Step P328, a reverse rotation command is outputted to the driver 70 for the motor for adjusting the right side, whereafter the program shifts to the aforementioned Step P326.

If the answer is Y in the aforementioned Step P322, the count value S is loaded from the memory M59 in Step P329. Then, in Step P330, 1 is added to the count value S of the memory M59 for overwriting, whereafter the program shifts to Step P326 mentioned above.

Then, in Step P326 mentioned above, the count value S is loaded from the memory M59, whereafter it is determined in Step P331 whether the count value S is 2. If the answer is Y in this Step P331, it is determined in Step P332 whether the cylinder engagement signal for the rotary screen cylinder is ON. If the answer is Y in this step, the program returns to the aforementioned Step P238. If the answer is N, the program returns to the aforementioned Step P125.

If the answer is N in the above-mentioned Step P331, the count value is loaded from the counter 68 for detecting the current position of the left side of the squeegee, and stored into the memory M62, in Step P333. Then, in Step P334, the desired count value of the counter for detecting the position of the left side of the squeegee is loaded from the memory M55.

Then, in Step P335, it is determined whether the count value of the counter for detecting the current position of the left side of the squeegee is equal to the desired count value of the counter for detecting the position of the left side of the squeegee. If the answer is Y, the value of the memory M60 for storing the rotating direction of the motor for adjusting the left side is loaded in Step P336. If the answer is N, the program shifts to Step P344 to be described later.

Then, in Step P337, it is determined whether the value of the memory for storing the rotating direction of the motor for adjusting the left side is 1. If the answer is Y, outputting of the normal rotation command to the driver 66 for the motor for adjusting the left side is stopped in Step P338, and the program proceeds to Step P339. If the answer is N, it is determined in Step P340 whether the value of the memory for storing the rotating direction of the motor for adjusting the left side is 2.

If the answer is Y in the above Step P340, outputting of the reverse rotation command to the driver 66 for the motor for adjusting the left side is stopped in Step P341, and the program shifts to the aforementioned Step P339. If the answer is N, the program shifts to the aforementioned Step P344.

Then, in the aforementioned Step P339, the memory M60 for storing the rotating direction of the motor for adjusting the left side is overwritten with 0. Then, in Step P342, the count value S is loaded from the memory M59, whereafter 1 is added to the count value S of the memory M59 for overwriting in Step P343.

Then, in Step P344, the count value is loaded from the counter 72 for detecting the current position of the right side of the squeegee, and stored into the memory M63. Then, in Step P345, the desired count value of the counter for detecting the position of the right side of the squeegee is loaded from the memory M56.

Then, in Step P346, it is determined whether the count value of the counter for detecting the current position of the right side of the squeegee is equal to the desired count value of the counter for detecting the position of the right side of the squeegee. If the answer is Y, the value of the memory M61 for storing the rotating direction of the motor for adjusting the right side is loaded in Step P347. If the answer is N, the program returns to Step P326.

Then, in Step P348, it is determined whether the value of the memory for storing the rotating direction of the motor for adjusting the right side is 1. If the answer is Y, outputting of the normal rotation command to the driver 70 for the motor for adjusting the right side is stopped in Step P349, and the program proceeds to Step P350. If the answer is N, it is determined in Step P351 whether the value of the memory for storing the rotating direction of the motor for adjusting the right side is 2.

If the answer is Y in the above Step P351, outputting of the reverse rotation command to the driver 70 for the motor for adjusting the right side is stopped in Step P352, and the program shifts to the aforementioned Step P350. If the answer is N, the program returns to Step P326.

Then, in the aforementioned Step P350, the memory M61 for storing the rotating direction of the motor for adjusting the right side is overwritten with 0. Then, in Step P353, the count value S is loaded from the memory M59, whereafter 1 is added to the count value S of the memory M59 for overwriting in Step P354. Then, the program returns to Step P326.

In accordance with the above-described motion flow, when the squeegee throw-on and throw-off automatic control switch 52 is ON and the cylinder engagement signal for the rotary screen cylinder 11 is ON, the squeegee 38 is moved to the predetermined retreat position when it enters the rotation phase of the rotary screen cylinder 11 at the squeegee retreat start position.

Then, in Step P355 shifted from the aforementioned Step P123, the throw-off position (count value of the counter) of the squeegee is loaded from the memory M54.

Then, in Step P356, the memory M55 for storing the desired count value of the counter for detecting the position of the left side of the squeegee is overwritten with the throw-off position (count value of the counter) of the squeegee. Then, in Step P357, the memory M56 for storing the desired count value of the counter for detecting the position of the right side of the squeegee is overwritten with the throw-off position (count value of the counter) of the squeegee.

Then, in Step P358, the count value S of the memory M59 is overwritten with 0, whereafter the memory M60 for storing the rotating direction of the motor for adjusting the left side is overwritten with 0 in Step P359. Then, in Step P360, the memory M61 for storing the rotating direction of the motor for adjusting the right side is overwritten with 0.

Then, in Step P361, the count value is loaded from the counter 74 for detecting the rotation phase of the rotary screen cylinder, and stored into the memory M68. Then, in Step P362, the rotation phase of the rotary screen cylinder during squeegee throw-off is loaded from the memory M58.

Then, in Step P363, it is determined whether the count value of the counter for detecting the rotation phase of the rotary screen cylinder is equal to the rotation phase of the rotary screen cylinder during squeegee throw-off. If the answer is N, the program returns to Step P361 mentioned above. If the answer is Y, the count value is loaded from the counter 68 for detecting the current position of the left side of the squeegee, and stored into the memory M62, in Step P364. Then, in Step P365, the desired count value of the counter for detecting the position of the left side of the squeegee is loaded from the memory M55.

Then, in Step P366, it is determined whether the count value of the counter for detecting the current position of the left side of the squeegee is equal to the desired count value of the counter for detecting the position of the left side of the squeegee. If the answer is N, it is determined, in Step P367, whether the count value of the counter for detecting the current position of the left side of the squeegee is less than the desired count value of the counter for detecting the position of the left side of the squeegee.

If the answer is Y in the above Step P367, the memory M60 for storing the rotating direction of the motor for adjusting the left side is overwritten with 1 in Step P368. Then, in Step P369, a normal rotation command is outputted to the driver 66 for the motor for adjusting the left side, whereafter the program proceeds to Step P370. If the answer is N in Step P367, the memory M60 for storing the rotating direction of the motor for adjusting the left side is overwritten with 2 in Step P371. Then, in Step P372, a reverse rotation command is outputted to the driver 66 for the motor for adjusting the left side, whereafter the program shifts to the aforementioned Step P370.

If the answer is Y in the aforementioned Step P366, the count value S is loaded from the memory M59 in Step P373. Then, in Step P374, 1 is added to the count value S of the memory M59 for overwriting, whereafter the program shifts to Step P370 mentioned above.

Then, in the aforementioned Step P370, the count value is loaded from the counter 72 for detecting the current position of the right side of the squeegee, and stored into the memory M63. Then, in Step P375, the desired count value of the counter for detecting the position of the right side of the squeegee is loaded from the memory M56.

Then, in Step P376, it is determined whether the count value of the counter for detecting the current position of the right side of the squeegee is equal to the desired count value of the counter for detecting the position of the right side of the squeegee. If the answer is N, it is determined, in Step P377, whether the count value of the counter for detecting the current position of the right side of the squeegee is less than the desired count value of the counter for detecting the position of the right side of the squeegee.

If the answer is Y in the above Step P377, the memory M61 for storing the rotating direction of the motor for adjusting the right side is overwritten with 1 in Step P378. Then, in Step P379, a normal rotation command is outputted to the driver 70 for the motor for adjusting the right side, whereafter the program proceeds to Step P380. If the answer is N in Step P377, the memory M61 for storing the rotating direction of the motor for adjusting the right side is overwritten with 2 in Step P381. Then, in Step P382, a reverse rotation command is outputted to the driver 70 for the motor for adjusting the right side, whereafter the program shifts to the aforementioned Step P380.

If the answer is Y in the aforementioned Step P376, the count value S is loaded from the memory M59 in Step P383. Then, in Step P384, 1 is added to the count value S of the memory M59 for overwriting, whereafter the program shifts to Step P380 mentioned above.

Then, in Step P380 mentioned above, the count value S is loaded from the memory M59, whereafter it is determined in Step P385 whether the count value S is 2. If the answer is Y in this Step P385, outputting of the enabling signal to the counter 76 for counting the total number of revolutions during squeegee throw-on is stopped in Step P386, and the program returns to Step P1.

Then, in Step P387, the count value is loaded from the counter 68 for detecting the current position of the left side of the squeegee, and stored into the memory M62. Then, in Step P388, the desired count value of the counter for detecting the position of the left side of the squeegee is loaded from the memory M55.

Then, in Step P389, it is determined whether the count value of the counter for detecting the current position of the left side of the squeegee is equal to the desired count value of the counter for detecting the position of the left side of the squeegee. If the answer is Y, the value of the memory M60 for storing the rotating direction of the motor for adjusting the left side is loaded in Step P390. If the answer is N, the program shifts to Step P398 to be described later.

Then, in Step P391, it is determined whether the value of the memory for storing the rotating direction of the motor for adjusting the left side is 1. If the answer is Y, outputting of the normal rotation command to the driver 66 for the motor for adjusting the left side is stopped in Step P392, and the program proceeds to Step P393. If the answer is N, it is determined in Step P394 whether the value of the memory for storing the rotating direction of the motor for adjusting the left side is 2.

If the answer is Y in the above Step P394, outputting of the reverse rotation command to the driver 66 for the motor for adjusting the left side is stopped in Step P395, and the program shifts to the aforementioned Step P393. If the answer is N, the program shifts to the aforementioned Step P398.

Then, in the aforementioned Step P393, the memory M60 for storing the rotating direction of the motor for adjusting the left side is overwritten with 0. Then, in Step P396, the count value S is loaded from the memory M59, whereafter 1 is added to the count value S of the memory M59 for overwriting in Step P397.

Then, in Step P398, the count value is loaded from the counter 72 for detecting the current position of the right side of the squeegee, and stored into the memory M63. Then, in Step P399, the desired count value of the counter for detecting the position of the right side of the squeegee is loaded from the memory M56.

Then, in Step P400, it is determined whether the count value of the counter for detecting the current position of the right side of the squeegee is equal to the desired count value of the counter for detecting the position of the right side of the squeegee. If the answer is Y, the value of the memory M61 for storing the rotating direction of the motor for adjusting the right side is loaded in Step P401. If the answer is N, the program returns to Step P380.

Then, in Step P402, it is determined whether the value of the memory for storing the rotating direction of the motor for adjusting the right side is 1. If the answer is Y, outputting of the normal rotation command to the driver 70 for the motor for adjusting the right side is stopped in Step P403, and the program proceeds to Step P404. If the answer is N, it is determined in Step P405 whether the value of the memory for storing the rotating direction of the motor for adjusting the right side is 2.

If the answer is Y in the above Step P405, outputting of the reverse rotation command to the driver 70 for the motor for adjusting the right side is stopped in Step P406, and the program shifts to the aforementioned Step P404. If the answer is N, the program returns to Step P380.

Then, in the aforementioned Step P404, the memory M61 for storing the rotating direction of the motor for adjusting the right side is overwritten with 0. Then, in Step P407, the count value S is loaded from the memory M59, whereafter 1 is added to the count value S of the memory M59 for overwriting in Step P408. Then, the program returns to Step P380.

In accordance with the above-described motion flow, when the squeegee throw-on and throw-off automatic control switch 52 is brought to the OFF-state, the squeegee 38 is moved to the throw-off position.

According to the present Embodiment 1, as described above, the squeegee 38 is moved by the squeegee throw-on and throw-off control device 40A to the position of retreat from the notch 13b of the impression cylinder 13 with a timing conformed to the preset length in the transport direction of the material W to be printed, in other words, when the squeegee 38 enters the rotation phase of the rotary screen cylinder 11 at the squeegee retreat start position.

This makes it possible to prevent the damage or wear of the screen printing forme 11c due to the abrupt movement of the squeegee 38 during printing (namely, at the rear end of the printed material W, the squeegee 38 abruptly moving toward the impression cylinder 13 by an amount corresponding to the thickness of the printed material W).

Furthermore, the above-mentioned retreat position is controlled to a position where the leading end of the squeegee 38 makes contact with the inner peripheral surface of the screen printing forme 11c, and the pressing force of the squeegee 38 acting on the inner peripheral surface of the screen printing forme 11c becomes smaller than the pressing force exerted during printing.

Thus, the screen printing forme 11c can be prevented from being pushed into the notch 13b of the impression cylinder 13 and damaged thereby, and there is no ink leaking out toward the downstream side in the rotating direction of the screen printing forme 11c, so that deterioration of printing quality can be prevented. That is, the following problems are avoided: Because of leaks of ink toward the downstream side in the rotating direction of the screen printing forme 11c, the amount of ink remaining in front of the squeegee 38 becomes small to decrease the ink density at the start of printing. The ink leaking out toward the downstream side leaks out through the holes of the picture pattern portion under a centrifugal force during high speed rotation, adheres to outside portions of the holes, and sticks to the outside of the picture pattern portion during printing, thereby deteriorating printing quality.

Furthermore, the squeegee throw-on and throw-off control device 40A can preset the pressing force of the squeegee 38 at the retreat position in accordance with the type of the screen printing forme 11c (material, forme thickness, mesh size, etc.), the picture pattern area rate of the picture pattern printed on the material W to be printed, the type of ink used in printing (viscosity, yield value, type of pigment, etc.), and the type of the squeegee 38 (material, thickness, etc.).

Hence, damage to the screen printing forme 11c and deterioration of printing quality are prevented with even higher accuracy.

In the present Embodiment 1, the control pressure may be switched using a hydraulic or pneumatic actuator instead of the motor 36A for adjusting the left side and the motor 36B for adjusting the right side. Moreover, the motors 36A and 36B are disposed on the right side and the left side. However, there may be adopted a configuration in which a one-sided motor moves the right and left sides, for example, by connecting the right and left sides by a lever mechanism.

### Embodiment 2

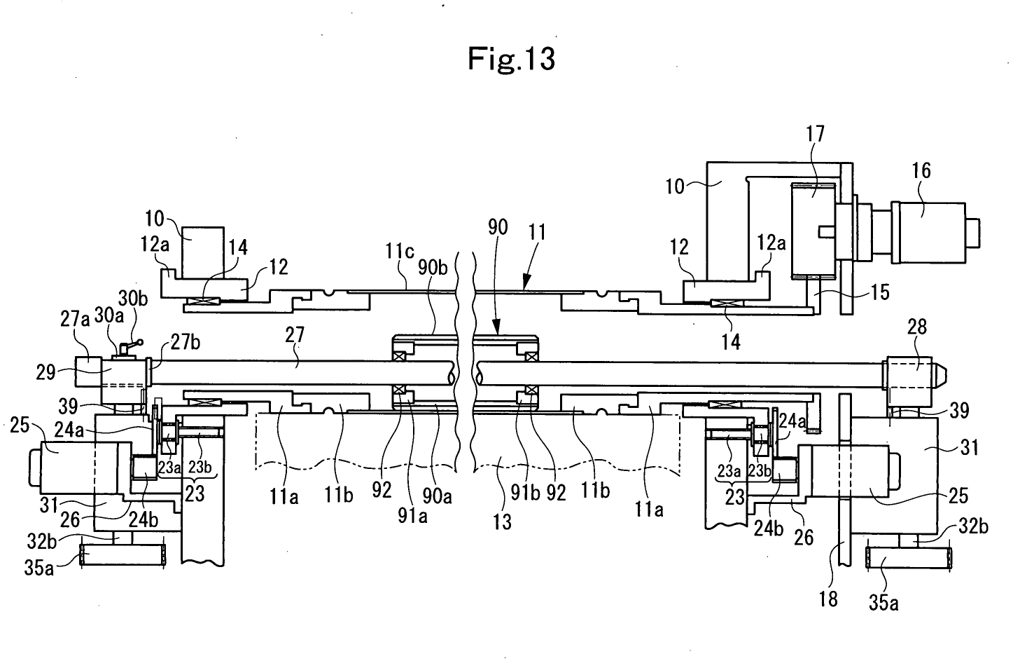

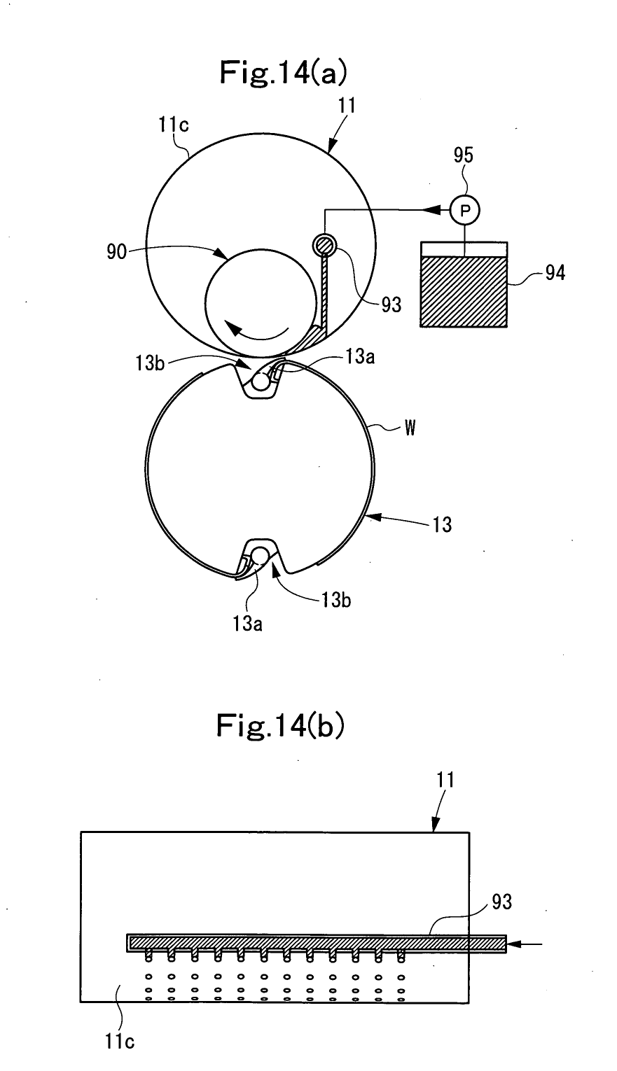

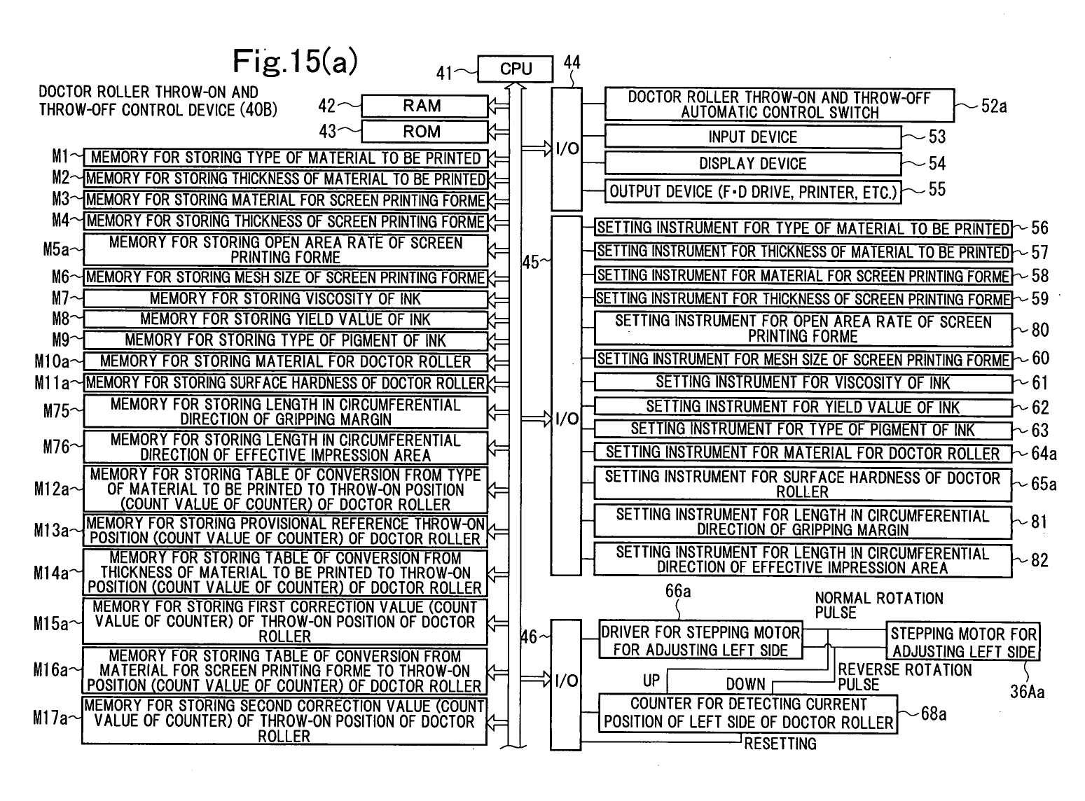

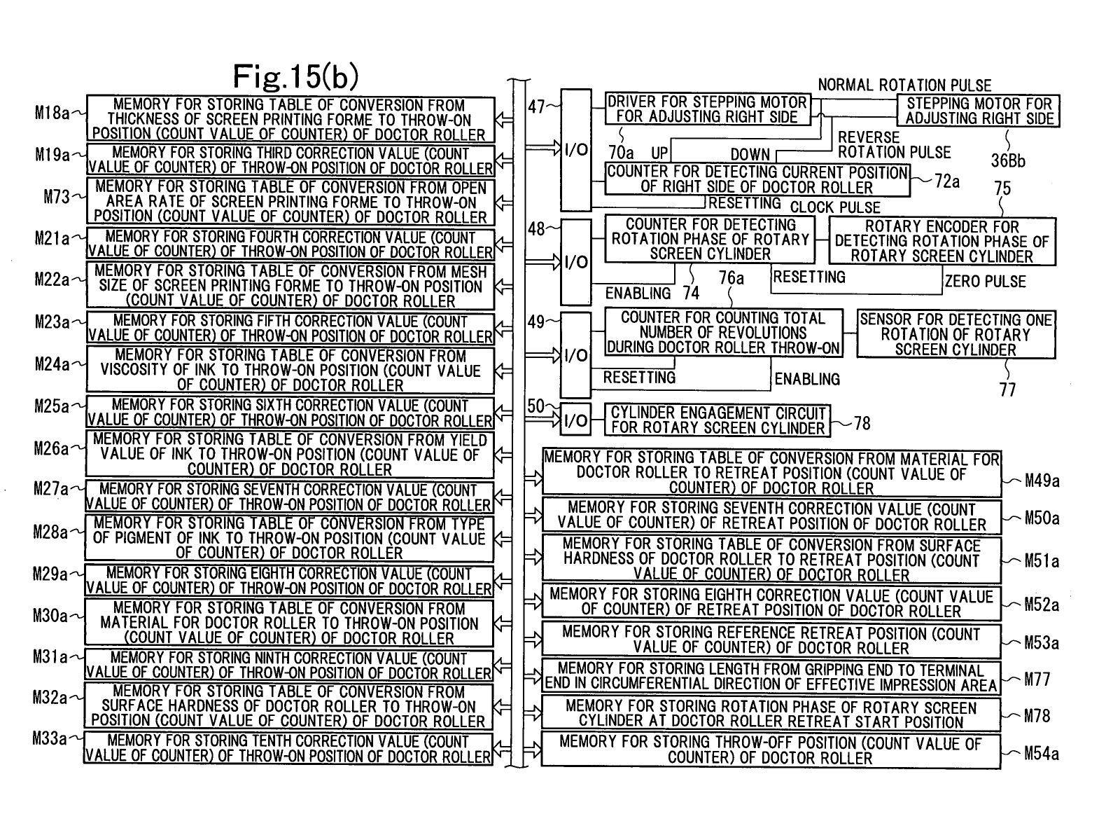

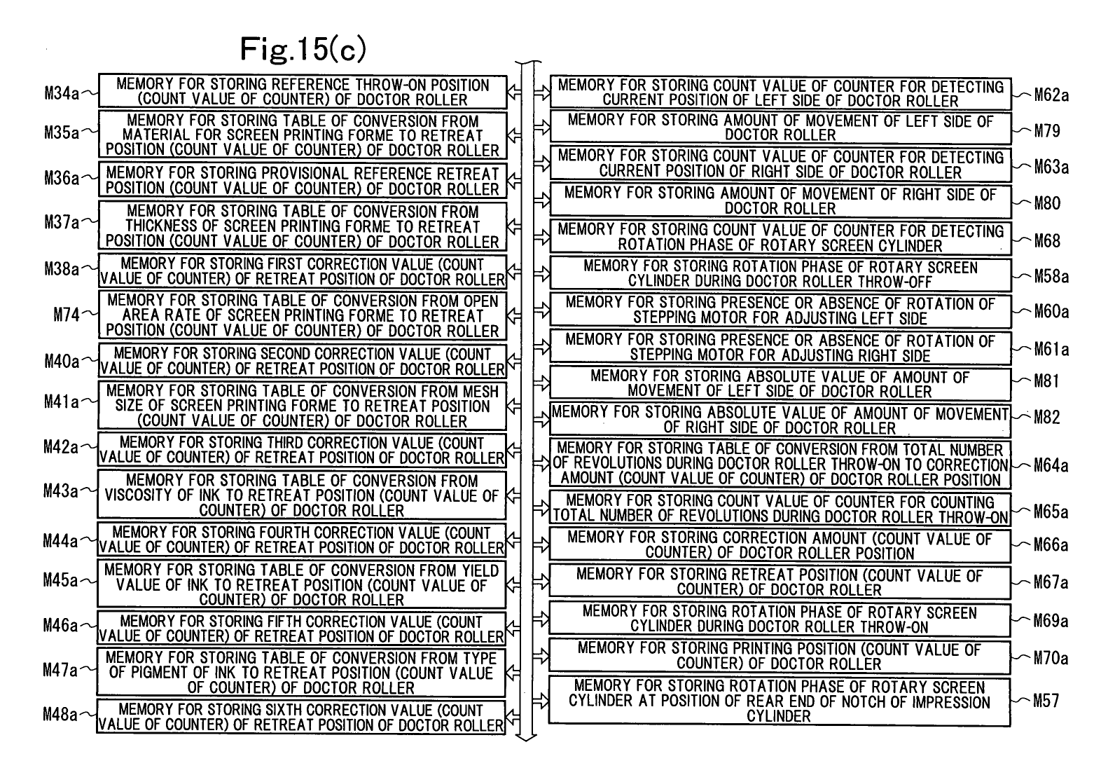

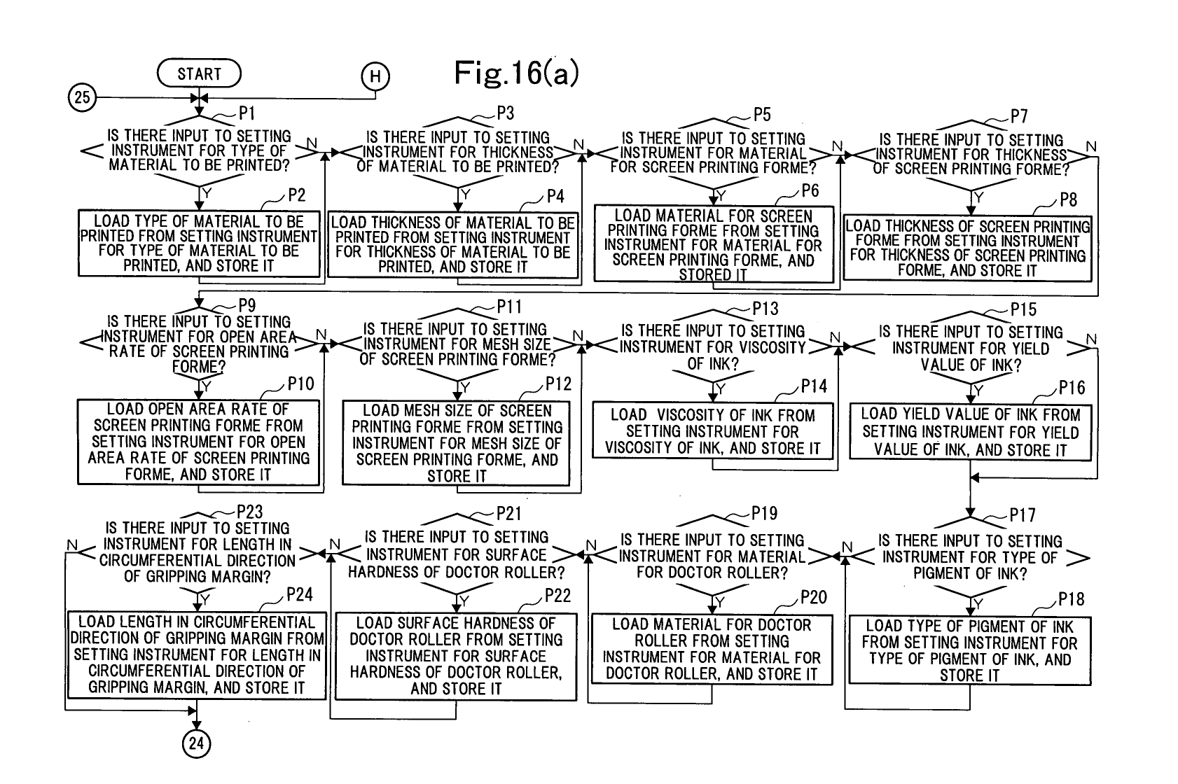

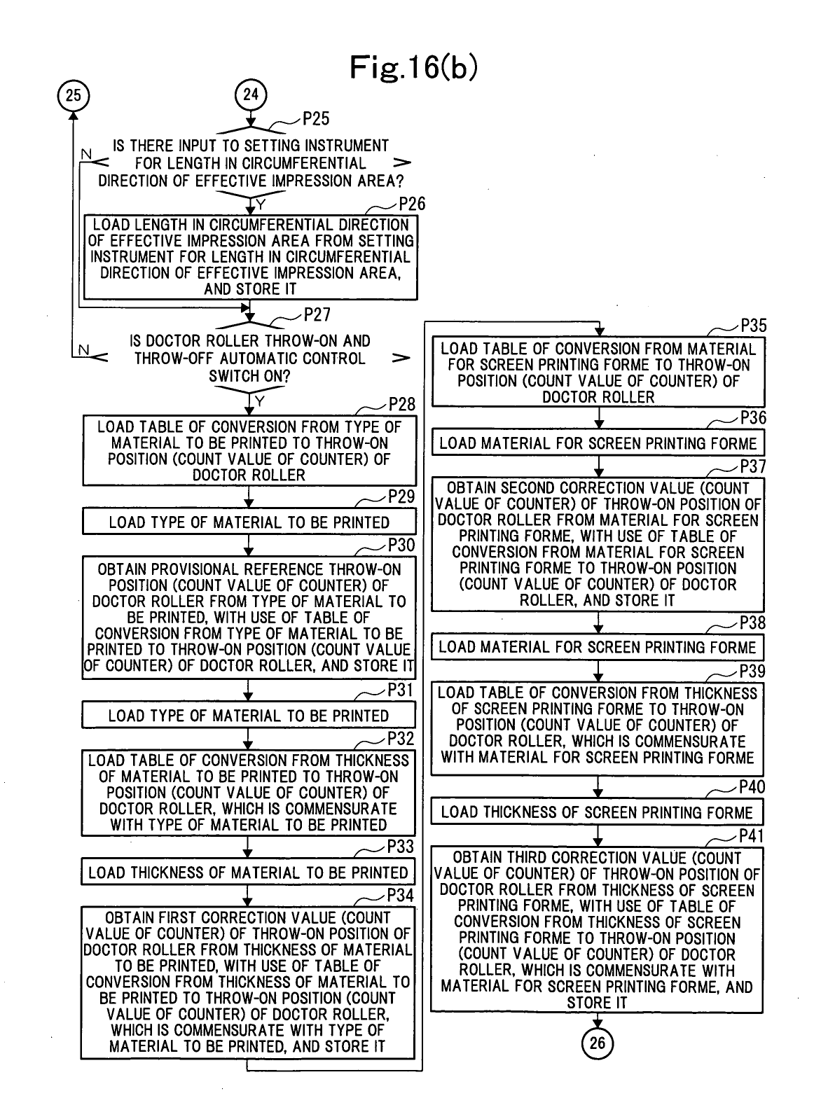

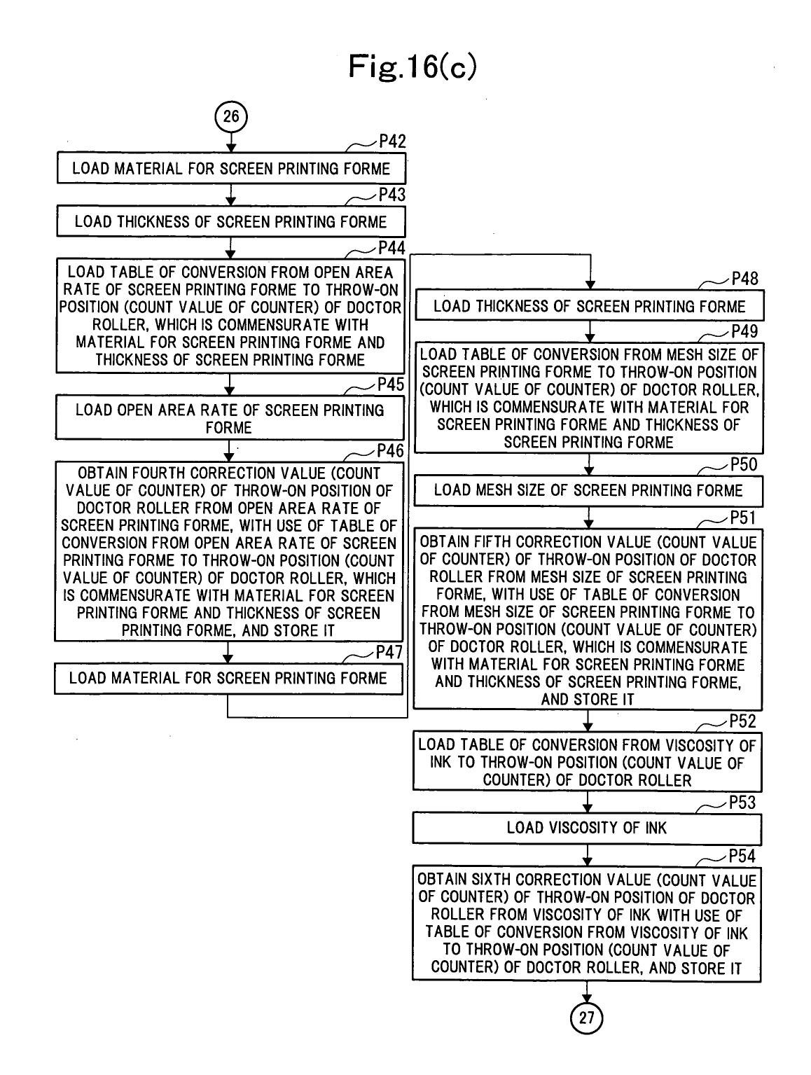

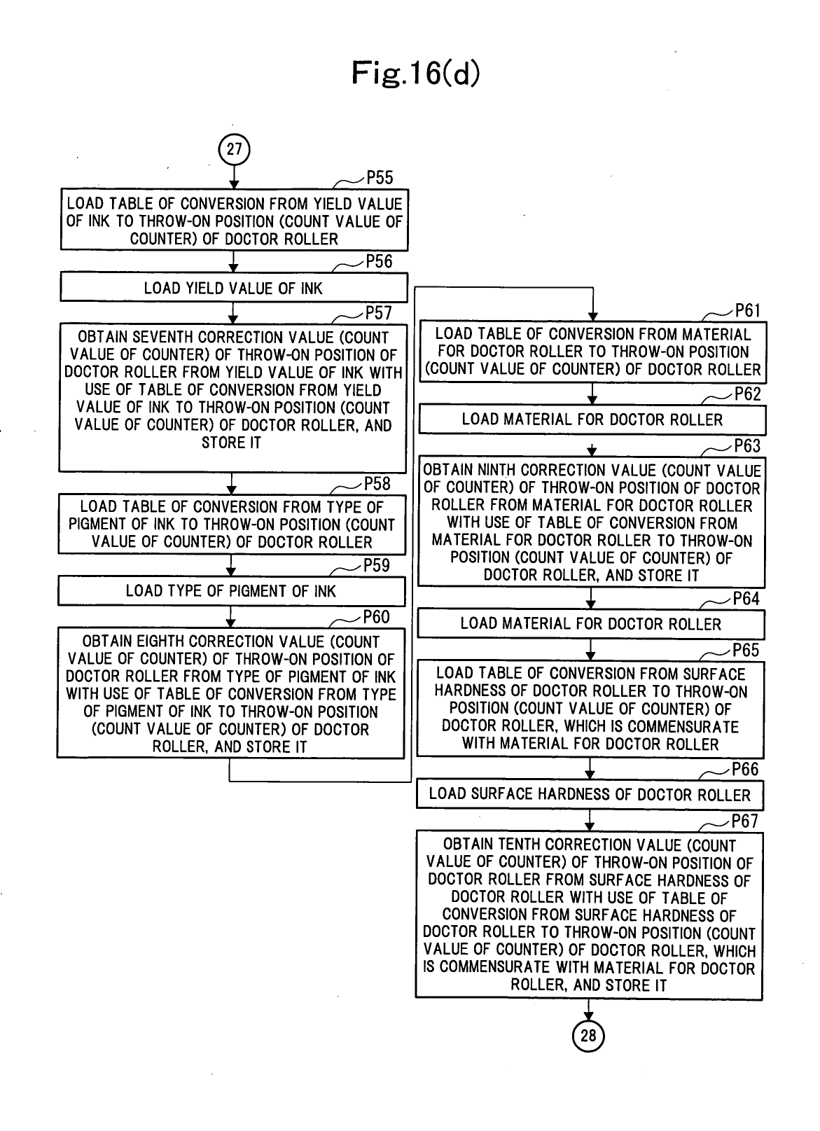

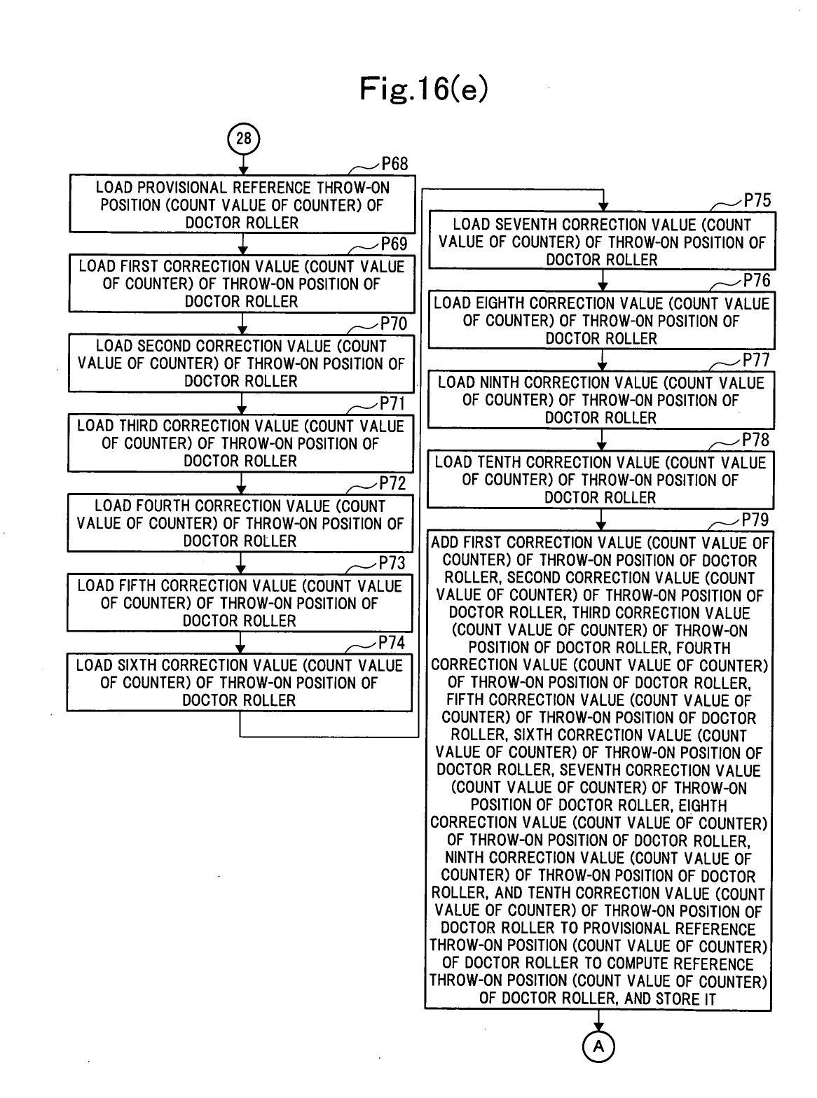

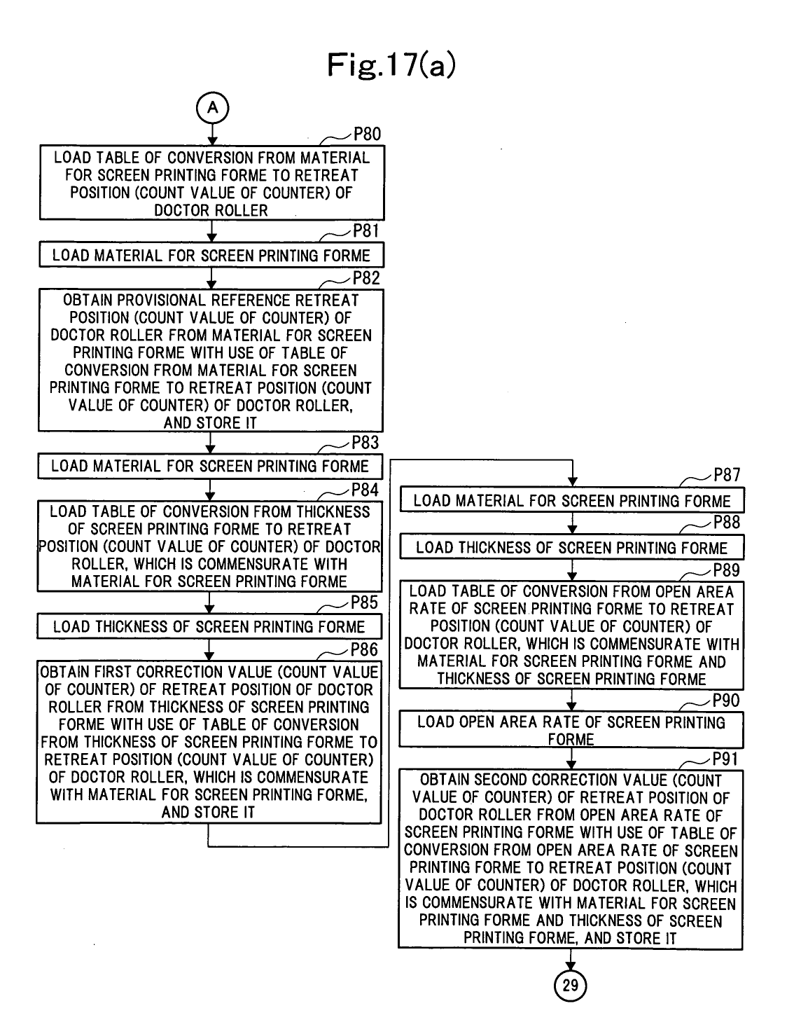

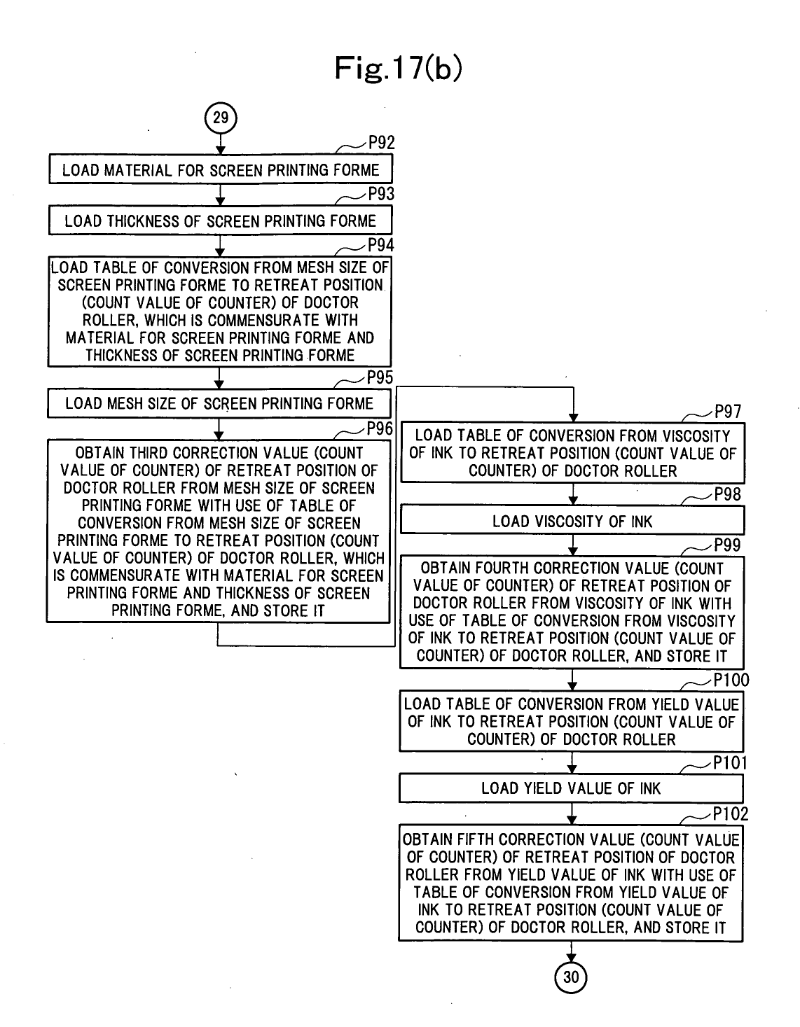

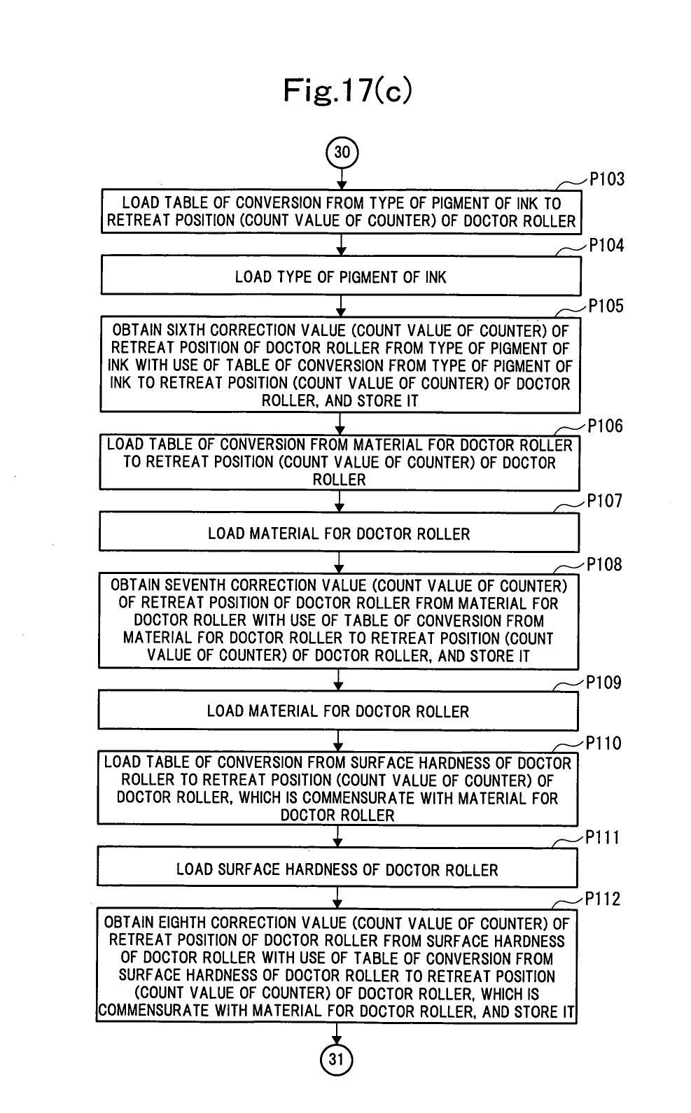

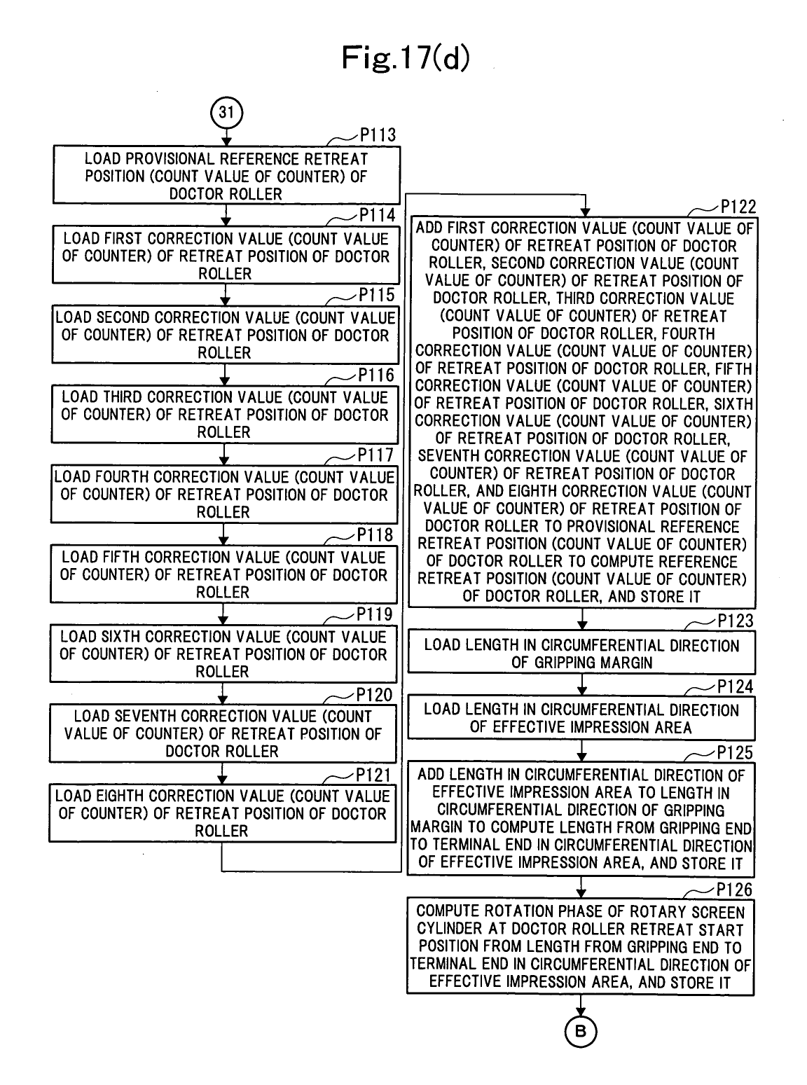

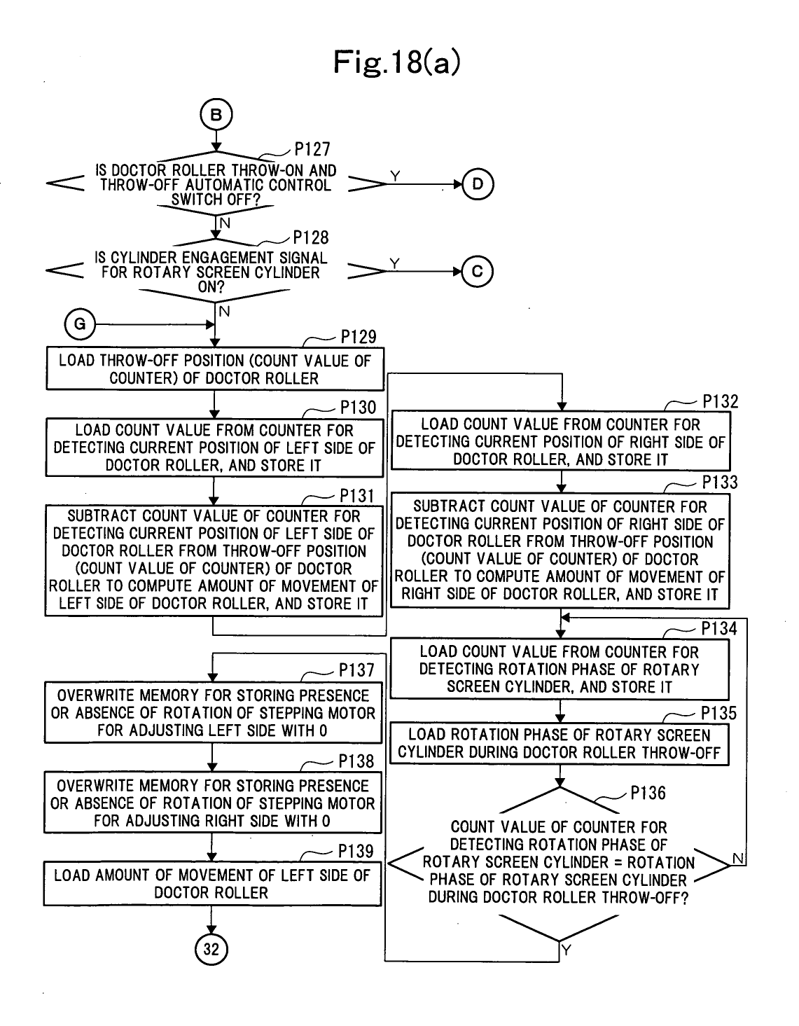

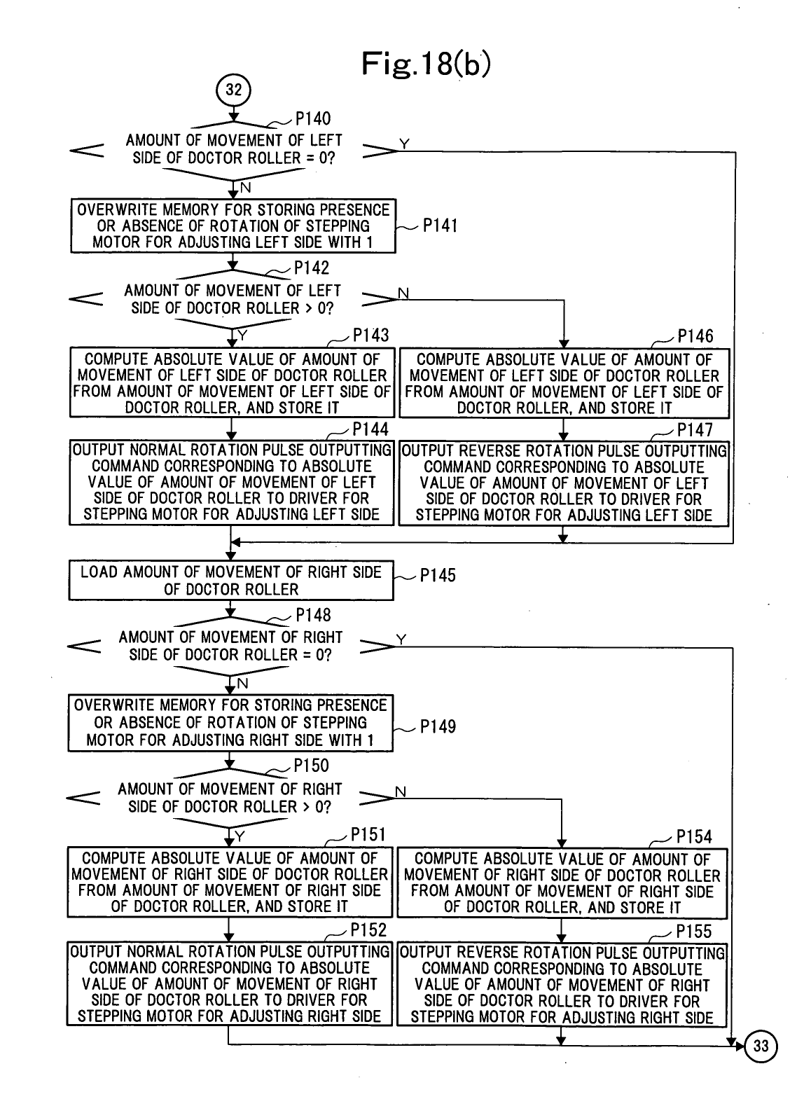

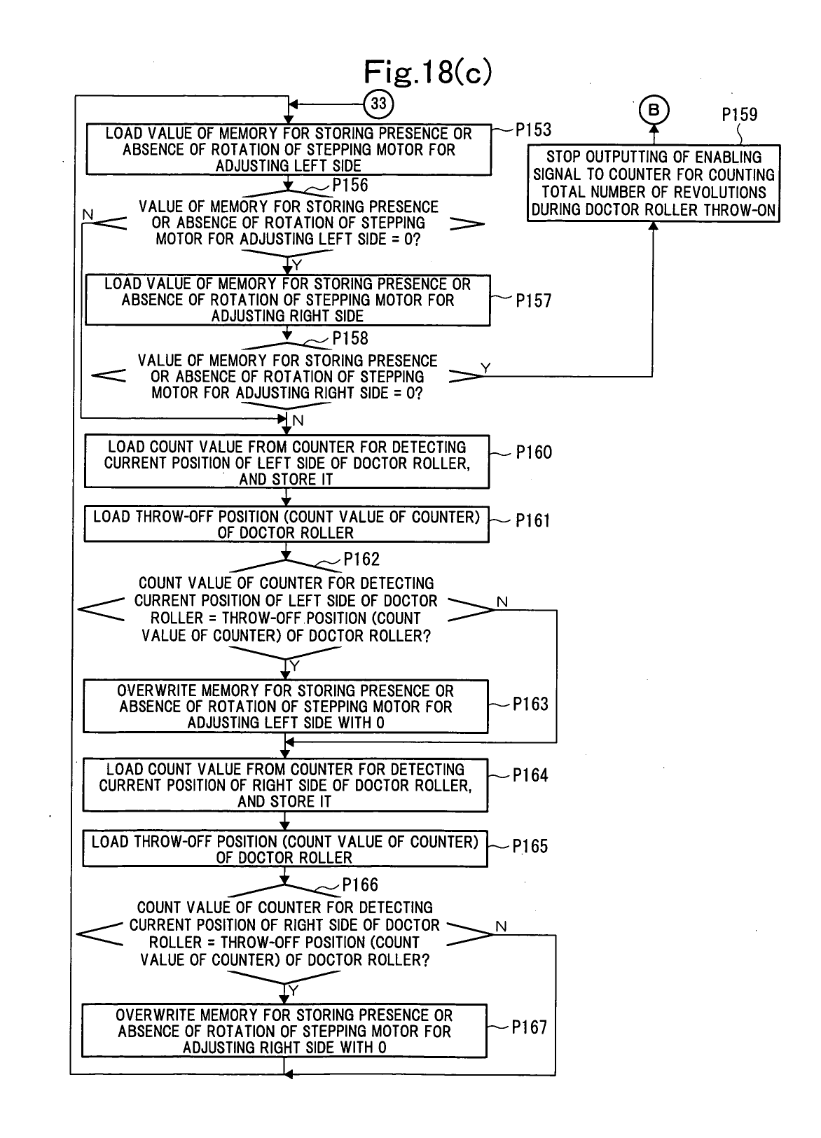

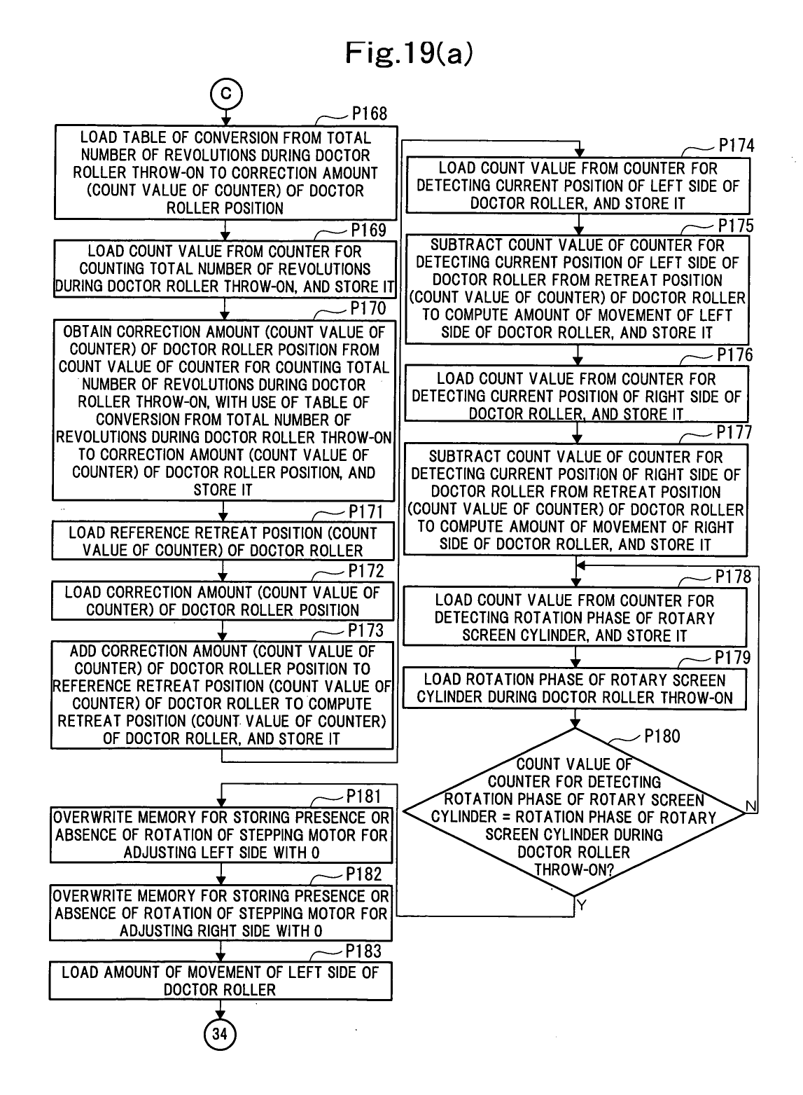

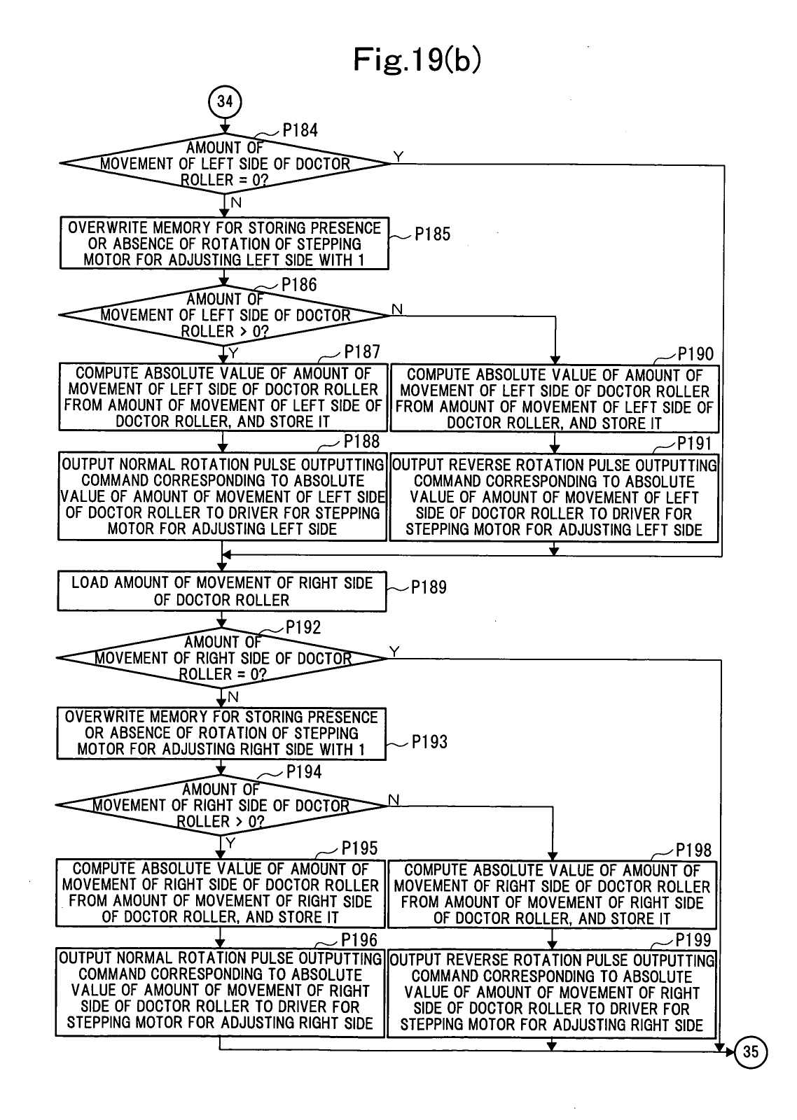

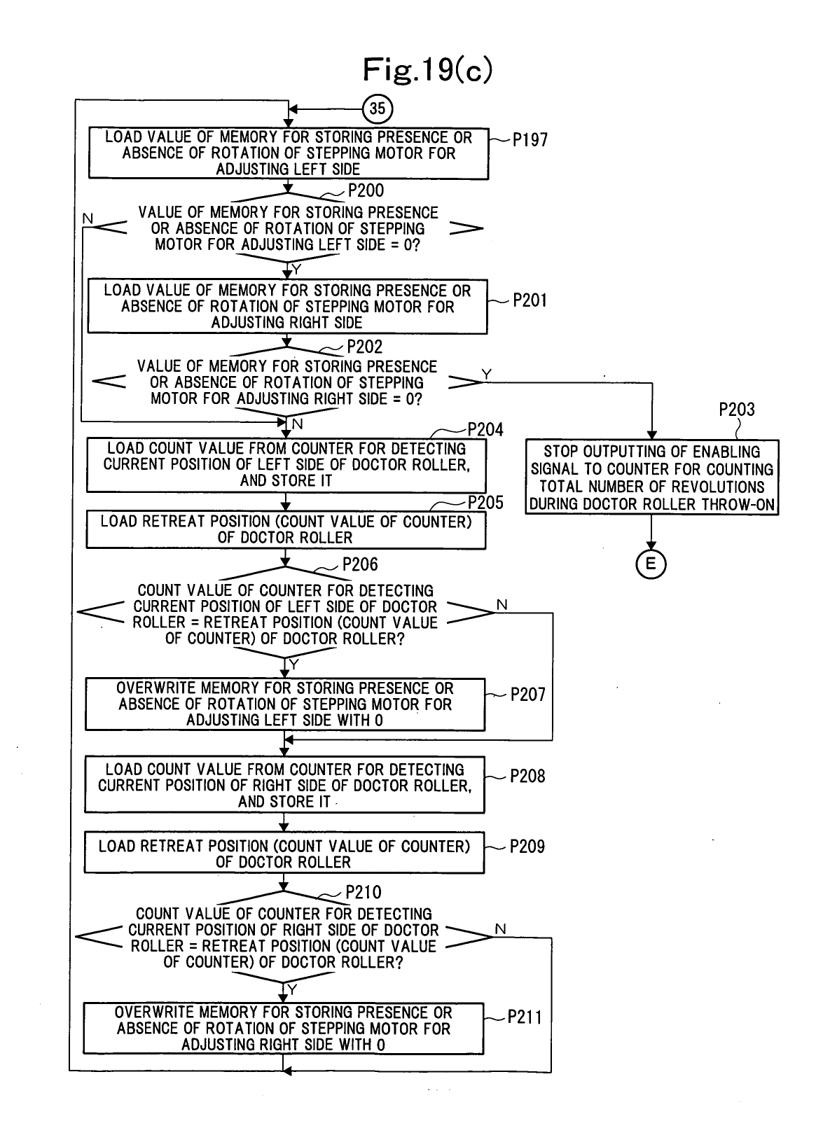

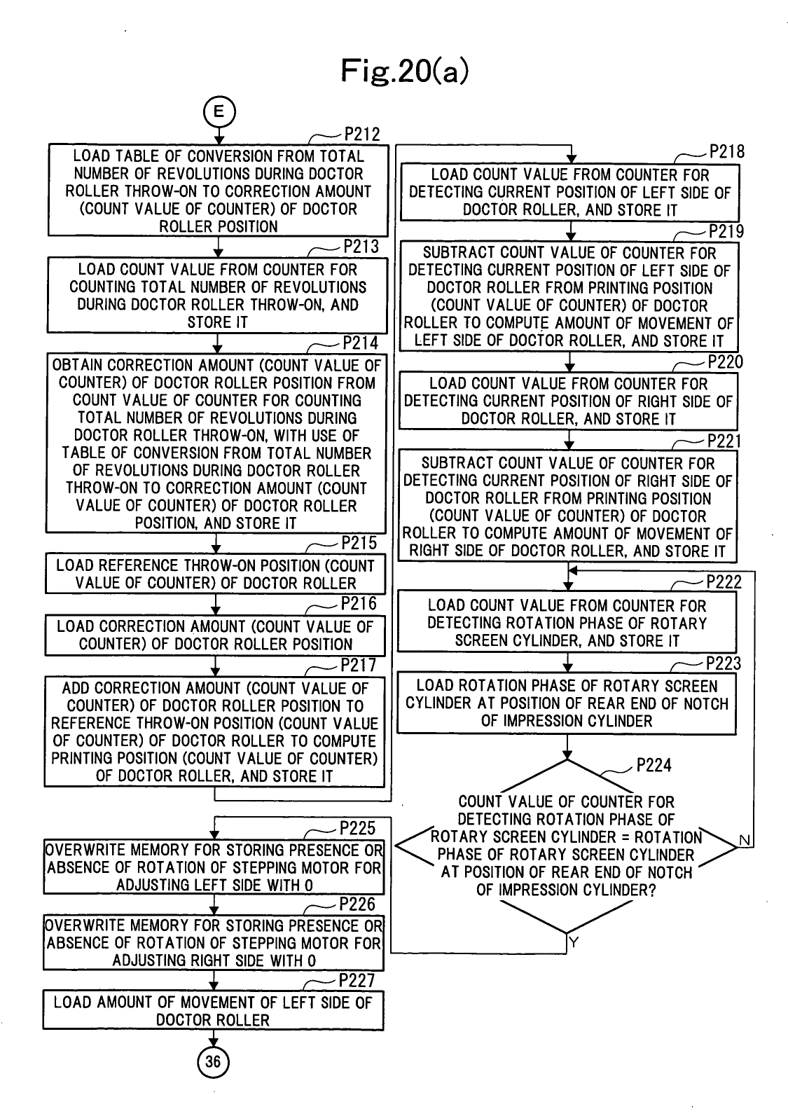

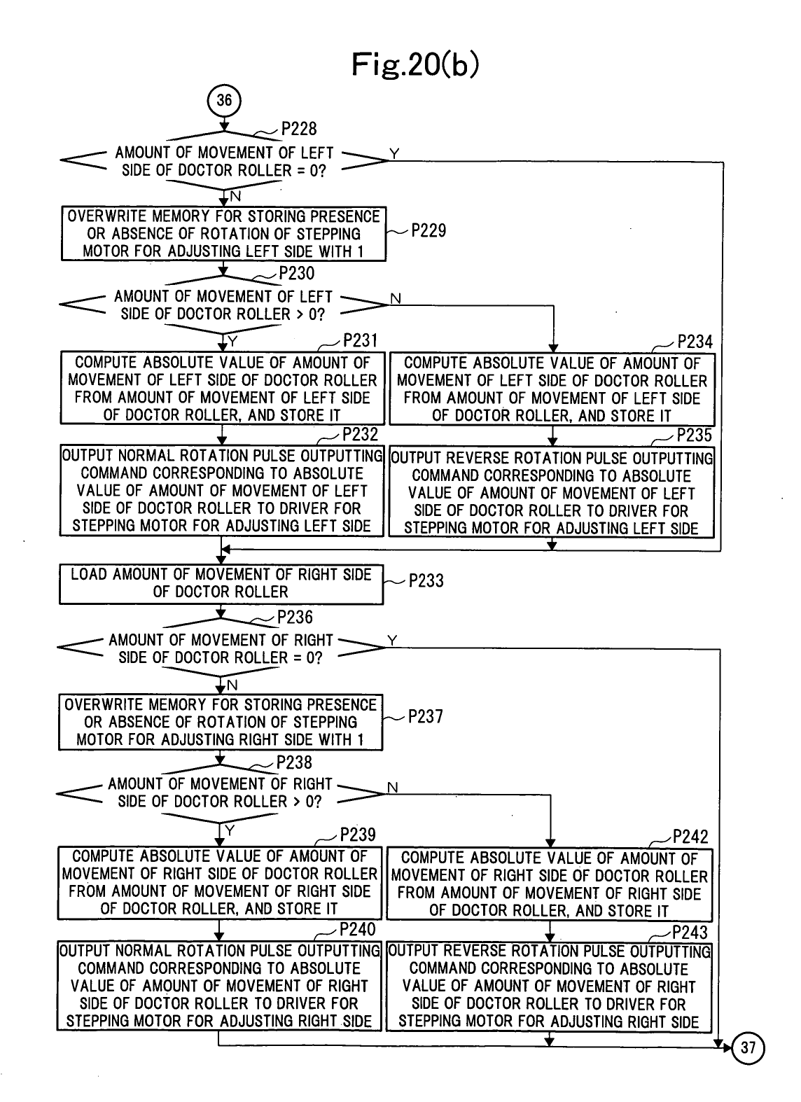

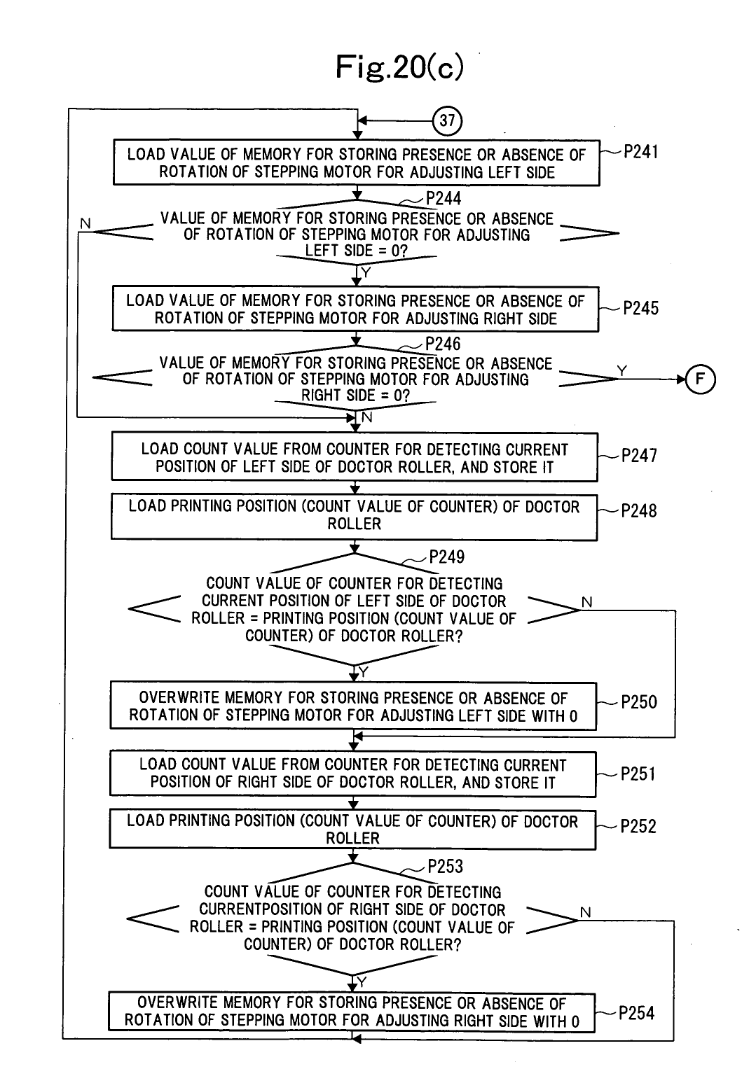

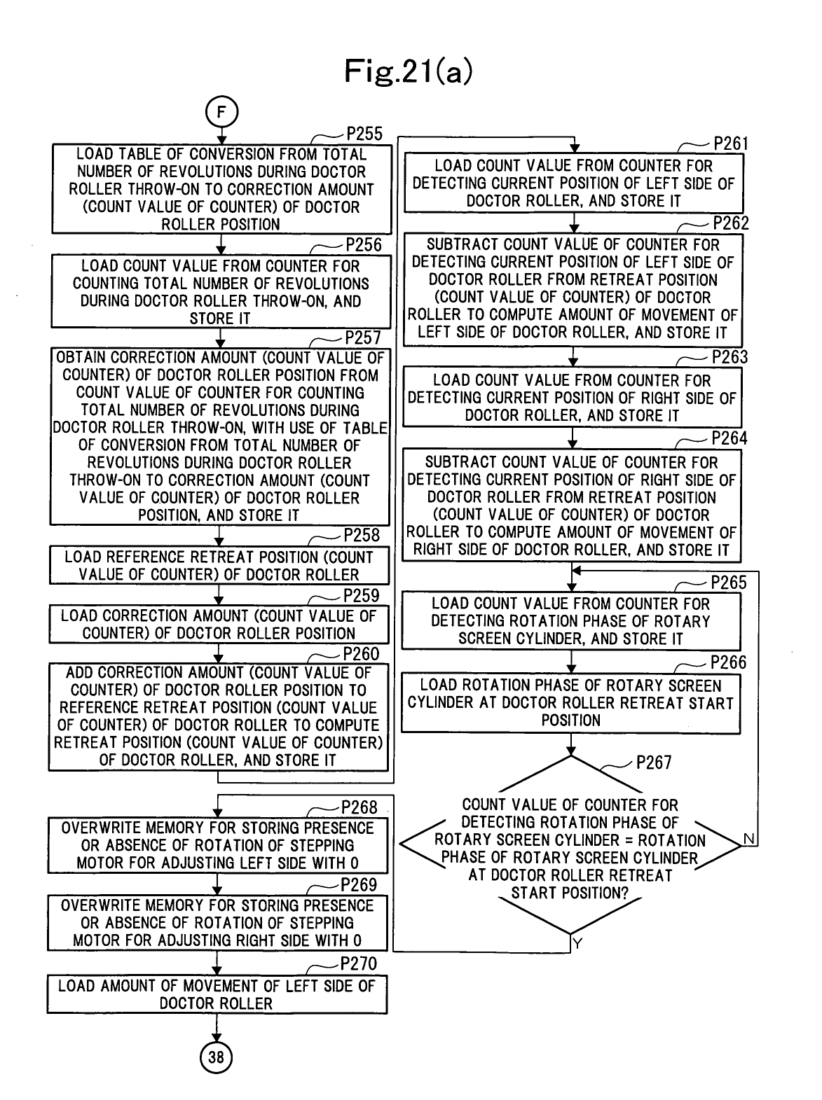

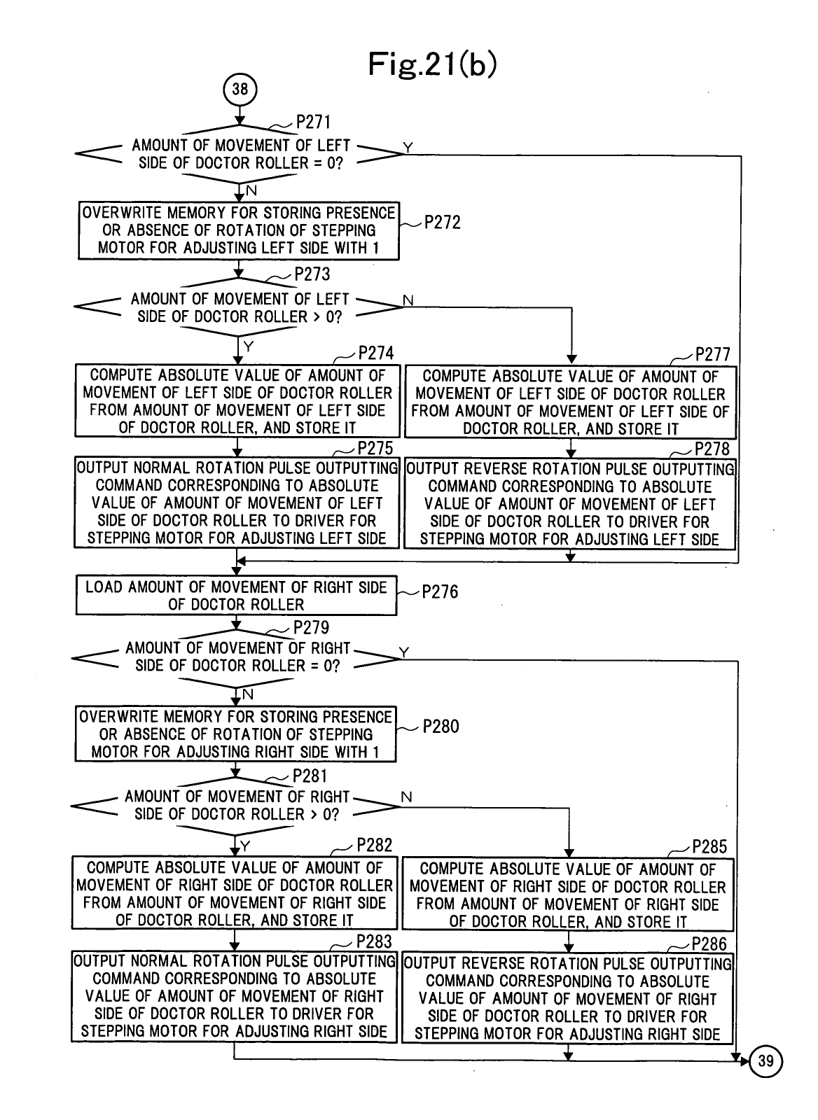

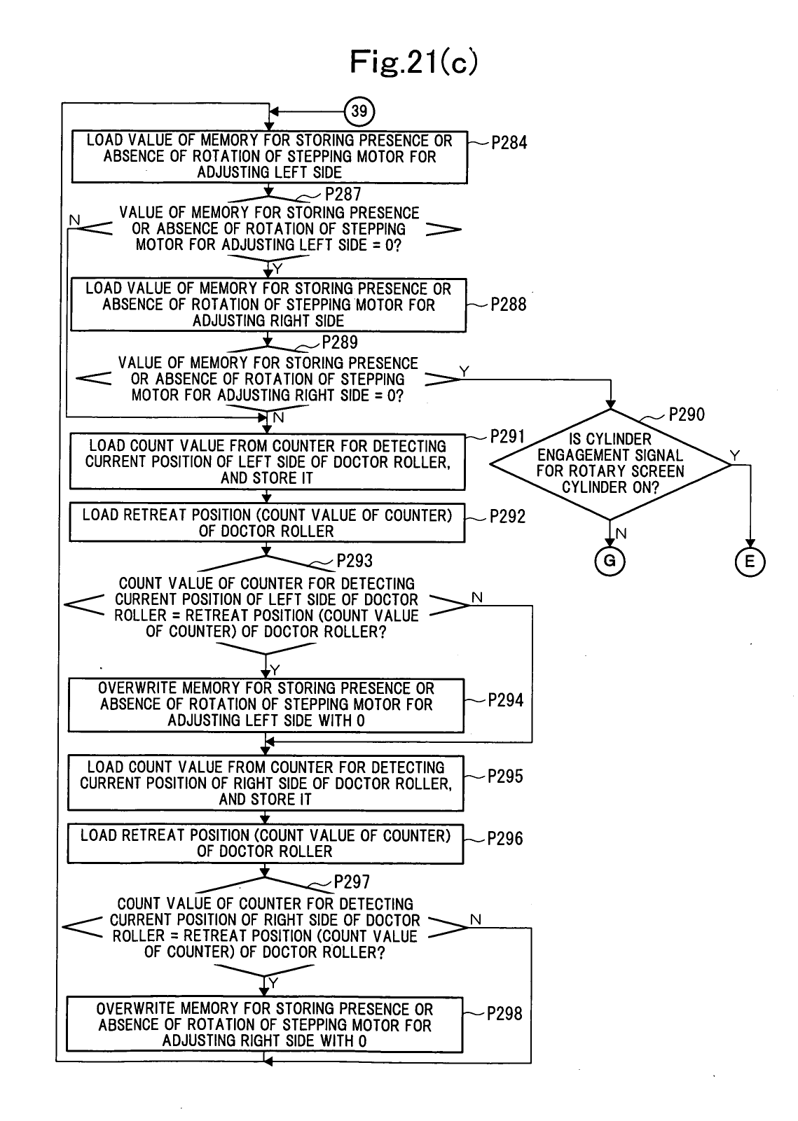

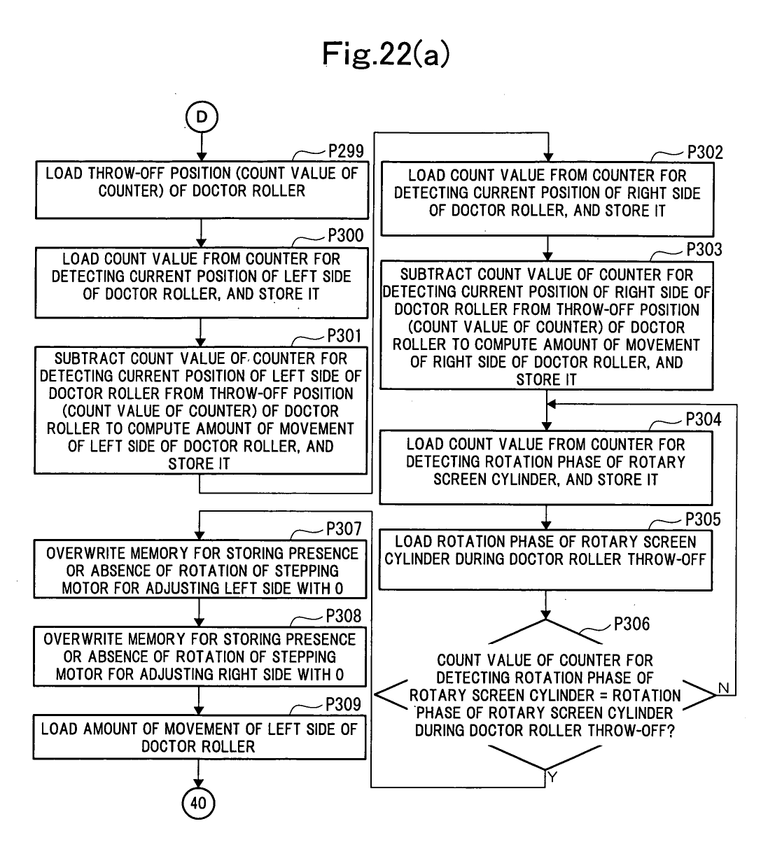

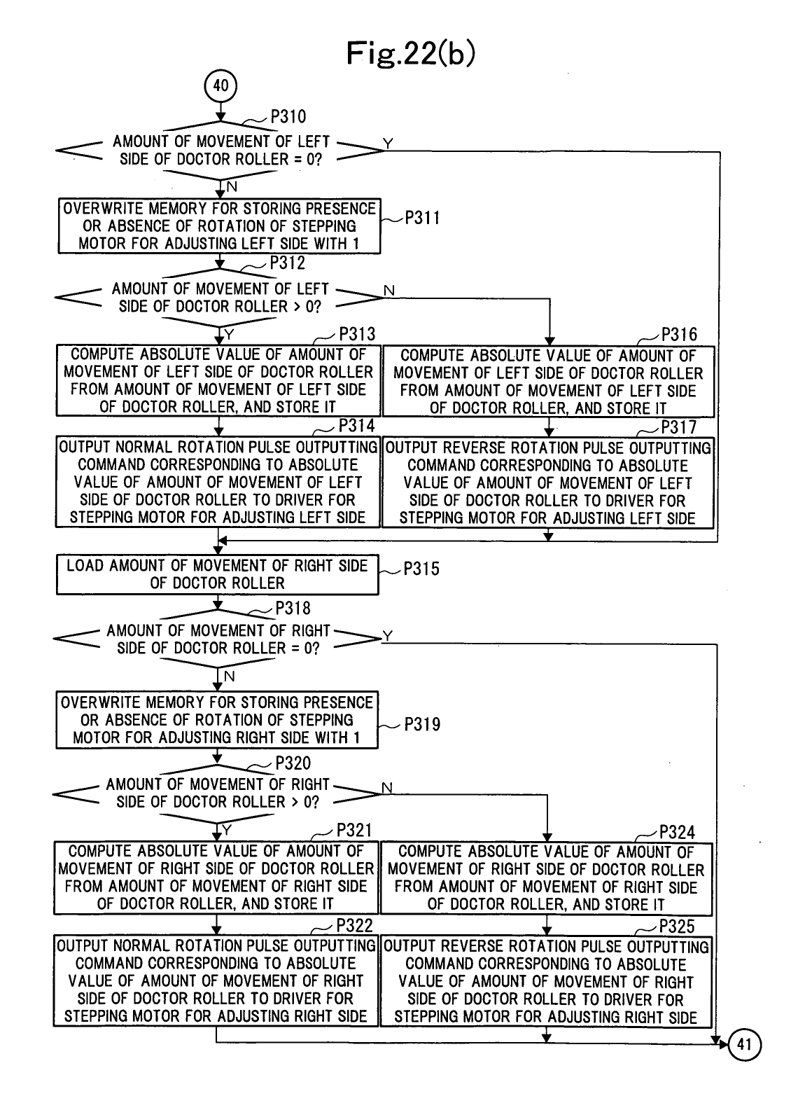

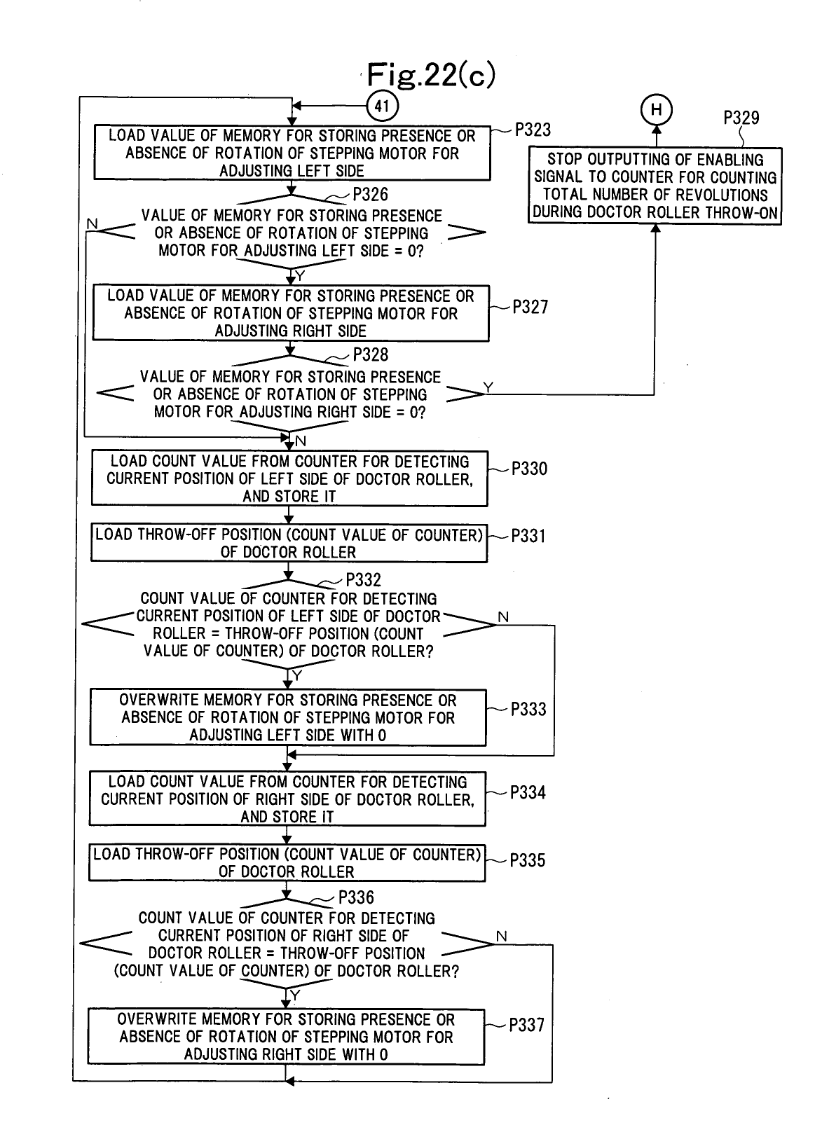

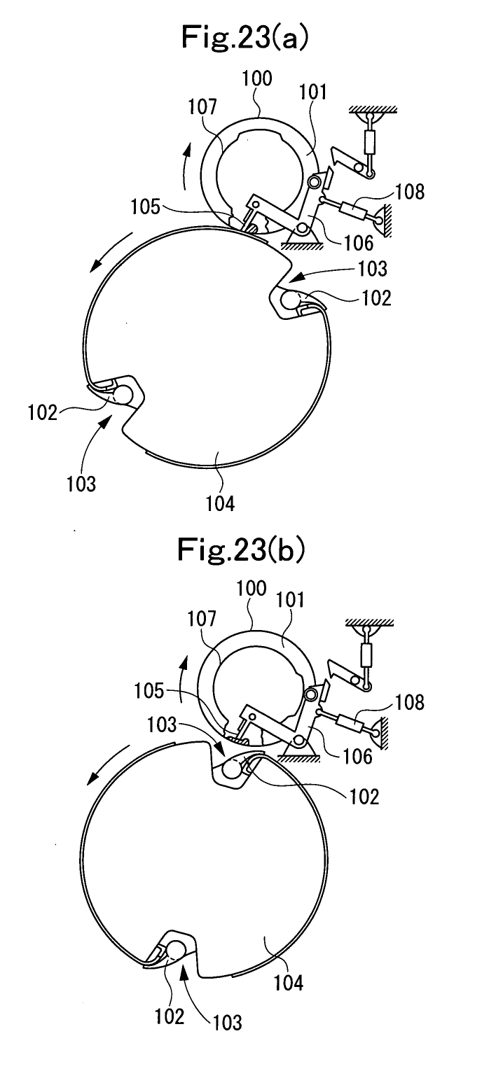

FIG. 13 is a schematic configurational sectional view of a rotary screen printing unit in a rotary screen printing press showing Embodiment 2 of the present invention. FIG. 14(a) is an explanation drawing of an ink supply system. FIG. 14(b) is an explanation drawing of an ink supply pipe. FIGS. 15(a) to 15(c) are control block diagrams of a doctor roller throw-on and throw-off control device. FIGS. 16(a) to 16(e) are motion flow charts of the doctor roller throw-on and throw-off control device. FIGS. 17(a) to 17(d) are motion flow charts of the doctor roller throw-on and throw-off control device. FIGS. 18(a) to 18(c) are motion flow charts of the doctor roller throw-on and throw-off control device. FIGS. 19(a) to 19(c) are motion flow charts of the doctor roller throw-on and throw-off control device. FIGS. 20(a) to 20(c) are motion flow charts of the doctor roller throw-on and throw-off control device. FIGS. 21(a) to 21(c) are motion flow charts of the doctor roller throw-on and throw-off control device. FIGS. 22(a) to 22(c) are motion flow charts of the doctor roller throw-on and throw-off control device.

The present Embodiment 2 is an embodiment in which a stepping motor 36Aa for adjusting a left side and a stepping motor 36Bb for adjusting a right side (see FIGS. 15(a) and 15(b)) are used instead of the motor 36A for adjusting the left side of the support shaft 27 and the motor 36B for adjusting the right side of the support shaft 27 in Embodiment 1, and a doctor roller 90 is used instead of the squeegee 38 as the liquid transfer member, as shown in FIG. 13.

The doctor roller 90 has a double structure composed of an inner roller 90a formed from a metal and an outer roller 90b formed from rubber. The doctor roller 90 is rotatably supported on a support shaft 27 via bearings 92 at left and right end members 91a and 91b fitted into the inner roller 90a.

As shown in FIGS. 14(a) and 14(b), an ink supply pipe 93 is horizontally installed within the screen printing forme 11c, and ink stored within an external tank 94 is supplied to the ink supply pipe 93 by a pump 95. The ink is dropped from the ink supply pipe 93 toward the inner peripheral surface of the screen printing forme 11c at multiple points in the cylinder axis direction of the rotary screen cylinder 11.

Thus, the outer peripheral surface of the doctor roller 90 makes a rolling contact with the inner peripheral surface of the screen printing forme 11c, whereby the ink supplied to the interior of the screen printing forme 11c through the ink supply pipe 93 is transferred to the printing surface of the material W to be printed via the holes of the screen printing forme 11c.

Other features are the same as those in Embodiment 1, so that duplicate explanations are omitted by reference to FIGS. 1 to 4(a), 4(b).

In the present Embodiment 2, the stepping motors 36Aa and 36Bb are drivingly controlled, independently of each other, by a doctor roller throw-on and throw-off control device (control means) 40B to be described later, whereby throw-on and throw-off of the doctor roller 90 with respect to the inner peripheral surface of the screen printing forme 11c, and the adjustment of the throw-on position of the doctor roller 90 are automatically carried out.

According to the present Embodiment 2, moreover, the doctor roller 90 is moved by the doctor roller throw-on and throw-off control device 40B to the position of retreat from the notch 13b of the impression cylinder 13 with a timing conformed to the preset length from the gripping end to the terminal end in the circumferential direction of the effective impression area (the length of the printing region in the transport direction of the material W to be printed).

Moreover, the above retreat position is controlled to a position where the outer peripheral surface of the doctor roller 90 makes contact with the inner peripheral surface of the screen printing forme 11c, and the pressing force of the doctor roller 90 acting on the inner peripheral surface of the screen printing forme 11c becomes smaller than the pressing force exerted during printing.

The doctor roller throw-on and throw-off control device 40B can also preset the pressing force of the doctor roller 90 at the retreat position, in accordance with the type of the screen printing forme 11c (material, forme thickness, open area rate, mesh size, etc.), the type of ink used in printing (viscosity, yield value, type of pigment, etc.), and the type of the doctor roller 90 (material, surface hardness, etc.). Concretely, relevant motions will be described by motion flow charts to be offered later.

The doctor roller throw-on and throw-off control device 40B of the present Embodiment 2 comprises CPU 41, RAM 42, ROM 43, and input/output devices 44 to 50 connected together by BUS (bus line), as shown in FIGS. 15(a) to 15(c). To the BUS (bus line), the following memories are connected: A memory M1 for storing the type of the material to be printed, a memory M2 for storing the thickness of the material to be printed, a memory M3 for storing the material for the screen printing forme, a memory M4 for storing the thickness of the screen printing forme, a memory M5a for storing the open area rate of the screen printing forme, a memory M6 for storing the mesh size of the screen printing forme, a memory M7 for storing the viscosity of ink, a memory M8 for storing the yield value of ink, a memory M9 for storing the type of the pigment of ink, a memory M10a for storing the material for the doctor roller, a memory M11a for storing the surface hardness of the doctor roller, a memory M75 for storing the length in the circumferential direction of the gripping margin, and a memory M76 for storing the length in the circumferential direction of the effective impression area.

To the BUS (bus line), the following memories are further connected: A memory M12a for storing a table of conversion from the type of the material to be printed to the throw-on position (count value of a counter) of the doctor roller, a memory M13a for storing the provisional reference throw-on position (count value of the counter) of the doctor roller, a memory M14a for storing a table of conversion from the thickness of the material to be printed to the throw-on position (count value of the counter) of the doctor roller, a memory M15a for storing the first correction value (count value of the counter) of the throw-on position of the doctor roller, a memory M16a for storing a table of conversion from the material for the screen printing forme to the throw-on position (count value of the counter) of the doctor roller, a memory M17a for storing the second correction value (count value of the counter) of the throw-on position of the doctor roller, a memory M18a for storing a table of conversion from the thickness of the screen printing forme to the throw-on position (count value of the counter) of the doctor roller, a memory M19a for storing the third correction value (count value of the counter) of the throw-on position of the doctor roller, a memory M73 for storing a table of conversion from the open area rate of the screen printing forme to the throw-on position (count value of the counter) of the doctor roller, and a memory M21a for storing the fourth correction value (count value of the counter) of the throw-on position of the doctor roller.

To the BUS (bus line), the following memories are further connected: A memory M22a for storing a table of conversion from the mesh size of the screen printing forme to the throw-on position (count value of the counter) of the doctor roller, a memory M23a for storing the fifth correction value (count value of the counter) of the throw-on position of the doctor roller, a memory M24a for storing a table of conversion from the viscosity of ink to the throw-on position (count value of the counter) of the doctor roller, a memory M25a for storing the sixth correction value (count value of the counter) of the throw-on position of the doctor roller, a memory M26a for storing a table of conversion from the yield value of ink to the throw-on position (count value of the counter) of the doctor roller, a memory M27a for storing the seventh correction value (count value of the counter) of the throw-on position of the doctor roller, a memory M28a for storing a table of conversion from the type of the pigment of ink to the throw-on position (count value of the counter) of the doctor roller, a memory M29a for storing the eighth correction value (count value of the counter) of the throw-on position of the doctor roller, a memory M30a for storing a table of conversion from the material for the doctor roller to the throw-on position (count value of the counter) of the doctor roller, a memory M31a for storing the ninth correction value (count value of the counter) of the throw-on position of the doctor roller, a memory M32a for storing a table of conversion from the surface hardness of the doctor roller to the throw-on position (count value of the counter) of the doctor roller, and a memory M33a for storing the tenth correction value (count value of the counter) of the throw-on position of the doctor roller.

To the BUS (bus line), the following memories are further connected: A memory M34a for storing the reference throw-on position (count value of the counter) of the doctor roller, a memory M35a for storing a table of conversion from the material for the screen printing forme to the retreat position (count value of the counter) of the doctor roller, a memory M36a for storing the provisional reference retreat position (count value of the counter) of the doctor roller, a memory M37a for storing a table of conversion from the thickness of the screen printing forme to the retreat position (count value of the counter) of the doctor roller, a memory M38a for storing the first correction value (count value of the counter) of the retreat position of the doctor roller, a memory M74 for storing a table of conversion from the open area rate of the screen printing forme to the retreat position (count value of the counter) of the doctor roller, a memory M40a for storing the second correction value (count value of the counter) of the retreat position of the doctor roller, a memory M41a for storing a table of conversion from the mesh size of the screen printing forme to the retreat position (count value of the counter) of the doctor roller, a memory M42a for storing the third correction value (count value of the counter) of the retreat position of the doctor roller, a memory M43a for storing a table of conversion from the viscosity of ink to the retreat position (count value of the counter) of the doctor roller, a memory M44a for storing the fourth correction value (count value of the counter) of the retreat position of the doctor roller, a memory M45a for storing a table of conversion from the yield value of ink to the retreat position (count value of the counter) of the doctor roller, and a memory M46a for storing the fifth correction value (count value of the counter) of the retreat position of the doctor roller.

To the BUS (bus line), the following memories are further connected: A memory M47a for storing a table of conversion from the type of the pigment of ink to the retreat position (count value of the counter) of the doctor roller, a memory M48a for storing the sixth correction value (count value of the counter) of the retreat position of the doctor roller, a memory M49a for storing a table of conversion from the material for the doctor roller to the retreat position (count value of the counter) of the doctor roller, a memory M50a for storing the seventh correction value (count value of the counter) of the retreat position of the doctor roller, a memory M51a for storing a table of conversion from the surface hardness of the doctor roller to the retreat position (count value of the counter) of the doctor roller, a memory M52a for storing the eighth correction value (count value of the counter) of the retreat position of the doctor roller, a memory M53a for storing the reference retreat position (count value of the counter) of the doctor roller, a memory M77 for storing the length from the gripping end to the terminal end in the circumferential direction of the effective impression area, a memory M78 for storing the rotation phase of the rotary screen cylinder at the position of doctor roller retreat start or the doctor roller retreat start position, and a memory M54a for storing the throw-off position (count value of the counter) of the doctor roller.

To the BUS (bus line), the following memories are further connected: A memory M62a for storing the count value of a counter for detecting the current position of the left side of the doctor roller, a memory M79 for storing the amount of movement of the left side of the doctor roller, a memory M63a for storing the count value of a counter for detecting the current position of the right side of the doctor roller, a memory M80 for storing the amount of movement of the right side of the doctor roller, a memory M68 for storing the count value of a counter for detecting the rotation phase of the rotary screen cylinder, a memory M58a for storing the rotation phase of the rotary screen cylinder during doctor roller throw-off, a memory M60a for storing the presence or absence of rotation of a stepping motor for adjusting the left side, a memory M61a for storing the presence or absence of rotation of a stepping motor for adjusting the right side, a memory M81 for storing the absolute value of the amount of movement of the left side of the doctor roller, a memory M82 for storing the absolute value of the amount of movement of the right side of the doctor roller, a memory M64a for storing a table of conversion from the total number of revolutions during doctor roller throw-on to the correction amount (count value of the counter) of the doctor roller position, a memory M65a for storing the count value of a counter for counting the total number of revolutions during doctor roller throw-on, a memory M66a for storing the correction amount (count value of the counter) of the doctor roller position, a memory M67a for storing the retreat position (count value of the counter) of the doctor roller, a memory M69a for storing the rotation phase of the rotary screen cylinder during doctor roller throw-on, a memory M70a for storing the printing position (count value of the counter) of the doctor roller, and a memory M57 for storing the rotation phase of the rotary screen cylinder at the position of the rear end of the notch of the impression cylinder.

To the input/output device 44, the following are connected: A doctor roller throw-on and throw-off automatic control switch 52a, an input device 53 such as a keyboard, a display device 54 such as CRT or a display, and an output device 55 such as a printer or a floppy disk (registered trademark) drive.

To the input/output device 45, the following are connected: A setting instrument 56 for the type of the material to be printed, a setting instrument 57 for the thickness of the material to be printed, a setting instrument 58 for the material for the screen printing forme, a setting instrument 59 for the thickness of the screen printing forme, a setting instrument 80 for the open area rate of the screen printing forme, a setting instrument 60 for the mesh size of the screen printing forme, a setting instrument 61 for the viscosity of ink, a setting instrument 62 for the yield value of ink, a setting instrument 63 for the type of the pigment of ink, a setting instrument 64a for the material for the doctor roller, a setting instrument 65a for the surface hardness of the doctor roller, a setting instrument (setting means) 81 for the length in the circumferential direction of the gripping margin, and a setting instrument (setting means) 82 for the length in the circumferential direction of the effective impression area.

To the input/output device 46, the stepping motor 36Aa for adjusting the left side is connected via a driver 66a for the stepping motor for adjusting the left side, and a counter 68a for detecting the current position of the left side of the doctor roller is also connected.

To the input/output device 47, the stepping motor 36Bb for adjusting the right side is connected via a driver 70a for the stepping motor for adjusting the right side, and a counter 72a for detecting the current position of the right side of the doctor roller is also connected.

To the input/output device 48, a rotary encoder 75 for detecting the rotation phase of the rotary screen cylinder is connected via a counter 74 for detecting the rotation phase of the rotary screen cylinder. The rotary encoder 75 for detecting the rotation phase of the rotary screen cylinder is provided on a rotating part of the rotary screen printing press rotating in synchronism with the rotary screen cylinder in such a manner as to generate a zero pulse in the reference rotation phase of the rotary screen cylinder. Thus, the counter 74 for detecting the rotation phase of the rotary screen cylinder is reset in the reference rotation phase of the rotary screen cylinder each time the rotary screen cylinder makes one rotation. Then, the counter 74 for detecting the rotation phase of the rotary screen cylinder counts clock pulses generated in accordance with the rotation of the rotary screen cylinder, producing a count value conformed to the rotation phase of the rotary screen cylinder.

To the input/output device 49, a sensor 77 for detecting one rotation of the rotary screen cylinder is connected via a counter 76a for counting the total number of revolutions during doctor roller throw-on. The sensor 77 for detecting one rotation of the rotary screen cylinder is provided on a rotating part of the rotary screen printing press so as to produce one pulse each time the rotary screen cylinder makes one rotation. Thus, the counter 76a for counting the total number of revolutions during doctor roller throw-on is adapted to count the number of revolutions of the rotary screen cylinder in an operating state.

To the input/output device 50, a cylinder engagement circuit 78 for the rotary screen cylinder is connected.

The control actions or motions of the doctor roller throw-on and throw-off control device 40B configured as above will be described in detail based on the motion flow charts of FIGS. 16(a) to 16(e), FIGS. 17(a) to 17(d), FIGS. 18(a) to 18(c), FIGS. 19(a) to 19(c), FIGS. 20(a) to 20(c), FIGS. 21(a) to 21(c), and FIGS. 22(a) to 22(c).

In Step P1, it is determined whether there is an input to the setting instrument 56 for the type of the material to be printed. If the answer is Y (yes), the type of the material W to be printed is loaded from the setting instrument 56 for the type of the material to be printed, and stored into the memory M1, in Step P2, and the program proceeds to Step P3. If the answer is N (no), the program directly shifts to Step P3.

Then, in Step P3, it is determined whether there is an input to the setting instrument 57 for the thickness of the material to be printed. If the answer is Y, the thickness of the material to be printed is loaded from the setting instrument 57 for the thickness of the material to be printed, and stored into the memory M2, in Step P4. Then, the program proceeds to Step P5. If the answer is N, the program directly shifts to Step P5.

Then, in Step P5, it is determined whether there is an input to the setting instrument 58 for the material for the screen printing forme. If the answer is Y, the material for the screen printing forme 11c is loaded from the setting instrument 58 for the material for the screen printing forme, and stored into the memory M3, in Step P6. Then, the program proceeds to Step P7. If the answer is N, the program directly shifts to Step P7.

Then, in Step P7, it is determined whether there is an input to the setting instrument 59 for the thickness of the screen printing forme. If the answer is Y, the thickness of the screen printing forme is loaded from the setting instrument 59 for the thickness of the screen printing forme, and stored into the memory M4, in Step P8. Then, the program proceeds to Step P9. If the answer is N, the program directly shifts to Step P9.

Then, in Step P9, it is determined whether there is an input to the setting instrument 80 for the open area rate of the screen printing forme. If the answer is Y, the open area rate of the screen printing forme is loaded from the setting instrument 80 for the open area rate of the screen printing forme, and stored into the memory M5a, in Step P10. Then, the program proceeds to Step P11. If the answer is N, the program directly shifts to Step P11.

Then, in Step P11, it is determined whether there is an input to the setting instrument 60 for the mesh size of the screen printing forme. If the answer is Y, the mesh size of the screen printing forme 11c is loaded from the setting instrument 60 for the mesh size of the screen printing forme, and stored into the memory M6, in Step P12. Then, the program proceeds to Step P13. If the answer is N, the program directly shifts to Step P13.

Then, in Step P13, it is determined whether there is an input to the setting instrument 61 for the viscosity of ink. If the answer is Y, the viscosity of ink is loaded from the setting instrument 61 for the viscosity of ink, and stored into the memory M7, in Step P14. Then, the program proceeds to Step P15. If the answer is N, the program directly shifts to Step P15.

Then, in Step P15, it is determined whether there is an input to the setting instrument 62 for the yield value of ink. If the answer is Y, the yield value of ink is loaded from the setting instrument 62 for the yield value of ink, and stored into the memory M8, in Step P16. Then, the program proceeds to Step P17. If the answer is N, the program directly shifts to Step P17.

Then, in Step P17, it is determined whether there is an input to the setting instrument 63 for the type of the pigment of ink. If the answer is Y, the type of the pigment of ink is loaded from the setting instrument 63 for the type of the pigment of ink, and stored into the memory M9, in Step P18. Then, the program proceeds to Step P19. If the answer is N, the program directly shifts to Step P19.

Then, in Step P19, it is determined whether there is an input to the setting instrument 64a for the material for the doctor roller. If the answer is Y, the material for the doctor roller 90 is loaded from the setting instrument 64a for the material for the doctor roller, and stored into the memory M10a, in Step P20. Then, the program proceeds to Step P21. If the answer is N, the program directly shifts to Step P21.

Then, in Step P21, it is determined whether there is an input to the setting instrument 65a for the surface hardness of the doctor roller. If the answer is Y, the surface hardness of the doctor roller is loaded from the setting instrument 65a for the surface hardness of the doctor roller, and stored into the memory M11a, in Step P22. Then, the program proceeds to Step P23. If the answer is N, the program directly shifts to Step P23.

Then, in Step P23, it is determined whether there is an input to the setting instrument 81 for the length in the circumferential direction of the gripping margin. If the answer is Y, the length in the circumferential direction of the gripping margin is loaded from the setting instrument 81 for the length in the circumferential direction of the gripping margin, and stored into the memory M75, in Step P24. Then, the program proceeds to Step P25. If the answer is N, the program directly shifts to Step P25.

Then, in Step P25, it is determined whether there is an input to the setting instrument (setting means) 82 for the length in the circumferential direction of the effective impression area. If the answer is Y, the length in the circumferential direction of the effective impression area is loaded from the setting instrument 82 for the length in the circumferential direction of the effective impression area, and stored into the memory M76, in Step P26. Then, the program proceeds to Step P27. If the answer is N, the program directly shifts to Step P27.

Then, in Step P27, it is determined whether the doctor roller throw-on and throw-off automatic control switch 52a is ON. If the answer is Y, the table of conversion from the type of the material to be printed to the throw-on position (count value of the counter) of the doctor roller is loaded from the memory M12a in Step P28. If the answer is N, the program returns to Step P1.

Then, in Step P29, the type of the material W to be printed is loaded from the memory M1. Then, in Step P30, the provisional reference throw-on position (count value of the counter) of the doctor roller is obtained from the type of the material W to be printed, with the use of the table of conversion from the type of the material to be printed to the throw-on position (count value of the counter) of the doctor roller, and is stored into the memory M13a.

Then, in Step P31, the type of the material W to be printed is loaded from the memory M1. Then, in Step P32, the table of conversion from the thickness of the material to be printed to the throw-on position (count value of the counter) of the doctor roller, which is commensurate with the type of the material to be printed, is loaded from the memory M14a.

Then, in Step P33, the thickness of the material to be printed is loaded from the memory M2. Then, in Step P34, the first correction value (count value of the counter) of the throw-on position of the doctor roller is obtained from the thickness of the material to be printed, with the use of the table of conversion from the thickness of the material to be printed to the throw-on position (count value of the counter) of the doctor roller, which is commensurate with the type of the material to be printed, and this correction value is stored into the memory M15a.

Then, in Step P35, the table of conversion from the material for the screen printing forme to the throw-on position (count value of the counter) of the doctor roller is loaded from the memory M16a. Then, in Step P36, the material for the screen printing forme 11c is loaded from the memory M3. Then, in Step P37, the second correction value (count value of the counter) of the throw-on position of the doctor roller is obtained from the material for the screen printing forme 11c, with the use of the table of conversion from the material for the screen printing forme to the throw-on position (count value of the counter) of the doctor roller, and this correction value is stored into the memory M17a.

Then, in Step P38, the material for the screen printing forme 11c is loaded from the memory M3. Then, in Step P39, the table of conversion from the thickness of the screen printing forme to the throw-on position (count value of the counter) of the doctor roller, which is commensurate with the material for the screen printing forme, is loaded from the memory M18a.

Then, in Step P40, the thickness of the screen printing forme is loaded from the memory M4. Then, in Step P41, the third correction value (count value of the counter) of the throw-on position of the doctor roller is obtained from the thickness of the screen printing forme, with the use of the table of conversion from the thickness of the screen printing forme to the throw-on position (count value of the counter) of the doctor roller, which is commensurate with the material for the screen printing forme, and this correction value is stored into the memory M19a.

Then, in Step P42, the material for the screen printing forme 11c is loaded from the memory M3. Then, in Step P43, the thickness of the screen printing forme is loaded from the memory M4. Then, in Step P44, the table of conversion from the open area rate of the screen printing forme to the throw-on position (count value of the counter) of the doctor roller, which is commensurate with the material for the screen printing forme and the thickness of the screen printing forme, is loaded from the memory M73.

Then, in Step P45, the open area rate of the screen printing forme is loaded from the memory M5a. Then, in Step P46, the fourth correction value (count value of the counter) of the throw-on position of the doctor roller is obtained from the open area rate of the screen printing forme, with the use of the table of conversion from the open area rate of the screen printing forme to the throw-on position (count value of the counter) of the doctor roller, which is commensurate with the material for the screen printing forme and the thickness of the screen printing forme, and this correction value is stored into the memory M21a.

Then, in Step P47, the material for the screen printing forme 11c is loaded from the memory M3. Then, in Step P48, the thickness of the screen printing forme is loaded from the memory M4. Then, in Step P49, the table of conversion from the mesh size of the screen printing forme to the throw-on position (count value of the counter) of the doctor roller, which is commensurate with the material for the screen printing forme and the thickness of the screen printing forme, is loaded from the memory M22a.

Then, in Step P50, the mesh size of the screen printing forme is loaded from the memory M6. Then, in Step P51, the fifth correction value (count value of the counter) of the throw-on position of the doctor roller is obtained from the mesh size of the screen printing forme, with the use of the table of conversion from the mesh size of the screen printing forme to the throw-on position (count value of the counter) of the doctor roller, which is commensurate with the material for the screen printing forme and the thickness of the screen printing forme, and this correction value is stored into the memory M23a.

Then, in Step P52, the table of conversion from the viscosity of ink to the throw-on position (count value of the counter) of the doctor roller is loaded from the memory M24a. Then, in Step P53, the viscosity of ink is loaded from the memory M7. Then, in Step P54, the sixth correction value (count value of the counter) of the throw-on position of the doctor roller is obtained from the viscosity of ink with the use of the table of conversion from the viscosity of ink to the throw-on position (count value of the counter) of the doctor roller, and this correction value is stored into the memory M25a.

Then, in Step P55, the table of conversion from the yield value of ink to the throw-on position (count value of the counter) of the doctor roller is loaded from the memory M26a. Then, in Step P56, the yield value of ink is loaded from the memory M8. Then, in Step P57, the seventh correction value (count value of the counter) of the throw-on position of the doctor roller is obtained from the yield value of ink with the use of the table of conversion from the yield value of ink to the throw-on position (count value of the counter) of the doctor roller, and this correction value is stored into the memory M27a.

Then, in Step P58, the table of conversion from the type of the pigment of ink to the throw-on position (count value of the counter) of the doctor roller is loaded from the memory M28a. Then, in Step P59, the type of the pigment of ink is loaded from the memory M9. Then, in Step P60, the eighth correction value (count value of the counter) of the throw-on position of the doctor roller is obtained from the type of the pigment of ink with the use of the table of conversion from the type of the pigment of ink to the throw-on position (count value of the counter) of the doctor roller, and this correction value is stored into the memory M29a.

Then, in Step P61, the table of conversion from the material for the doctor roller to the throw-on position (count value of the counter) of the doctor roller is loaded from the memory M30a. Then, in Step P62, the material for the doctor roller 90 is loaded from the memory M10a. Then, in Step P63, the ninth correction value (count value of the counter) of the throw-on position of the doctor roller is obtained from the material for the doctor roller 90 with the use of the table of conversion from the material for the doctor roller to the throw-on position (count value of the counter) of the doctor roller, and this correction value is stored into the memory M31a.

Then, in Step P64, the material for the doctor roller 90 is loaded from the memory M10a. Then, in Step P65, the table of conversion from the surface hardness of the doctor roller to the throw-on position (count value of the counter) of the doctor roller, which is commensurate with the material for the doctor roller, is loaded from the memory M32a.

Then, in Step P66, the surface hardness of the doctor roller is loaded from the memory M11a. Then, in Step P67, the tenth correction value (count value of the counter) of the throw-on position of the doctor roller is obtained from the surface hardness of the doctor roller with the use of the table of conversion from the surface hardness of the doctor roller to the throw-on position (count value of the counter) of the doctor roller, which is commensurate with the material for the doctor roller, and this correction value is stored into the memory M33a.

Then, in Step P68, the provisional reference throw-on position (count value of the counter) of the doctor roller is loaded from the memory M13a, whereafter, in Step P69, the first correction value (count value of the counter) of the throw-on position of the doctor roller is loaded from the memory M15a. Then, in Step P70, the second correction value (count value of the counter) of the throw-on position of the doctor roller is loaded from the memory M17a.

Then, in Step P71, the third correction value (count value of the counter) of the throw-on position of the doctor roller is loaded from the memory M19a, whereafter, in Step P72, the fourth correction value (count value of the counter) of the throw-on position of the doctor roller is loaded from the memory M21a. Then, in Step P73, the fifth correction value (count value of the counter) of the throw-on position of the doctor roller is loaded from the memory M23a.

Then, in Step P74, the sixth correction value (count value of the counter) of the throw-on position of the doctor roller is loaded from the memory M25a, whereafter, in Step P75, the seventh correction value (count value of the counter) of the throw-on position of the doctor roller is loaded from the memory M27a. Then, in Step P76, the eighth correction value (count value of the counter) of the throw-on position of the doctor roller is loaded from the memory M29a.

Then, in Step P77, the ninth correction value (count value of the counter) of the throw-on position of the doctor roller is loaded from the memory M31a, whereafter, in Step P78, the tenth correction value (count value of the counter) of the throw-on position of the doctor roller is loaded from the memory M33a.

Then, in Step P79, the first correction value (count value of the counter) of the throw-on position of the doctor roller, the second correction value (count value of the counter) of the throw-on position of the doctor roller, the third correction value (count value of the counter) of the throw-on position of the doctor roller, the fourth correction value (count value of the counter) of the throw-on position of the doctor roller, the fifth correction value (count value of the counter) of the throw-on position of the doctor roller, the sixth correction value (count value of the counter) of the throw-on position of the doctor roller, the seventh correction value (count value of the counter) of the throw-on position of the doctor roller, the eighth correction value (count value of the counter) of the throw-on position of the doctor roller, the ninth correction value (count value of the counter) of the throw-on position of the doctor roller, and the tenth correction value (count value of the counter) of the throw-on position of the doctor roller are added to the provisional reference throw-on position (count value of the counter) of the doctor roller to compute the reference throw-on position (count value of the counter) of the doctor roller, and this reference throw-on position (count value of the counter) of the doctor roller is stored into the memory M34a.

In accordance with the above-described motion flow, the throw-on position of the doctor roller 90 during printing is preset, based on the type of the material W to be printed (i.e., difference in the material, e.g., paper, cloth, film or corrugated board), in conformity with the thickness of the material to be printed, the material for the screen printing forme 11c, the thickness of the screen printing forme, the open area rate of the screen printing forme, the mesh size of the screen printing forme 11c, the viscosity of ink, the yield value of ink, the type of the pigment of ink, the material for the doctor roller, and the surface hardness of the doctor roller.

Then, in Step P80, the table of conversion from the material for the screen printing forme to the retreat position (count value of the counter) of the doctor roller is loaded from the memory M35a. Then, in Step P81, the material for the screen printing forme 11c is loaded from the memory M3. Then, in Step P82, the provisional reference retreat position (count value of the counter) of the doctor roller is obtained from the material for the screen printing forme 11c with the use of the table of conversion from the material for the screen printing forme to the retreat position (count value of the counter) of the doctor roller, and is stored into the memory M36a.

Then, in Step P83, the material for the screen printing forme 11c is loaded from the memory M3. Then, in Step P84, the table of conversion from the thickness of the screen printing forme to the retreat position (count value of the counter) of the doctor roller, which is commensurate with the material for the screen printing forme, is loaded from the memory M37a.

Then, in Step P85, the thickness of the screen printing forme is loaded from the memory M4. Then, in Step P86, the first correction value (count value of the counter) of the retreat position of the doctor roller is obtained from the thickness of the screen printing forme with the use of the table of conversion from the thickness of the screen printing forme to the retreat position (count value of the counter) of the doctor roller, which is commensurate with the material for the screen printing forme, and this correction value is stored into the memory M38a.

Then, in Step P87, the material for the screen printing forme 11c is loaded from the memory M3, whereafter, in Step P88, the thickness of the screen printing forme is loaded from the memory M4. Then, in Step P89, the table of conversion from the open area rate of the screen printing forme to the retreat position (count value of the counter) of the doctor roller, which is commensurate with the material for the screen printing forme and the thickness of the screen printing forme, is loaded from the memory M74.

Then, in Step P90, the open area rate of the screen printing forme is loaded from the memory M5a. Then, in Step P91, the second correction value (count value of the counter) of the retreat position of the doctor roller is obtained from the open area rate of the screen printing forme with the use of the table of conversion from the open area rate of the screen printing forme to the retreat position (count value of the counter) of the doctor roller, which is commensurate with the material for the screen printing forme and the thickness of the screen printing forme, and this correction value is stored into the memory M40a.

Then, in Step P92, the material for the screen printing forme is loaded from the memory M3. Then, in Step P93, the thickness of the screen printing forme is loaded from the memory M4. Then, in Step P94, the table of conversion from the mesh size of the screen printing forme to the retreat position (count value of the counter) of the doctor roller, which is commensurate with the material for the screen printing forme and the thickness of the screen printing forme, is loaded from the memory M41a.

Then, in Step P95, the mesh size of the screen printing forme 11c is loaded from the memory M6. Then, in Step P96, the third correction value (count value of the counter) of the retreat position of the doctor roller is obtained from the mesh size of the screen printing forme 11c with the use of the table of conversion from the mesh size of the screen printing forme to the retreat position (count value of the counter) of the doctor roller, which is commensurate with the material for the screen printing forme and the thickness of the screen printing forme, and this correction value is stored into the memory M42a.

Then, in Step P97, the table of conversion from the viscosity of ink to the retreat position (count value of the counter) of the doctor roller is loaded from the memory M43a. Then, in Step P98, the viscosity of ink is loaded from the memory M7. Then, in Step P99, the fourth correction value (count value of the counter) of the retreat position of the doctor roller is obtained from the viscosity of ink with the use of the table of conversion from the viscosity of ink to the retreat position (count value of the counter) of the doctor roller, and this correction value is stored into the memory M44a.

Then, in Step P100, the table of conversion from the yield value of ink to the retreat position (count value of the counter) of the doctor roller is loaded from the memory M45a. Then, in Step P101, the yield value of ink is loaded from the memory M8. Then, in Step P102, the fifth correction value (count value of the counter) of the retreat position of the doctor roller is obtained from the yield value of ink with the use of the table of conversion from the yield value of ink to the retreat position (count value of the counter) of the doctor roller, and this correction value is stored into the memory M46a.

Then, in Step P103, the table of conversion from the type of the pigment of ink to the retreat position (count value of the counter) of the doctor roller is loaded from the memory M47a. Then, in Step P104, the type of the pigment of ink is loaded from the memory M9. Then, in Step P105, the sixth correction value (count value of the counter) of the retreat position of the doctor roller is obtained from the type of the pigment of ink with the use of the table of conversion from the type of the pigment of ink to the retreat position (count value of the counter) of the doctor roller, and this correction value is stored into the memory M48a.

Then, in Step P106, the table of conversion from the material for the doctor roller to the retreat position (count value of the counter) of the doctor roller is loaded from the memory M49a. Then, in Step P107, the material for the doctor roller is loaded from the memory M10a. Then, in Step P108, the seventh correction value (count value of the counter) of the retreat position of the doctor roller is obtained from the material for the doctor roller with the use of the table of conversion from the material for the doctor roller to the retreat position (count value of the counter) of the doctor roller, and this correction value is stored into the memory M50a.

Then, in Step P109, the material for the doctor roller is loaded from the memory M10a. Then, in Step P110, the table of conversion from the surface hardness of the doctor roller to the retreat position (count value of the counter) of the doctor roller, which is commensurate with the material for the doctor roller, is loaded from the memory M51a.

Then, in Step P111, the surface hardness of the doctor roller is loaded from the memory M11a. Then, in Step P112, the eighth correction value (count value of the counter) of the retreat position of the doctor roller is obtained from the surface hardness of the doctor roller with the use of the table of conversion from the surface hardness of the doctor roller to the retreat position (count value of the counter) of the doctor roller, which is commensurate with the material for the doctor roller, and this correction value is stored into the memory M52a.

Then, in Step P113, the provisional reference retreat position (count value of the counter) of the doctor roller is loaded from the memory M36a, whereafter, in Step P114, the first correction value (count value of the counter) of the retreat position of the doctor roller is loaded from the memory M38a. Then, in Step P115, the second correction value (count value of the counter) of the retreat position of the doctor roller is loaded from the memory M40a.

Then, in Step P116, the third correction value (count value of the counter) of the retreat position of the doctor roller is loaded from the memory M42a, whereafter, in Step P117, the fourth correction value (count value of the counter) of the retreat position of the doctor roller is loaded from the memory M44a. Then, in Step P118, the fifth correction value (count value of the counter) of the retreat position of the doctor roller is loaded from the memory M46a.

Then, in Step P119, the sixth correction value (count value of the counter) of the retreat position of the doctor roller is loaded from the memory M48a, whereafter, in Step P120, the seventh correction value (count value of the counter) of the retreat position of the doctor roller is loaded from the memory M50a. Then, in Step P121, the eighth correction value (count value of the counter) of the retreat position of the doctor roller is loaded from the memory M52a.

Then, in Step P122, the first correction value (count value of the counter) of the retreat position of the doctor roller, the second correction value (count value of the counter) of the retreat position of the doctor roller, the third correction value (count value of the counter) of the retreat position of the doctor roller, the fourth correction value (count value of the counter) of the retreat position of the doctor roller, the fifth correction value (count value of the counter) of the retreat position of the doctor roller, the sixth correction value (count value of the counter) of the retreat position of the doctor roller, the seventh correction value (count value of the counter) of the retreat position of the doctor roller, and the eighth correction value (count value of the counter) of the retreat position of the doctor roller are added to the provisional reference retreat position (count value of the counter) of the doctor roller to compute the reference retreat position (count value of the counter) of the doctor roller. This reference retreat position (count value of the counter) of the doctor roller is stored into the memory M53a. The reference retreat position of the doctor roller obtained is a position closer to the throw-off position of the doctor roller than to the reference throw-on position of the doctor roller obtained in Step P79, in other words, a position at which the doctor roller 90 does not leave the inner peripheral surface of the screen printing forme 11c, and its pressing force decreases.

Then, the length in the circumferential direction of the gripping margin is loaded from the memory M75 in Step P123. Then, the length in the circumferential direction of the effective impression area is loaded from the memory M76 in Step P124.

Then, in Step P125, the length in the circumferential direction of the effective impression area is added to the length in the circumferential direction of the gripping margin to compute the length from the gripping end to the terminal end in the circumferential direction of the effective impression area. The computed length is stored into the memory M77. Then, in Step P126, the rotation phase of the rotary screen cylinder at the doctor roller retreat start position is computed from the length from the gripping end to the terminal end in the circumferential direction of the effective impression area, and stored into the memory M78. The obtained rotation phase of the rotary screen cylinder at the doctor roller retreat start position is the rotation phase of the rotary screen cylinder at a time when the doctor roller opposes a position between the rear end in the transport direction of the material to be printed and the rear end of the printing region where the picture pattern is printed, in other words, a position slightly spaced from the rear end in the transport direction of the material to be printed toward the front end in the transport direction of the material to be printed.

In accordance with the above-described motion flow, the retreat position of the doctor roller 90 when opposing the notch 13b of the impression cylinder 13 (in other words, the pressing force acting on the inner peripheral surface of the screen printing forme 11c) is preset, based on the material for the screen printing forme 11c, in conformity with the thickness of the screen printing forme, the open area rate of the screen printing forme, the mesh size of the screen printing forme 11c, the viscosity of ink, the yield value of ink, the type of the pigment of ink, the material for the doctor roller, and the surface hardness of the doctor roller.

Then, in Step P127, it is determined whether the doctor roller throw-on and throw-off automatic control switch 52a is OFF. If the answer is Y (yes), the program shifts to Step P299 to be described later. If the answer is N (no), it is determined, in Step P128, whether a cylinder engagement signal from the cylinder engagement circuit 78 for the rotary screen cylinder is ON.

If the answer is Y in the above Step P128, the program shifts to Step P168 to be described later. If the answer is N, the throw-off position (count value of the counter) of the doctor roller is loaded from the memory M54a in Step P129.

Then, in Step P130, the count value is loaded from the counter 68a for detecting the current position of the left side of the doctor roller, and stored into the memory M62a. Then follows Step P131 in which the count value of the counter for detecting the current position of the left side of the doctor roller is subtracted from the throw-off position (count value of the counter) of the doctor roller to compute the amount of movement of the left side of the doctor roller, which is stored into the memory M79.

Then, in Step P132, the count value is loaded from the counter 72a for detecting the current position of the right side of the doctor roller, and stored into the memory M63a. Then follows Step P133 in which the count value of the counter for detecting the current position of the right side of the doctor roller is subtracted from the throw-off position (count value of the counter) of the doctor roller to compute the amount of movement of the right side of the doctor roller, which is stored into the memory M80.

Then, in Step P134, the count value is loaded from the counter 74 for detecting the rotation phase of the rotary screen cylinder, and stored into the memory M68. Then, in Step P135, the rotation phase of the rotary screen cylinder during doctor roller throw-off is loaded from the memory M58a.

Then, in Step P136, it is determined whether the count value of the counter for detecting the rotation phase of the rotary screen cylinder is equal to the rotation phase of the rotary screen cylinder during doctor roller throw-off. If the answer is N, the program returns to Step P134 mentioned above. If the answer is Y, Step P137 is executed in which the memory M60a for storing the presence or absence of rotation of the stepping motor for adjusting the left side is overwritten with 0. Then, in Step P138, the memory M61a for storing the presence or absence of rotation of the stepping motor for adjusting the right side is overwritten with 0.

Then, in Step P139, the amount of movement of the left side of the doctor roller is loaded from the memory M79. Then, in Step P140, it is determined whether the amount of movement of the left side of the doctor roller is equal to 0. If the answer is Y in Step P140, the program shifts to Step P145 to be described later. If the answer is N in Step P140, the memory M60a for storing the presence or absence of rotation of the stepping motor for adjusting the left side is overwritten with 1 in Step P141.

Then, in Step P142, it is determined whether the amount of movement of the left side of the doctor roller is larger than 0. If the answer is Y in Step P142, Step P143 is executed to compute the absolute value of the amount of movement of the left side of the doctor roller from the amount of movement of the left side of the doctor roller, and store it into the memory M81. Then, in Step P144, a normal rotation pulse outputting command corresponding to the absolute value of the amount of movement of the left side of the doctor roller is outputted to the driver 66a for the stepping motor for adjusting the left side. Then, the program proceeds to the aforementioned Step P145.

If the answer is N in the above Step P142, Step P146 is executed to compute the absolute value of the amount of movement of the left side of the doctor roller from the amount of movement of the left side of the doctor roller, and store it into the memory M81. Then, in Step P147, a reverse rotation pulse outputting command corresponding to the absolute value of the amount of movement of the left side of the doctor roller is outputted to the driver 66a for the stepping motor for adjusting the left side. Then, the program shifts to the aforementioned Step P145.

Then, in the above Step P145, the amount of movement of the right side of the doctor roller is loaded from the memory M80. Then, in Step P148, it is determined whether the amount of movement of the right side of the doctor roller is equal to 0. If the answer is Y in Step P148, the program shifts to Step P153 to be described later. If the answer is N in Step P148, the memory M61a for storing the presence or absence of rotation of the stepping motor for adjusting the right side is overwritten with 1 in Step P149.

Then, in Step P150, it is determined whether the amount of movement of the right side of the doctor roller is larger than 0. If the answer is Y in Step P150, Step P151 is executed to compute the absolute value of the amount of movement of the right side of the doctor roller from the amount of movement of the right side of the doctor roller, and store it into the memory M82. Then, in Step P152, a normal rotation pulse outputting command corresponding to the absolute value of the amount of movement of the right side of the doctor roller is outputted to the driver 70a for the stepping motor for adjusting the right side. Then, the program proceeds to the aforementioned Step P153.

If the answer is N in the above Step P150, Step P154 is executed to compute the absolute value of the amount of movement of the right side of the doctor roller from the amount of movement of the right side of the doctor roller, and store it into the memory M82. Then, in Step P155, a reverse rotation pulse outputting command corresponding to the absolute value of the amount of movement of the right side of the doctor roller is outputted to the driver 70a for the stepping motor for adjusting the right side. Then, the program shifts to the aforementioned Step P153.

Subsequently, in the aforementioned Step P153, the value of the memory M60a for storing the presence or absence of rotation of the stepping motor for adjusting the left side is loaded. Then, in Step P156, it is determined whether the value of the memory for storing the presence or absence of rotation of the stepping motor for adjusting the left side is equal to 0. If the answer is Y in Step P156, the value of the memory M61a for storing the presence or absence of rotation of the stepping motor for adjusting the right side is loaded in Step P157. If the answer is N in Step P156, the program shifts to Step P160 to be described later.

Then, in Step P158, it is determined whether the value of the memory for storing the presence or absence of rotation of the stepping motor for adjusting the right side is equal to 0. If the answer is Y in Step P158, outputting of the enabling signal to the counter 76a for counting the total number of revolutions during doctor roller throw-on is stopped in Step P159, and the program returns to Step P127. If the answer is N in Step P158, the aforementioned Step P160 is executed to load the count value from the counter 68a for detecting the current position of the left side of the doctor roller, and store it into the memory M62a.

Then, in Step P161, the throw-off position (count value of the counter) of the doctor roller is loaded from the memory M54a. Then, in Step P162, it is determined whether the count value of the counter for detecting the current position of the left side of the doctor roller is equal to the throw-off position (count value of the counter) of the doctor roller. If the answer is Y, the memory M60a for storing the presence or absence of rotation of the stepping motor for adjusting the left side is overwritten with 0 in Step P163, and the program proceeds to Step P164. If the answer is N, the program directly shifts to Step P164.

Then, in the above Step P164, the count value is loaded from the counter 72a for detecting the current position of the right side of the doctor roller, and stored into the memory M63a. Then, in Step P165, the throw-off position (count value of the counter) of the doctor roller is loaded from the memory M54a.

Then, in Step P166, it is determined whether the count value of the counter 72a for detecting the current position of the right side of the doctor roller is equal to the throw-off position (count value of the counter) of the doctor roller. If the answer is Y, the memory M61a for storing the presence or absence of rotation of the stepping motor for adjusting the right side is overwritten with 0 in Step P167, and the program returns to Step P153. If the answer is N, the program directly returns to Step P153.

In accordance with the above-described motion flow, when the doctor roller throw-on and throw-off automatic control switch 52a is ON and the cylinder engagement signal for the rotary screen cylinder 11 is OFF, the doctor roller 90 is moved to the throw-off position.

Then, in Step P168 shifted from the aforementioned Step P128, the table of conversion from the total number of revolutions during doctor roller throw-on to the correction amount (count value of the counter) of the doctor roller position is loaded from the memory M64a. Then, in Step P169, the count value is loaded from the counter 76a for counting the total number of revolutions during doctor roller throw-on, and stored into the memory M65a.

Then, in Step P170, the correction amount (count value of the counter) of the doctor roller position is obtained from the count value of the counter 76a for counting the total number of revolutions during doctor roller throw-on, with the use of the table of conversion from the total number of revolutions during doctor roller throw-on to the correction amount (count value of the counter) of the doctor roller position, and this correction amount is stored into the memory M66a. Then, in Step P171, the reference retreat position (count value of the counter) of the doctor roller is loaded from the memory M53a.

Then, in Step P172, the correction amount (count value of the counter) of the doctor roller position is loaded from the memory M66a. Then, in Step P173, the correction amount (count value of the counter) of the doctor roller position is added to the reference retreat position (count value of the counter) of the doctor roller to compute the retreat position (count value of the counter) of the doctor roller, which is stored into the memory M67a.

Then, in Step P174, the count value is loaded from the counter 68a for detecting the current position of the left side of the doctor roller, and stored into the memory M62a. Then follows Step P175 in which the count value of the counter for detecting the current position of the left side of the doctor roller is subtracted from the retreat position (count value of the counter) of the doctor roller to compute the amount of movement of the left side of the doctor roller, which is stored into the memory M79.

Then, in Step P176, the count value is loaded from the counter 72a for detecting the current position of the right side of the doctor roller, and stored into the memory M63a. Then follows Step P177 in which the count value of the counter for detecting the current position of the right side of the doctor roller is subtracted from the retreat position (count value of the counter) of the doctor roller to compute the amount of movement of the right side of the doctor roller, which is stored into the memory M75.

Then, in Step P178, the count value is loaded from the counter 74 for detecting the rotation phase of the rotary screen cylinder, and stored into the memory M68. Then, in Step P179, the rotation phase of the rotary screen cylinder during doctor roller throw-on is loaded from the memory M69a.

Then, in Step P180, it is determined whether the count value of the counter for detecting the rotation phase of the rotary screen cylinder is equal to the rotation phase of the rotary screen cylinder during doctor roller throw-on. If the answer is N, the program returns to Step P178 mentioned above. If the answer is Y, Step P181 is executed in which the memory M60a for storing the presence or absence of rotation of the stepping motor for adjusting the left side is overwritten with 0. Then, in Step P182, the memory M61a for storing the presence or absence of rotation of the stepping motor for adjusting the right side is overwritten with 0.

Then, in Step P183, the amount of movement of the left side of the doctor roller is loaded from the memory M79. Then, in Step P184, it is determined whether the amount of movement of the left side of the doctor roller is equal to 0. If the answer is Y in Step P184, the program shifts to Step P189 to be described later. If the answer is N in Step P184, the memory M60a for storing the presence or absence of rotation of the stepping motor for adjusting the left side is overwritten with 1 in Step P185.

Then, in Step P186, it is determined whether the amount of movement of the left side of the doctor roller is larger than 0. If the answer is Y in Step P186, Step P187 is executed to compute the absolute value of the amount of movement of the left side of the doctor roller from the amount of movement of the left side of the doctor roller, and store it into the memory M81. Then, in Step P188, a normal rotation pulse outputting command corresponding to the absolute value of the amount of movement of the left side of the doctor roller is outputted to the driver 66a for the stepping motor for adjusting the left side. Then, the program proceeds to the aforementioned Step P189.

If the answer is N in Step P186, Step P190 is executed to compute the absolute value of the amount of movement of the left side of the doctor roller from the amount of movement of the left side of the doctor roller, and store it into the memory M81. Then, in Step P191, a reverse rotation pulse outputting command corresponding to the absolute value of the amount of movement of the left side of the doctor roller is outputted to the driver 66a for the stepping motor for adjusting the left side. Then, the program shifts to the aforementioned Step P189.

Then, in the above Step P189, the amount of movement of the right side of the doctor roller is loaded from the memory M80. Then, in Step P192, it is determined whether the amount of movement of the right side of the doctor roller is equal to 0. If the answer is Y in Step P192, the program shifts to Step P197 to be described later. If the answer is N in Step P192, the memory M61a for storing the presence or absence of rotation of the stepping motor for adjusting the right side is overwritten with 1 in Step P193.

Then, in Step P194, it is determined whether the amount of movement of the right side of the doctor roller is larger than 0. If the answer is Y in Step P194, Step P195 is executed to compute the absolute value of the amount of movement of the right side of the doctor roller from the amount of movement of the right side of the doctor roller, and store it into the memory M82. Then, in Step P196, a normal rotation pulse outputting command corresponding to the absolute value of the amount of movement of the right side of the doctor roller is outputted to the driver 70a for the stepping motor for adjusting the right side. Then, the program proceeds to Step P197.

If the answer is N in the above Step P194, Step P198 is executed to compute the absolute value of the amount of movement of the right side of the doctor roller from the amount of movement of the right side of the doctor roller, and store it into the memory M82. Then, in Step P199, a reverse rotation pulse outputting command corresponding to the absolute value of the amount of movement of the right side of the doctor roller is outputted to the driver 70a for the stepping motor for adjusting the right side. Then, the program shifts to the aforementioned Step P197.

Subsequently, in the above Step P197, the value of the memory M60a for storing the presence or absence of rotation of the stepping motor for adjusting the left side is loaded. Then, in Step P200, it is determined whether the value of the memory for storing the presence or absence of rotation of the stepping motor for adjusting the left side is equal to 0. If the answer is Y in Step P200, the value of the memory M61a for storing the presence or absence of rotation of the stepping motor for adjusting the right side is loaded in Step P201. If the answer is N, the program shifts to Step P204 to be described later.

Subsequently, in Step P202, it is determined whether the value of the memory for storing the presence or absence of rotation of the stepping motor for adjusting the right side is equal to 0. If the answer is Y, Step P203 is executed to output an enabling signal to the counter 76a for counting the total number of revolutions during doctor roller throw-on, and the program shifts to Step P212 to be described later. If the answer is N, the aforementioned Step P204 is executed to load the count value from the counter 68a for detecting the current position of the left side of the doctor roller, and store it into the memory M62a.

Then, in Step P205, the retreat position (count value of the counter) of the doctor roller is loaded from the memory M67a. Then, in Step P206, it is determined whether the count value of the counter for detecting the current position of the left side of the doctor roller is equal to the retreat position (count value of the counter) of the doctor roller. If the answer is Y, the memory M60a for storing the presence or absence of rotation of the stepping motor for adjusting the left side is overwritten with 0 in Step P207, and the program proceeds to Step P208. If the answer is N, the program directly shifts to Step P208.

Then, in the aforementioned Step P208, the count value is loaded from the counter 72a for detecting the current position of the right side of the doctor roller, and stored into the memory M63a. Then, in Step P209, the retreat position (count value of the counter) of the doctor roller is loaded from the memory M67a.

Then, in Step P210, it is determined whether the count value of the counter 72a for detecting the current position of the right side of the doctor roller is equal to the retreat position (count value of the counter) of the doctor roller. If the answer is Y, the memory M61a for storing the presence or absence of rotation of the stepping motor for adjusting the right side is overwritten with 0 in Step P211, and the program returns to Step P197. If the answer is N, the program directly returns to Step P197.

In accordance with the above-described motion flow, when the doctor roller throw-on and throw-off automatic control switch 52a is ON and the cylinder engagement signal for the rotary screen cylinder 11 is ON, the doctor roller 90 is moved to the predetermined retreat position when it opposes the notch 13b of the impression cylinder 13.

Then, in Step P212 shifted from the aforementioned Step P203, the table of conversion from the total number of revolutions during doctor roller throw-on to the correction amount (count value of the counter) of the doctor roller position is loaded from the memory M64a. Then, in Step P213, the count value is loaded from the counter 76a for counting the total number of revolutions during doctor roller throw-on, and stored into the memory M65a.

Then, in Step P214, the correction amount (count value of the counter) of the doctor roller position is obtained from the count value of the counter 76a for counting the total number of revolutions during doctor roller throw-on, with the use of the table of conversion from the total number of revolutions during doctor roller throw-on to the correction amount (count value of the counter) of the doctor roller position, and this correction amount is stored into the memory M66a. Then, in Step P215, the reference throw-on position (count value of the counter) of the doctor roller is loaded from the memory M34a.

Then, in Step P216, the correction amount (count value of the counter) of the doctor roller position is loaded from the memory M66a. Then, in Step P217, the correction amount (count value of the counter) of the doctor roller position is added to the reference throw-on position (count value of the counter) of the doctor roller to compute the printing position (count value of the counter) of the doctor roller, which is stored into the memory M70a.

Then, in Step P218, the count value is loaded from the counter 68a for detecting the current position of the left side of the doctor roller, and stored into the memory M62a. Then, in Step P219, the count value of the counter for detecting the current position of the left side of the doctor roller is subtracted from the printing position (count value of the counter) of the doctor roller to compute the amount of movement of the left side of the doctor roller, which is stored into the memory M79.

Then, in Step P220, the count value is loaded from the counter 72a for detecting the current position of the right side of the doctor roller, and stored into the memory M63a. Then, in Step P221, the count value of the counter for detecting the current position of the right side of the doctor roller is subtracted from the printing position (count value of the counter) of the doctor roller to compute the amount of movement of the right side of the doctor roller, which is stored into the memory M80.

Then, in Step P222, the count value is loaded from the counter 74 for detecting the rotation phase of the rotary screen cylinder, and stored into the memory M68. Then, in Step P223, the rotation phase of the rotary screen cylinder at the position of the rear end of the notch of the impression cylinder is loaded from the memory M57.

Then, in Step P224, it is determined whether the count value of the counter for detecting the rotation phase of the rotary screen cylinder is equal to the rotation phase of the rotary screen cylinder at the position of the rear end of the notch of the impression cylinder. If the answer is N, the program returns to Step P222 mentioned above. If the answer is Y, the memory M60a for storing the presence or absence of rotation of the stepping motor for adjusting the left side is overwritten with 0 in Step P225. Subsequently, in Step P226, the memory M61a for storing the presence or absence of rotation of the stepping motor for adjusting the right side is overwritten with 0.

Then, in Step P227, the amount of movement of the left side of the doctor roller is loaded from the memory M79. Then, in Step P228, it is determined whether the amount of movement of the left side of the doctor roller is equal to 0. If the answer is Y in Step P228, the program shifts to Step P233 to be described later. If the answer is N in Step P228, the memory M60a for storing the presence or absence of rotation of the stepping motor for adjusting the left side is overwritten with 1 in Step P229.

Then, in Step P230, it is determined whether the amount of movement of the left side of the doctor roller is larger than 0. If the answer is Y in Step P230, Step P231 is executed to compute the absolute value of the amount of movement of the left side of the doctor roller from the amount of movement of the left side of the doctor roller, and store it into the memory M81. Then, in Step P232, a normal rotation pulse outputting command corresponding to the absolute value of the amount of movement of the left side of the doctor roller is outputted to the driver 66a for the stepping motor for adjusting the left side. Then, the program proceeds to the aforementioned Step P233.

If the answer is N in Step P230, Step P234 is executed to compute the absolute value of the amount of movement of the left side of the doctor roller from the amount of movement of the left side of the doctor roller, and store it into the memory M81. Then, in Step P235, a reverse rotation pulse outputting command corresponding to the absolute value of the amount of movement of the left side of the doctor roller is outputted to the driver 66a for the stepping motor for adjusting the left side. Then, the program shifts to the aforementioned Step P233.

Then, in the above Step P233, the amount of movement of the right side of the doctor roller is loaded from the memory M80. Then, in Step P236, it is determined whether the amount of movement of the right side of the doctor roller is equal to 0. If the answer is Y in Step P236, the program shifts to Step P241 to be described later. If the answer is N in Step P236, the memory M61a for storing the presence or absence of rotation of the stepping motor for adjusting the right side is overwritten with 1 in Step P237.

Then, in Step P238, it is determined whether the amount of movement of the right side of the doctor roller is larger than 0. If the answer is Y in Step P238, Step P239 is executed to compute the absolute value of the amount of movement of the right side of the doctor roller from the amount of movement of the right side of the doctor roller, and store it into the memory M82. Then, in Step P240, a normal rotation pulse outputting command corresponding to the absolute value of the amount of movement of the right side of the doctor roller is outputted to the driver 70a for the stepping motor for adjusting the right side. Then, the program proceeds to the aforementioned Step P241.

If the answer is N in the above Step P238, Step P242 is executed to compute the absolute value of the amount of movement of the right side of the doctor roller from the amount of movement of the right side of the doctor roller, and store it into the memory M82. Then, in Step P243, a reverse rotation pulse outputting command corresponding to the absolute value of the amount of movement of the right side of the doctor roller is outputted to the driver 70a for the stepping motor for adjusting the right side. Then, the program shifts to the aforementioned Step P241.

Subsequently, in the above Step P241, the value of the memory M60a for storing the presence or absence of rotation of the stepping motor for adjusting the left side is loaded. Then, in Step P244, it is determined whether the value of the memory for storing the presence or absence of rotation of the stepping motor for adjusting the left side is equal to 0. If the answer is Y in Step P244, the value of the memory M61a for storing the presence or absence of rotation of the stepping motor for adjusting the right side is loaded in Step P245. If the answer is N, the program shifts to Step P247 to be described later.

Then, in Step P246, it is determined whether the value of the memory for storing the presence or absence of rotation of the stepping motor for adjusting the right side is equal to 0. If the answer is Y in Step P246, the program shifts to Step P255 to be described later. If the answer is N in Step P246, the aforementioned Step P247 is executed to load the count value from the counter 68a for detecting the current position of the left side of the doctor roller, and store it into the memory M62a.

Then, in Step P248, the printing position (count value of the counter) of the doctor roller is loaded from the memory M70a. Then, in Step P249, it is determined whether the count value of the counter for detecting the current position of the left side of the doctor roller is equal to the printing position (count value of the counter) of the doctor roller. If the answer is Y, the memory M60a for storing the presence or absence of rotation of the stepping motor for adjusting the left side is overwritten with 0 in Step P250, and the program proceeds to Step P251. If the answer is N in Step P249, the program directly shifts to Step P251.

Then, in the aforementioned Step P251, the count value is loaded from the counter 72a for detecting the current position of the right side of the doctor roller, and stored into the memory M63a. Then, in Step P252, the printing position (count value of the counter) of the doctor roller is loaded from the memory M70a.

Then, in Step P253, it is determined whether the count value of the counter 72a for detecting the current position of the right side of the doctor roller is equal to the printing position (count value of the counter) of the doctor roller. If the answer is Y, the memory M61a for storing the presence or absence of rotation of the stepping motor for adjusting the right side is overwritten with 0 in Step P254, and the program returns to Step P241. If the answer is N in Step P253, the program directly returns to Step P241.

In accordance with the above-described motion flow, when the doctor roller throw-on and throw-off automatic control switch 52a is ON and the cylinder engagement signal for the rotary screen cylinder 11 is ON, the doctor roller 90 is moved to the predetermined printing position when it enters the rotation phase of the rotary screen cylinder 11 corresponding to the position of the rear end of the notch of the impression cylinder 13.

Then, in Step P255 shifted from the aforementioned Step P246, the table of conversion from the total number of revolutions during doctor roller throw-on to the correction amount (count value of the counter) of the doctor roller position is loaded from the memory M64a. Then, in Step P256, the count value is loaded from the counter 76a for counting the total number of revolutions during doctor roller throw-on, and stored into the memory M65a.

Then, in Step P257, the correction amount (count value of the counter) of the doctor roller position is obtained from the count value of the counter 76a for counting the total number of revolutions during doctor roller throw-on, with the use of the table of conversion from the total number of revolutions during doctor roller throw-on to the correction amount (count value of the counter) of the doctor roller position, and this correction amount is stored into the memory M66a. Then, in Step P258, the reference retreat position (count value of the counter) of the doctor roller is loaded from the memory M53a.

Then, in Step P259, the correction amount (count value of the counter) of the doctor roller position is loaded from the memory M66a. Then, in Step P260, the correction amount (count value of the counter) of the doctor roller position is added to the reference retreat position (count value of the counter) of the doctor roller to compute the retreat position (count value of the counter) of the doctor roller, which is stored into the memory M67a.

Then, Step P261 is executed to load the count value from the counter 68a for detecting the current position of the left side of the doctor roller, and store it into the memory M62a. Then, in Step P262, the count value of the counter for detecting the current position of the left side of the doctor roller is subtracted from the retreat position (count value of the counter) of the doctor roller to compute the amount of movement of the left side of the doctor roller, which is stored into the memory M79.

Then, Step P263 is executed to load the count value from the counter 72a for detecting the current position of the right side of the doctor roller, and store it into the memory M63a. Then, in Step P264, the count value of the counter for detecting the current position of the right side of the doctor roller is subtracted from the retreat position (count value of the counter) of the doctor roller to compute the amount of movement of the right side of the doctor roller, which is stored into the memory M80.

Then, in Step P265, the count value is loaded from the counter 74 for detecting the rotation phase of the rotary screen cylinder, and stored into the memory M68. Then, in Step P266, the rotation phase of the rotary screen cylinder at the doctor roller retreat start position is loaded from the memory M78.

Then, in Step P267, it is determined whether the count value of the counter 74 for detecting the rotation phase of the rotary screen cylinder is equal to the rotation phase of the rotary screen cylinder at the doctor roller retreat start position. If the answer is N, the program returns to Step P265 mentioned above. If the answer is Y, the memory M60a for storing the presence or absence of rotation of the stepping motor for adjusting the left side is overwritten with 0 in Step P268. Then, in Step P269, the memory M61a for storing the presence or absence of rotation of the stepping motor for adjusting the right side is overwritten with 0.

Then, in Step P270, the amount of movement of the left side of the doctor roller is loaded from the memory M79. Then, in Step P271, it is determined whether the amount of movement of the left side of the doctor roller is equal to 0. If the answer is Y in Step P271, the program shifts to Step P276 to be described later. If the answer is N in Step P271, the memory M60a for storing the presence or absence of rotation of the stepping motor for adjusting the left side is overwritten with 1 in Step P272.

Then, in Step P273, it is determined whether the amount of movement of the left side of the doctor roller is larger than 0. If the answer is Y in Step P273, Step P274 is executed to compute the absolute value of the amount of movement of the left side of the doctor roller from the amount of movement of the left side of the doctor roller, and store it into the memory M81. Then, in Step P275, a normal rotation pulse outputting command corresponding to the absolute value of the amount of movement of the left side of the doctor roller is outputted to the driver 66a for the stepping motor for adjusting the left side. Then, the program proceeds to the aforementioned Step P276.

If the answer is N in the above Step P273, Step P277 is executed to compute the absolute value of the amount of movement of the left side of the doctor roller from the amount of movement of the left side of the doctor roller, and store it into the memory M81. Then, in Step P278, a reverse rotation pulse outputting command corresponding to the absolute value of the amount of movement of the left side of the doctor roller is outputted to the driver 66a for the stepping motor for adjusting the left side. Then, the program shifts to the aforementioned Step P276.

Then, in the aforementioned Step P276, the amount of movement of the right side of the doctor roller is loaded from the memory M80. Then, in Step P279, it is determined whether the amount of movement of the right side of the doctor roller is equal to 0. If the answer is Y in Step P279, the program shifts to Step P284 to be described later. If the answer is N in Step P279, the memory M61a for storing the presence or absence of rotation of the stepping motor for adjusting the right side is overwritten with 1 in Step P280.

Then, in Step P281, it is determined whether the amount of movement of the right side of the doctor roller is larger than 0. If the answer is Y in Step P281, Step P282 is executed to compute the absolute value of the amount of movement of the right side of the doctor roller from the amount of movement of the right side of the doctor roller, and store it into the memory M82. Then, in Step P283, a normal rotation pulse outputting command corresponding to the absolute value of the amount of movement of the right side of the doctor roller is outputted to the driver 70a for the stepping motor for adjusting the right side. Then, the program proceeds to the aforementioned Step P284.

If the answer isN in the above Step P281, Step P285 is executed to compute the absolute value of the amount of movement of the right side of the doctor roller from the amount of movement of the right side of the doctor roller, and store it into the memory M82. Then, in Step P286, a reverse rotation pulse outputting command corresponding to the absolute value of the amount of movement of the right side of the doctor roller is outputted to the driver 70a for the stepping motor for adjusting the right side. Then, the program shifts to the aforementioned Step P284.

Subsequently, in the aforementioned Step P284, the value of the memory M60a for storing the presence or absence of rotation of the stepping motor for adjusting the left side is loaded. Then, in Step P287, it is determined whether the value of the memory for storing the presence or absence of rotation of the stepping motor for adjusting the left side is equal to 0. If the answer is Y in Step P287, the value of the memory M61a for storing the presence or absence of rotation of the stepping motor for adjusting the right side is loaded in Step P288. If the answer is N in Step P287, the program shifts to Step P291 to be described later.

Subsequently, in Step P289, it is determined whether the value of the memory for storing the presence or absence of rotation of the stepping motor for adjusting the right side is equal to 0. If the answer is Y in Step P289, Step P290 is executed to determine whether the cylinder engagement signal for the rotary screen cylinder is ON. If the answer is Y, the program returns to Step P212. If the answer is N, the program returns to Step P129.

If the answer is N in the aforementioned Step P289, the count value is loaded from the counter 68a for detecting the current position of the left side of the doctor roller, and stored into the memory M62a, in the aforementioned Step P291.

Then, in Step P292, the retreat position (count value of the counter) of the doctor roller is loaded from the memory M67a. Then, in Step P293, it is determined whether the count value of the counter for detecting the current position of the left side of the doctor roller is equal to the retreat position (count value of the counter) of the doctor roller. If the answer is Y, the memory M60a for storing the presence or absence of rotation of the stepping motor for adjusting the left side is overwritten with 0 in Step P294, and the program proceeds to Step P295. If the answer is N, the program directly shifts to Step P295.

Then, in the aforementioned Step P295, the count value is loaded from the counter 72a for detecting the current position of the right side of the doctor roller, and stored into the memory M63a. Then, in Step P296, the retreat position (count value of the counter) of the doctor roller is loaded from the memory M67a.

Then, in Step P297, it is determined whether the count value of the counter 72a for detecting the current position of the right side of the doctor roller is equal to the retreat position (count value of the counter) of the doctor roller. If the answer is Y, the memory M61a for storing the presence or absence of rotation of the stepping motor for adjusting the right side is overwritten with 0 in Step P298, and the program returns to Step P284. If the answer is N, the program directly returns to Step P284.

In accordance with the above-described motion flow, when the doctor roller throw-on and throw-off automatic control switch 52a is ON and the cylinder engagement signal for the rotary screen cylinder 11 is ON, the doctor roller 90 is moved to the predetermined retreat position when it enters the rotation phase of the rotary screen cylinder 11 at the doctor roller retreat start position.

Then, in step P299 shifted from the aforementioned Step P127, the throw-off position (count value of the counter) of the doctor roller is loaded from the memory M54a.

Then, Step P300 is executed to load the count value from the counter 68a for detecting the current position of the left side of the doctor roller, and store it into the memory M62a. Then, in Step P301, the count value of the counter for detecting the current position of the left side of the doctor roller is subtracted from the throw-off position (count value of the counter) of the doctor roller to compute the amount of movement of the left side of the doctor roller, which is stored into the memory M79.

Then, Step P302 is executed to load the count value from the counter 72a for detecting the current position of the right side of the doctor roller, and store it into the memory M63a. Then, in Step P303, the count value of the counter for detecting the current position of the right side of the doctor roller is subtracted from the throw-off position (count value of the counter) of the doctor roller to compute the amount of movement of the right side of the doctor roller, which is stored into the memory M80.

Then, in Step P304, the count value is loaded from the counter 74 for detecting the rotation phase of the rotary screen cylinder, and stored into the memory M68. Then, in Step P305, the rotation phase of the rotary screen cylinder during doctor roller throw-off is loaded from the memory M58a.

Then, in Step P306, it is determined whether the count value of the counter for detecting the rotation phase of the rotary screen cylinder is equal to the rotation phase of the rotary screen cylinder during doctor roller throw-off. If the answer is N, the program returns to Step P304 mentioned above. If the answer is Y, the memory M60a for storing the presence or absence of rotation of the stepping motor for adjusting the left side is overwritten with 0 in Step P307. Then, in Step P308, the memory M61a for storing the presence or absence of rotation of the stepping motor for adjusting the right side is overwritten with 0.

Then, in Step P309, the amount of movement of the left side of the doctor roller is loaded from the memory M79. Then, in Step P310, it is determined whether the amount of movement of the left side of the doctor roller is equal to 0. If the answer is Y in Step P310, the program shifts to Step P315 to be described later. If the answer is N in Step P310, the memory M60a for storing the presence or absence of rotation of the stepping motor for adjusting the left side is overwritten with 1 in Step P311.

Then, in Step P312, it is determined whether the amount of movement of the left side of the doctor roller is larger than 0. If the answer is Y in Step P312, Step P313 is executed to compute the absolute value of the amount of movement of the left side of the doctor roller from the amount of movement of the left side of the doctor roller, and store it into the memory M81. Then, in Step P314, a normal rotation pulse outputting command corresponding to the absolute value of the amount of movement of the left side of the doctor roller is outputted to the driver 66a for the stepping motor for adjusting the left side. Then, the program proceeds to the aforementioned Step P315.

If the answer is N in the aforementioned Step P312, Step P316 is executed to compute the absolute value of the amount of movement of the left side of the doctor roller from the amount of movement of the left side of the doctor roller, and store it into the memory M81. Then, in Step P317, a reverse rotation pulse outputting command corresponding to the absolute value of the amount of movement of the left side of the doctor roller is outputted to the driver 66a for the stepping motor for adjusting the left side. Then, the program shifts to Step P315 mentioned above.

Then, in the above Step P315, the amount of movement of the right side of the doctor roller is loaded from the memory M80. Then, in Step P318, it is determined whether the amount of movement of the right side of the doctor roller is equal to 0. If the answer is Y in Step P318, the program shifts to Step P323 to be described later. If the answer is N in Step P318, the memory M61a for storing the presence or absence of rotation of the stepping motor for adjusting the right side is overwritten with 1 in Step P319.

Then, in Step P320, it is determined whether the amount of movement of the right side of the doctor roller is larger than 0. If the answer is Y in Step P320, Step P321 is executed to compute the absolute value of the amount of movement of the right side of the doctor roller from the amount of movement of the right side of the doctor roller, and store it into the memory M82. Then, in Step P322, a normal rotation pulse outputting command corresponding to the absolute value of the amount of movement of the right side of the doctor roller is outputted to the driver 70a for the stepping motor for adjusting the right side. Then, the program proceeds to the aforementioned Step P323.

If the answer is N in the aforementioned Step P320, Step P324 is executed to compute the absolute value of the amount of movement of the right side of the doctor roller from the amount of movement of the right side of the doctor roller, and store it into the memory M82. Then, in Step P325, a reverse rotation pulse outputting command corresponding to the absolute value of the amount of movement of the right side of the doctor roller is outputted to the driver 70a for the stepping motor for adjusting the right side. Then, the program shifts to the aforementioned Step P323.

Subsequently, in the above Step P323, the value of the memory M60a for storing the presence or absence of rotation of the stepping motor for adjusting the left side is loaded. Then, in Step P326, it is determined whether the value of the memory for storing the presence or absence of rotation of the stepping motor for adjusting the left side is equal to 0. If the answer is Y in Step P326, the value of the memory M61a for storing the presence or absence of rotation of the stepping motor for adjusting the right side is loaded in Step P327. If the answer is N in Step P326, the program shifts to Step P330 to be described later.

Subsequently, in Step P328, it is determined whether the value of the memory for storing the presence or absence of rotation of the stepping motor for adjusting the right side is equal to 0. If the answer is Y in Step P328, Step P329 is executed to stop the outputting of the enabling signal to the counter 76a for counting the total number of revolutions during doctor roller throw-on. Then, the program returns to Step P1. If the answer is N in Step P328, the aforementioned Step P330 is executed to load the count value from the counter 68a for detecting the current position of the left side of the doctor roller, and store it into the memory M62a.

Then, in Step P331, the throw-off position (count value of the counter) of the doctor roller is loaded from the memory M54a. Then, in Step P332, it is determined whether the count value of the counter for detecting the current position of the left side of the doctor roller is equal to the throw-off position (count value of the counter) of the doctor roller. If the answer is Y, the memory M60a for storing the presence or absence of rotation of the stepping motor for adjusting the left side is overwritten with 0 in Step P333, and the program proceeds to Step P334. If the answer is N in Step P332, the program directly shifts to Step P334.

Then, in the aforementioned Step P334, the count value is loaded from the counter 72a for detecting the current position of the right side of the doctor roller, and stored into the memory M63a. Then, in Step P335, the throw-off position (count value of the counter) of the doctor roller is loaded from the memory M54a.

Then, in Step P336, it is determined whether the count value of the counter 72a for detecting the current position of the right side of the doctor roller is equal to the throw-off position (count value of the counter) of the doctor roller. If the answer is Y, the memory M61a for storing the presence or absence of rotation of the stepping motor for adjusting the right side is overwritten with o in Step P337, and the program returns to Step P323. If the answer is N in Step P336, the program directly returns to Step P323.

In accordance with the above-described motion flow, when the doctor roller throw-on and throw-off automatic control switch 52a is brought to the OFF-state, the doctor roller 90 is moved to the throw-off position.

According to the present Embodiment 2, as described above, the doctor roller 90 is moved by the doctor roller throw-on and throw-off control device 40B to the position of retreat from the notch 13b of the impression cylinder 13 with a timing conformed to the preset length from the gripping end to the terminal end in the circumferential direction of the effective impression area (the length of the printing region in the transport direction of the material W to be printed), in other words, when the doctor roller 90 enters the rotation phase of the rotary screen cylinder 11 at the doctor roller retreat start position.

This makes it possible to prevent the damage or wear of the screen printing forme 11c due to the abrupt movement of the doctor roller 90 during printing (namely, at the rear end of the printed material W, the doctor roller 90 abruptly moving toward the impression cylinder 13 by an amount corresponding to the thickness of the printed material W).

Furthermore, the above-mentioned retreat position is controlled to a position where the outer peripheral surface of the doctor roller 90 makes contact with the inner peripheral surface of the screen printing forme 11c, and the pressing force of the doctor roller 90 acting on the inner peripheral surface of the screen printing forme 11c becomes smaller than the pressing force exerted during printing.

Thus, the screen printing forme 11c can be prevented from being pushed into the notch 13b of the impression cylinder 13 and damaged thereby, and there is no ink leaking out toward the downstream side in the rotating direction of the screen printing forme 11c, so that deterioration of printing quality can be prevented. That is, the following problems are avoided: Because of leaks of ink toward the downstream side in the rotating direction of the screen printing forme 11c, the amount of ink remaining in front of the doctor roller 90 becomes small to decrease the ink density at the start of printing. The ink leaking out toward the downstream side leaks out through the holes of the picture pattern portion under a centrifugal force during high speed rotation, adheres to outside portions of the holes, and sticks to the outside of the picture pattern portion during printing, thereby deteriorating printing quality.

The doctor roller throw-on and throw-off control device 40B can also preset the pressing force at the retreat position of the doctor roller 90 in accordance with the type of the screen printing forme 11c (material, forme thickness, open area rate, mesh size, etc.), the type of ink used in printing (viscosity, yield value, type of pigment, etc.), and the type of the doctor roller 90 (material, surface hardness, etc.).

Hence, damage to the screen printing forme 11c and deterioration of printing quality are prevented with even higher accuracy.

In the present Embodiment 2, moreover, the control pressure may be switched using a hydraulic or pneumatic actuator instead of the stepping motor 36Aa for adjusting the left side and the stepping motor 36Bb for adjusting the right side. Furthermore, the motors 36Aa and 36Bb are disposed on the right side and the left side. However, there may be adopted a configuration in which a one-sided motor moves the right and left sides, for example, by connecting the right and left sides by a lever mechanism.

The invention thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A liquid transfer member position adjusting method of a rotary stencil printing plate liquid coating machine including,
a stencil printing plate cylinder which supports a stencil printing plate and is supported rotatably,
an impression cylinder which is provided to oppose the stencil printing plate cylinder, and is supported rotatably, and
a liquid transfer member which is located within the stencil printing plate cylinder and, during liquid coating, contacts an inner peripheral surface of the stencil printing plate, while being pressed against the inner peripheral surface of the stencil printing plate, to transfer a liquid stored within the stencil printing plate cylinder to a material to be liquid coated, which is supplied between the stencil printing plate cylinder and the impression cylinder, via holes of the stencil printing plate, the method comprising:
setting one of a length in a transport direction of the material to be liquid coated, and a length of a liquid coating region in the transport direction of the material to be liquid coated; and
moving the liquid transfer member to a retreat position in accordance with one of the set length in the transport direction of the material to be liquid coated, and the set length of the liquid coating region in the transport direction of the material to be liquid coated.

2. The liquid transfer member position adjusting method of a rotary stencil printing plate liquid coating machine according to claim 1, wherein
the retreat position of the liquid transfer member is a position where the liquid transfer member makes contact with the inner peripheral surface of the stencil printing plate, and a pressing force of the liquid transfer member acting on the inner peripheral surface of the stencil printing plate becomes lower than a pressing force of the liquid transfer member exerted during the liquid coating.

3. The liquid transfer member position adjusting method of a rotary stencil printing plate liquid coating machine according to claim 2, wherein
adjustment of a position of the liquid transfer member is made by a motor.

4. The liquid transfer member position adjusting method of a rotary stencil printing plate liquid coating machine according to claim 2, wherein
the retreat position of the liquid transfer member is obtained from a type of the stencil printing plate.

5. The liquid transfer member position adjusting method of a rotary stencil printing plate liquid coating machine according to claim 2, wherein
the retreat position of the liquid transfer member is obtained from a picture pattern area rate of a picture pattern which is applied by the liquid coating to the material to be liquid coated.

6. The liquid transfer member position adjusting method of a rotary stencil printing plate liquid coating machine according to claim 2, wherein
the retreat position of the liquid transfer member is obtained from a type of the liquid used in the liquid coating.

7. The liquid transfer member position adjusting method of a rotary stencil printing plate liquid coating machine according to claim 2, wherein
the retreat position of the liquid transfer member is obtained from a type of the liquid transfer member.

8. A liquid transfer member position adjusting apparatus of a rotary stencil printing plate liquid coating machine including,
a stencil printing plate cylinder which supports a stencil printing plate and is supported rotatably,
an impression cylinder which is provided to oppose the stencil printing plate cylinder, and is supported rotatably, and
a liquid transfer member which is located within the stencil printing plate cylinder and, during liquid coating, contacts an inner peripheral surface of the stencil printing plate, while being pressed against the inner peripheral surface of the stencil printing plate, to transfer a liquid stored within the stencil printing plate cylinder to a material to be liquid coated, which is supplied between the stencil printing plate cylinder and the impression cylinder, via holes of the stencil printing plate,
the liquid transfer member position adjusting apparatus comprising:
setting means for setting a length in a transport direction of the material to be liquid coated, or a length of a liquid coating region in the transport direction of the material to be liquid coated, and
control means for controlling the liquid transfer member to be moved to a retreat position in accordance with the length in the transport direction of the material to be liquid coated, or the length of the liquid coating region in the transport direction of the material to be liquid coated, which has been set by the setting means.

9. The liquid transfer member position adjusting apparatus of a rotary stencil printing plate liquid coating machine according to claim 8, wherein
the control means controls the retreat position of the liquid transfer member to a position where the liquid transfer member makes contact with the inner peripheral surface of the stencil printing plate, and a pressing force of the liquid transfer member acting on the inner peripheral surface of the stencil printing plate becomes lower than a pressing force of the liquid transfer member exerted during the liquid coating.

10. The liquid transfer member position adjusting apparatus of a rotary stencil printing plate liquid coating machine according to claim 9, wherein
the control means makes adjustment of a position of the liquid transfer member by drivingly controlling a motor.

11. The liquid transfer member position adjusting apparatus of a rotary stencil printing plate liquid coating machine according to claim 9, wherein
the control means controls the retreat position of the liquid transfer member in accordance with a type of the stencil printing plate.

12. The liquid transfer member position adjusting apparatus of a rotary stencil printing plate liquid coating machine according to claim 9, wherein
the control means controls the retreat position of the liquid transfer member in accordance with a picture pattern area rate of a picture pattern which is applied by the liquid coating to the material to be liquid coated.

13. The liquid transfer member position adjusting apparatus of a rotary stencil printing plate liquid coating machine according to claim 9, wherein
the control means controls the retreat position of the liquid transfer member in accordance with a type of the liquid used in the liquid coating.

14. The liquid transfer member position adjusting apparatus of a rotary stencil printing plate liquid coating machine according to claim 9, wherein
the control means controls the retreat position of the liquid transfer member in accordance with a type of the liquid transfer member.
